(19) United States
(12) Patent Application Publication
(10) Pub. No.: US 2006/0221941 A1
(43) Pub. Date: Oct. 5, 2006

(54) Voice over internet protocol implemented call center

(76) Inventors: Konstantin Kishinsky, San Carlos, CA (US); Sergey Menshikov, Foster City, CA (US); Alexander Lobastov, Concord, CA (US); Alexei Vovenko, Pleasanton, CA (US); Pavel Karpenko, Concord, CA (US)

Correspondence Address: Dag Johansen, P.O. Box 7512, Menlo Park, CA, 94025, US

(21) Appl. No.: 11/267,959

(22) Filed: Nov. 5, 2005

Related U.S. Application Data
(60) Provisional application No. 60/625,179, filed on Nov. 5, 2004.

(51) Int. Cl. H04L 12/66

(52) U.S. Cl. 370/352

(57) ABSTRACT

The present invention takes advantage of Voice over Internet Protocol (VoIP) technology by introducing VoIP-based call center telephony equipment that is software-based and runs on inexpensive off-the-shelf personal computer (PC) systems. With the VoIP-based call center system of the present invention, the traditional Public Switched Telephone Network (PSTN) is coupled to a Voice over Internet Protocol (VoIP) gateway in order to convert all incoming traditional telephone communication into VoIP based telephony telecommunication. This is performed using the well-known SIP telephony protocol set forth in RFC 3261. Once converted to the VoIP format, the incoming VoIP-based calls are directed to the VoIP based Call Center Server system. The Call Center Server system provides all the sophisticated call center features that were formerly only available in large call centers created with specialized expensive telephone equipment

### RELATED APPLICATIONS

The present patent application hereby incorporates by reference in its entirety and claims the benefit of the previous U.S. Provisional Patent Application entitled “Voice Over Internet Protocol Implemented Call Center” filed on Nov. 5, 2004 having Ser. No. 60/625,1798.

### FIELD OF THE INVENTION

The present invention relates to the field of telephony equipment. In particular, the present invention discloses a sophisticated business call center environment that is constructed using Voice Over Internet Protocol (VOIP) technology.

### BACKGROUND OF THE INVENTION

Telephony equipment manufacturers have created a wide variety of complex telephony devices for creating large corporate call centers that handle large amounts of incoming and/or outgoing telephone calls. These complex telephony devices include Private Branch Exchanges (PBXs), Interactive Voice Response (IVR) systems, call queuing systems, and call routing systems.

Constructing and maintaining a call center with the traditional complex telephony devices is a difficult and costly proposition. Traditional telephony equipment tends to be very expensive to purchase and maintain. For example, traditional telephony equipment can be very complex to initially configure and later modify. Furthermore, the lack of inter-operable standards between such expensive traditional telephony equipment can lock in a purchaser to a specific vendor once an initial large investment in that vendor's telephony equipment has been made.

Due to the large expense and the complexity to install and maintain the required telephony equipment, the ability to create and maintain a large call center has been primarily the domain of large corporations. Only large corporations can afford the initial investment cost and can continue paying for the operating costs.

Smaller corporations have had to either outsource call center functions to a call center service provider or make due with inferior low-cost telephony equipment until growth allows such small corporations to upgrade to the more complex telephony equipment. It would therefore be desirable to provide small entities such as small businesses with better telephony solutions to handle small entity call center needs.

### DETAILED DESCRIPTION OF THE PREFERRED EMBODIMENT

A methods and apparatuses for implementing a business call center application that is built using Voice over Internet Protocol (VOIP) technology are disclosed. In the following description, for purposes of explanation, specific nomenclature is set forth to provide a thorough understanding of the present invention. However, it will be apparent to one skilled in the art that these specific details are not required in order to practice the present invention. For example, although the present invention has been described with reference to specific data communication and storage standards, the same techniques can easily be applied to other types of data communication and storage standards.

### GLOSSARY

This document contains many specialized terms. To aid the reader, this section presents a glossary of many of the commonly used terms in this document:
Call Center—A telecommunication application presented by the present invention for handling incoming and outgoing telephone traffic and distributing that traffic among a set of human agents.
Agent Server—A server program for managing the various human agents that work with a call center.
Agent Console—A program running on an agent's personal computer workstation for interacting with the Agent Server and Call Center.
Session Initiation Protocol (SIP)—A well-known Internet standard for handling voice traffic on the packet-switched Internet Protocol.
Voice over Internet Protocol (VoIP)—A general term for the technology used to carry telephone voice traffic on the packet-switched Internet.
Interactive Voice Response (IVR)—A programmable system for playing a set of announcement prompts to a caller and accepting touchtone or voice input from the caller.
Screen Pop—A term for the technology and feature of presenting information related to a call on an agent's workstation.

### Voice Over Internet Protocol

The Internet is a packet-switched communication network wherein each data packet that flows through the network to a destination will not necessarily follow the same path as other data packets. In contrast, the traditional telephone network is a circuit switched network that creates a virtual point-to-point connection between the two ends of a telephone call such that all of the call information travels across the same virtual point-to-point connection.

The Internet was created to carry digital computer data between different computer systems. Over the last thirty years, the data transmission capacity of the Internet has grown immensely such that even large digital files such as photographs, audio, and video are routine carried. But voice communication is a very important tool for humans. It was thus inevitable that the internet would be used to carry voice data even though it was not specifically designed for such a purpose. To accomplish this goal, the Session Initiation Protocol (SIP) standard was created in order to standardize telephony traffic on the Internet. Specifically, Request For Comments (RFC) document 3261, also known as RFC 3261, was created to handle telephony functions in the Internet Protocol (IP). An industry has grown up around the ability to carry telephony information across the Internet. That industry commonly refers to the technology as Voice over Internet Protocol (VoIP).

### VOIP Based Call Center

Voice over Internet Protocol (VoIP) has provided a useful alternative telecommunication system apart from the traditional telephone network. One of the real powers with VoIP technology is that it may be deeply integrated with network computer systems. In this manner, an office may be created using only computer network wiring instead of both telephone network wiring and computer network wiring. Furthermore, only digital packet-switched networking equipment is required instead of both telephone switch equipment and digital packet-switched networking equipment. The present invention takes advantage of the features by introducing VoIP-based call center telephony equipment that is software-based and runs on inexpensive off-the-shelf personal computer (PC) systems.

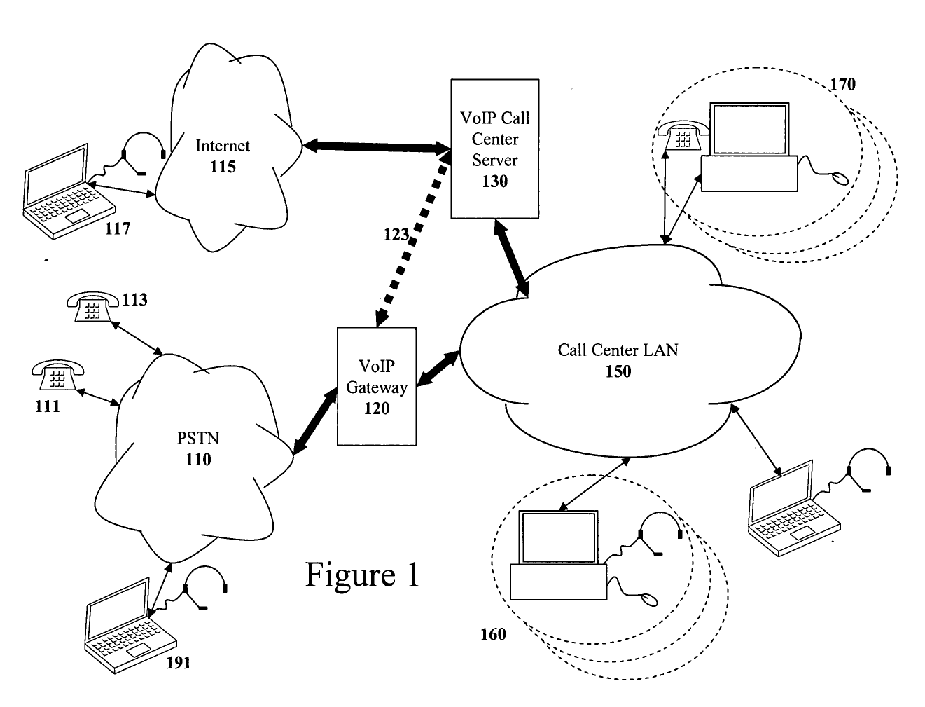

FIG. 1 illustrates a block diagram of an example use of the VoIP-based call center system of the present invention. Referring to FIG. 1, the traditional Public Switched Telephone Network (PSTN) 110 is coupled to a Voice over Internet Protocol (VoIP) gateway 120 in order to convert all incoming traditional telephone communication into VoIP based telephony telecommunication. This is performed using the well-known SIP telephony protocol set forth in RFC 3261. Once converted to the VoIP format, the incoming VoIP-based calls are directed to the Call Center Server system 130 that forms the core of the present invention.

In the embodiment of FIG. 1, the VoIP calls are carried on Call Center LAN 150 to Call Center Server system 130. In an alternate embodiment, the VoIP calls are directed to the Call Center Server system 130 across a direct connection illustrated by dotted line 123. Such an embodiment may reduce the amount of traffic on the Call Center LAN 150.

The Call Center Server 130 may provide a wide array of advanced telephony features that are desirable in a call center environment. The following list describes some of the telephony features that may provided by the Call Center Server 130.
Call Queuing and Call Distribution—Incoming calls are placed into a queue. The call queuing program queues incoming telephone calls based upon various criteria such as time, skills of available agents, and customer data. Calls may be distributed to a set of available agents based upon by many different factors. The call distribution may factors may include as agent skills, the caller's waiting time, the caller's DNIS and/or ANI (or any other information associated with a call), etc. Furthermore, this information can be used to provide a screen pop (described below) to the selected agent.
Interactive Voice Response (IVR)—Incoming calls are connected to a interactive system that collects information from the caller and provides the caller with a set of options on how to proceed. The IVR system provides traditional IVR features to a VOIP based call center. An Application Builder (App Builder) allows call center administrators to create custom IVR scripts and programs. The App builder is a simple GUI based scripting system.
Call Logging—Various telephone calls may be monitored and/or recorded for quality assurance purposes. Every interaction between an agent and a caller is logged into a database.
Agent Monitoring—The work metrics that cover agent performance may be recorded and reported.
Screen Pop—The Screen Pop system allows the VOIP based call center system to interact with other computer programs using standard protocols in order to provide agents with relevant information about incoming calls. For example, the IVR system may first be used to obtain an account number associated with an incoming caller. Later, when an agent is assigned to the call, a screen display containing relevant account information about the caller will pop onto the agent's computer screen (hence the term ‘screen pop’).

Referring back to FIG. 1, the VoIP Call Center Server 130 can direct VoIP calls to agents coupled to the Call Center LAN 150. A first set of agent stations 160 use a personal computer with a headset coupled to the personal computer's sound output and the personal computer's microphone input. In this manner, a software-based telephone application (known as a “softphone”) can be used on the personal computer to handle the telephone call. In addition to the softphone application for handling a VOIP-based telephone call, the personal computer runs an agent program that handles interactions with the VoIP Call Center Server 130. The personal computer may also run other programs that allow the agent to obtain data associated with the caller as set forth with the screen pop feature described above.

A second set of agent stations 170 may use stand-alone SIP-based digital telephones or traditional analog telephones that are outfitted with a SIP adaptor. Such agent stations must associate the address of the stand-alone SIP telephone or SIP adapter with the agent program running on the personal computer.

In addition to calls received over the Public Switched Telephone Network (PSTN) 110, calls may also be accepted from customers using VoIP telephony across the Internet 115. Similarly, the VoIP Call Center Server 130 may direct calls to agent stations that are located off-site across the Internet 115. For example, VoIP Call Center Server 130 could direct a call to an agent using personal computer 117 coupled to the Internet 115. In this manner, the VoIP Call Center Server 130 may be used to employ a number of work-at-home employees that are contacted across the Internet 115.

### Call Center Basics

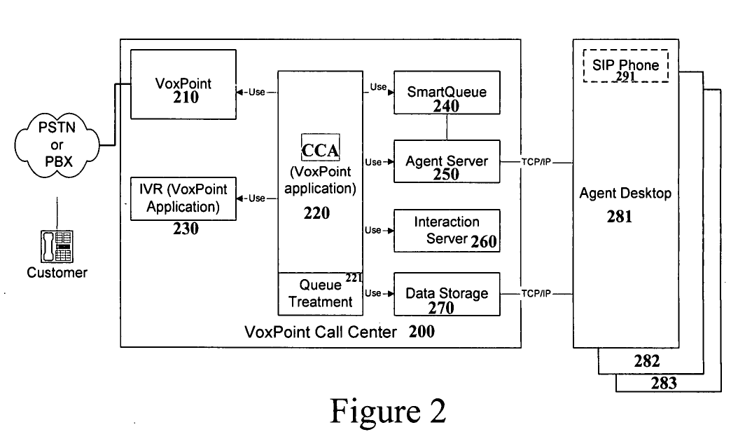

FIG. 2 illustrates the general architecture of the Call Center Server 200. Although FIG. 2 illustrates a number of server components on a single Call Center serve 200, one skilled in the art recognizes that the components may be spread on many different server systems.

The Call Center Server 200 is comprised of the following main sub components: Voxpoint telephone interface 210, Call Center Application (CCA) 220, Interactive Voice Response module 230, SmartQueue 240, Agent Server 250, Interaction Server 260, and Data Storage module 270.

As illustrated in FIG. 2, a Voxpoint module 210 provides the interface to the telephone system. The Voxpoint module 210 may handle different telephony interfaces including a Private Branch Exchange (PBX), Voice Over Internet Protocol (VOIP), and the Public Switched Telephone Network (PSTN).

The Call Center Application 220 is the main module for handling each incoming telephone call. The Call Center Application 220 handles the call flow of each customer call. In one embodiment, the Call Center Application 220 is a Jscript application.

The Interactive Voice Response module 230 provides a programmable Interactive system for providing audio prompts to callers and accepting caller input in the form of touchtone input and/or voice input. The SmartQueue 240 provides the ability of queuing calls and matching those calls with the most appropriate agent for the call.

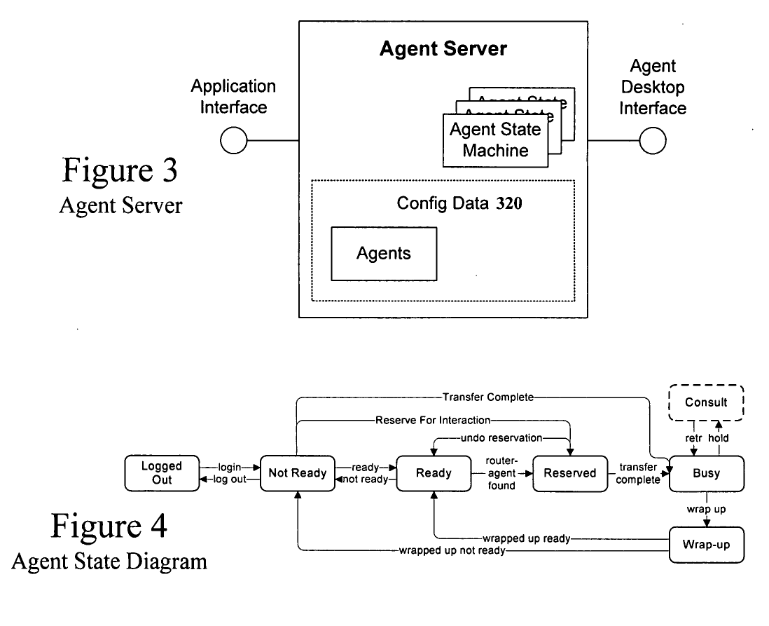

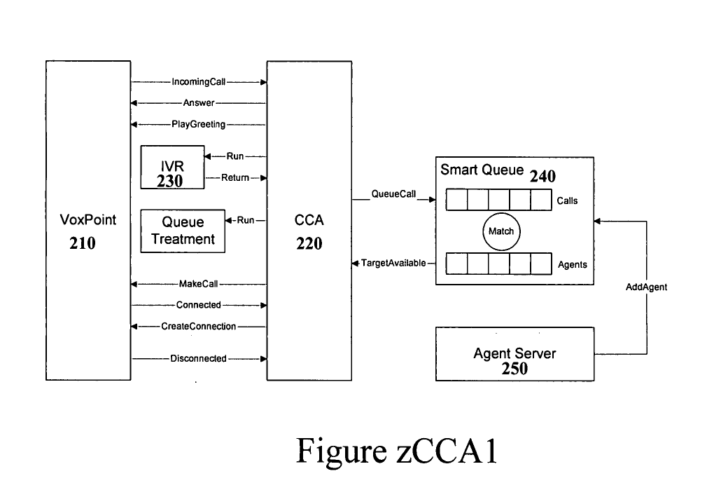

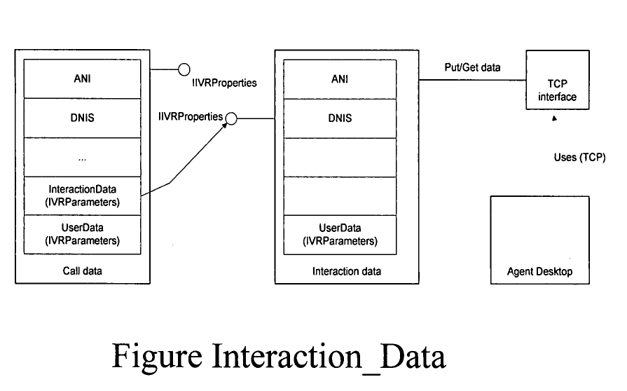

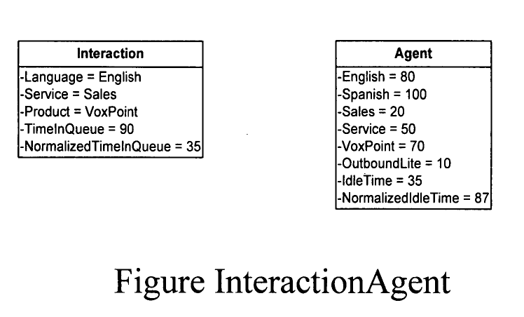

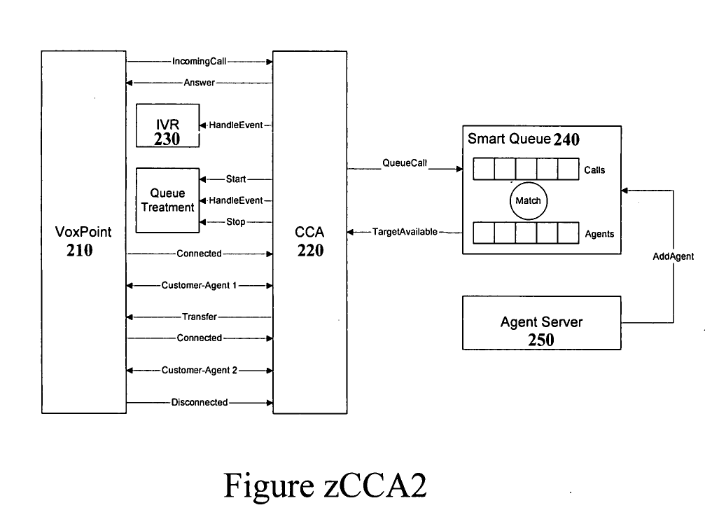

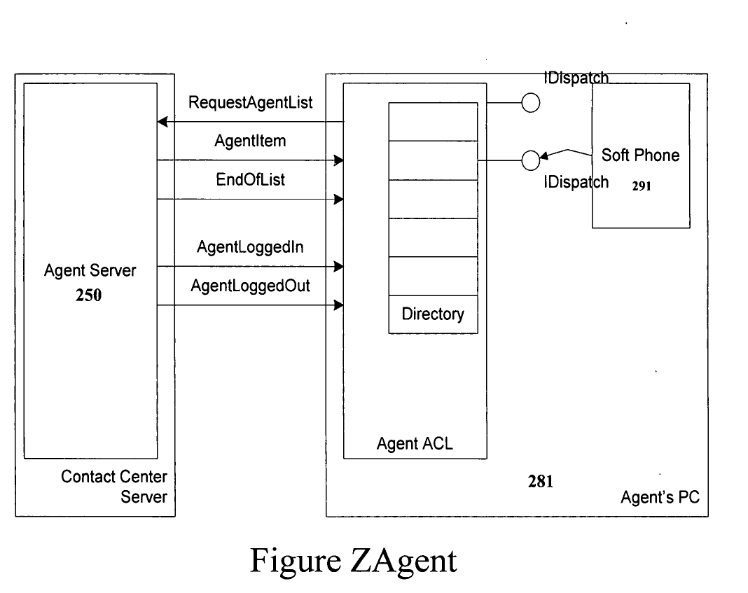

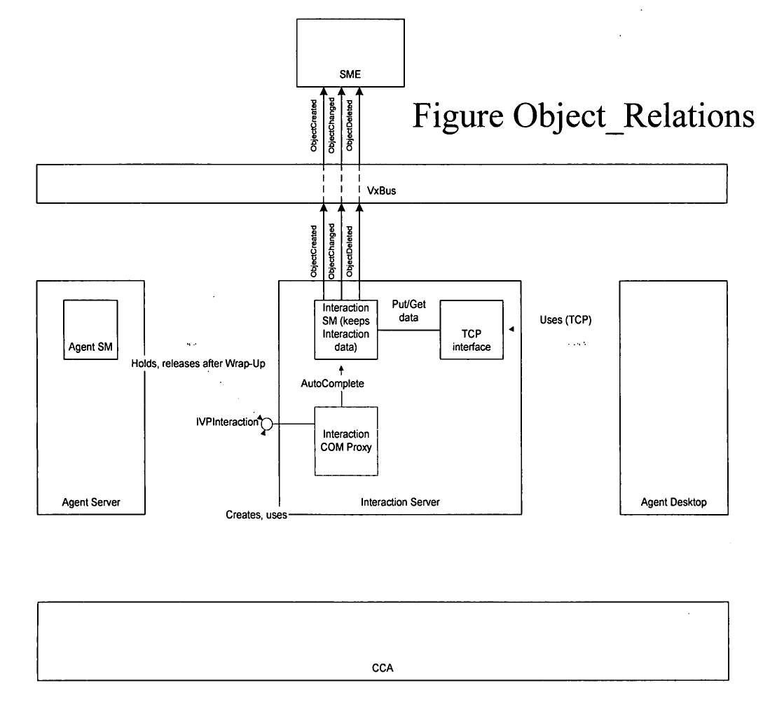

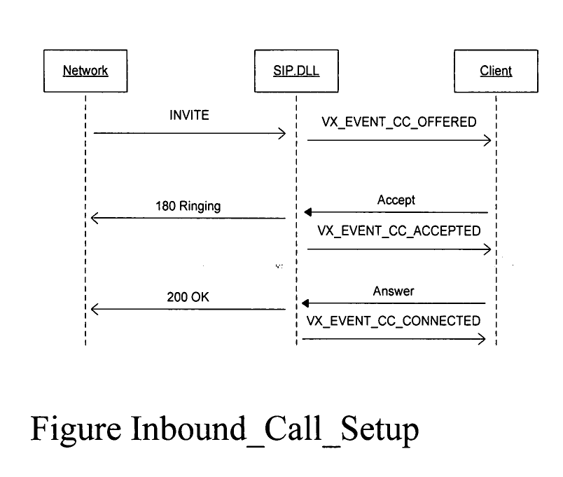

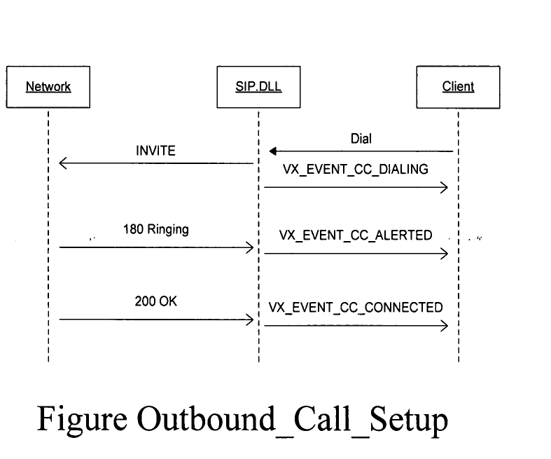

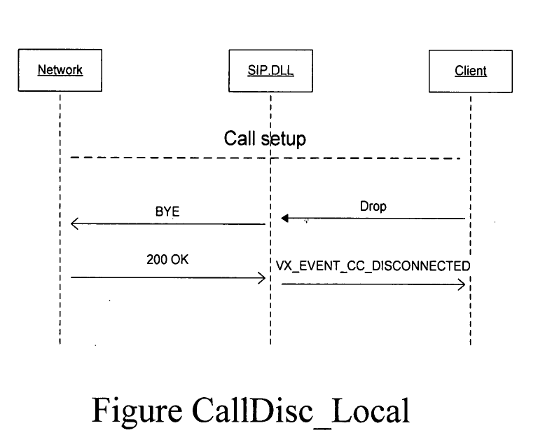

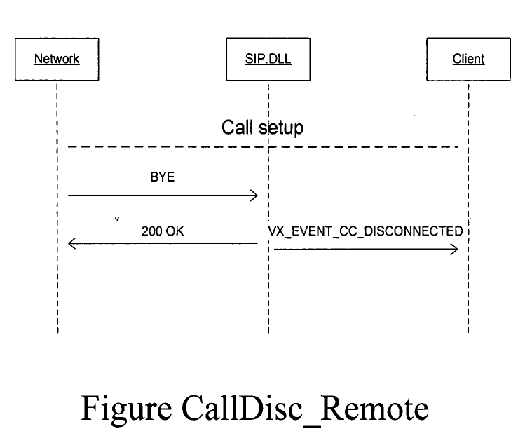

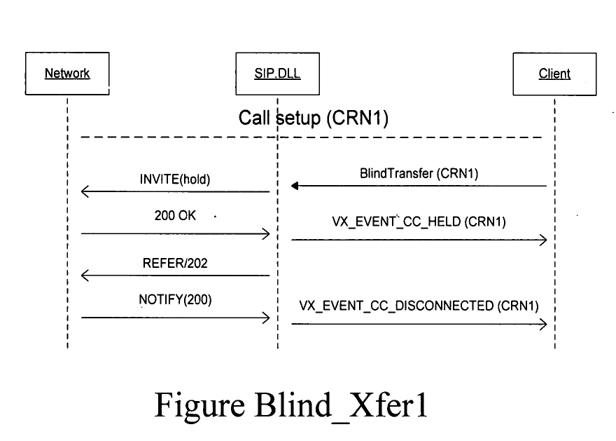

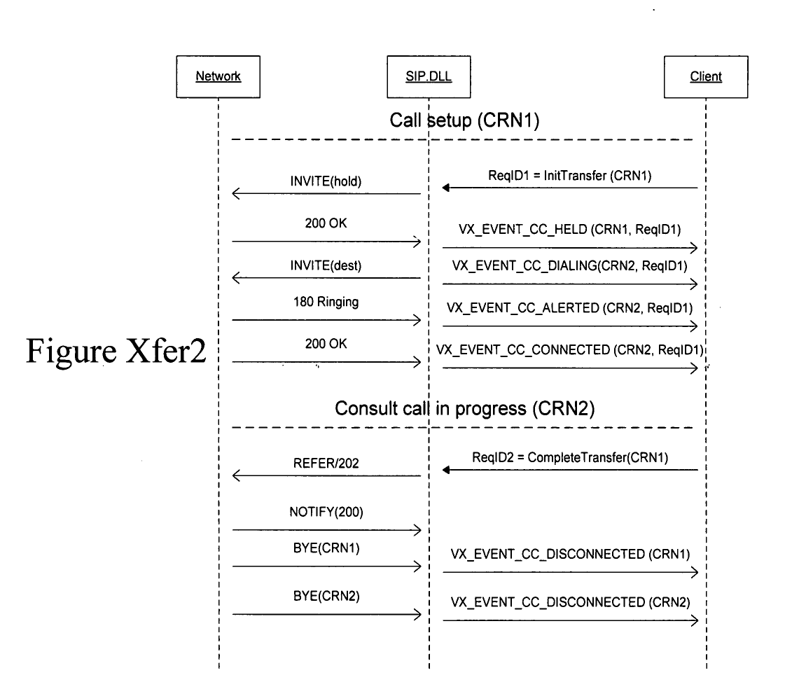

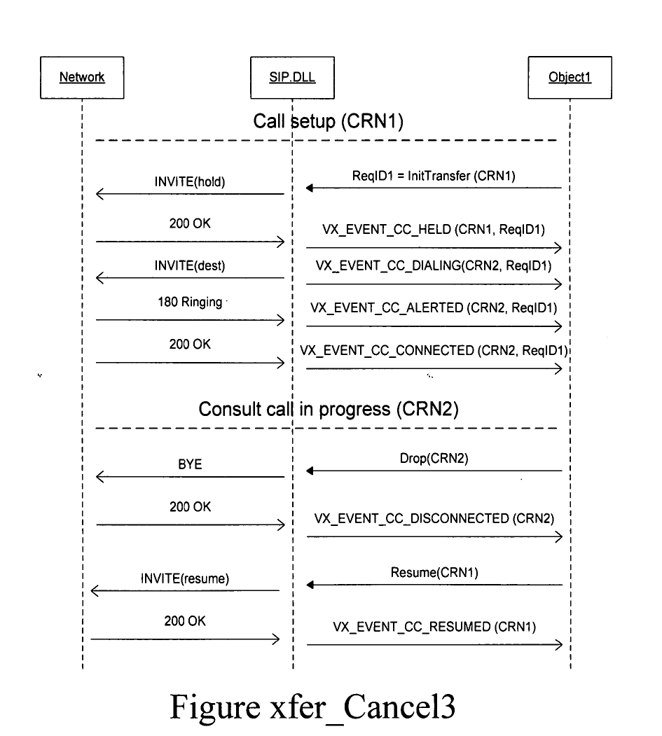

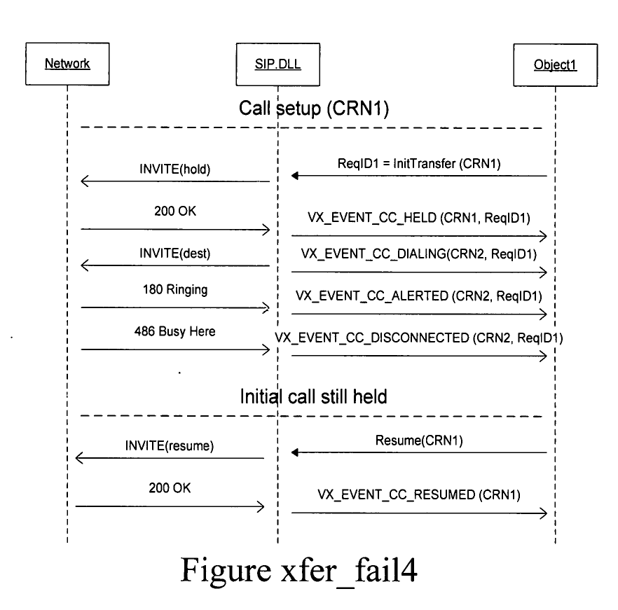

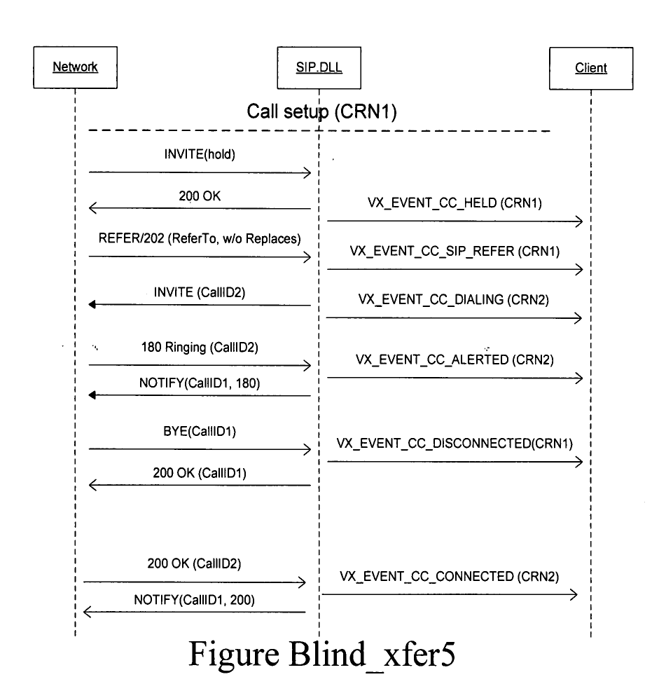

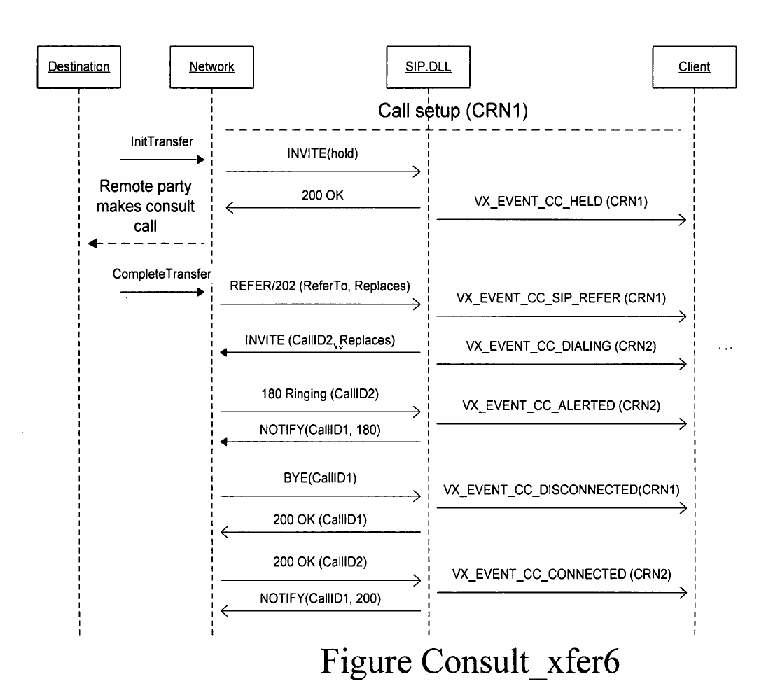

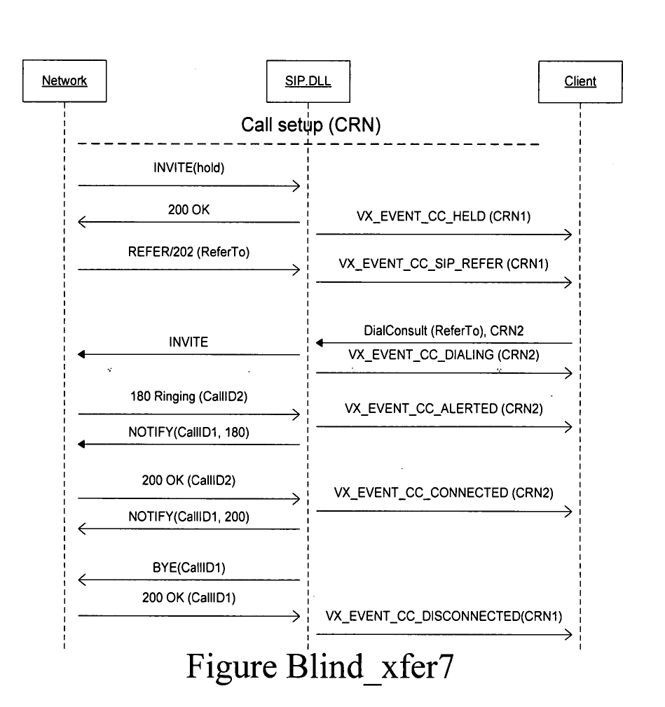

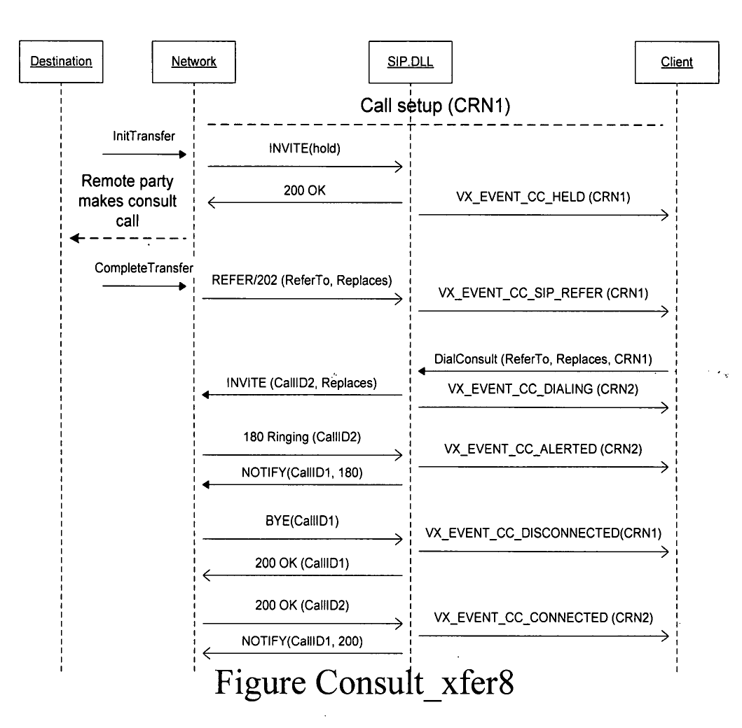

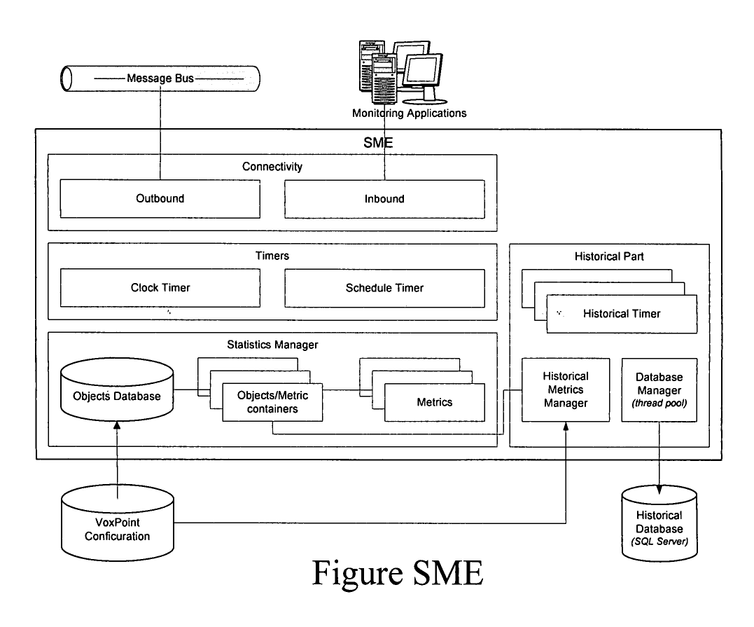

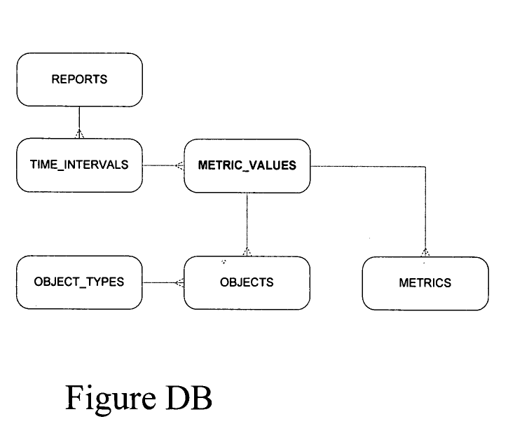

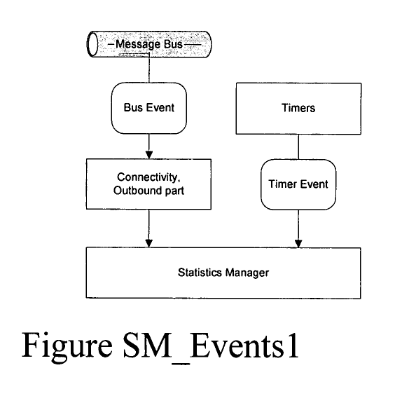

The Agent Server 250 keeps track of all the available customer agents for handling telephone calls. FIG. 3 illustrates a block diagram of the Agent Server 250. The Agent Server 250 creates and maintains agent state machines based on Call Center configuration information 320. For each agent it implements two interfaces: COM interface for using by CCA and other Call Center Server components and TCP/IP interface for using by agent desktop. The Agent Server 250 provides agent state information to the Call Center management framework via VoxPoint Message Bus (also known as the VxBus). The Agent Server 250 implements a basic agent management model (Start/Shutdown) and advanced management (Logout agent). In one embodiment, the Agent Server 250 is implemented as C++ EXE application.

The Interaction Server 260 maintains a log of all customer interactions handled by the Call Center 200. Finally, the Data Storage module 270 provides database services to the other modules. Specifically, the Data Storage module 270 provides database services to the Interaction Server 260 for maintaining a database of all the customer interactions.

CCA

Call Center Application implements call flow of the customer's call in the Call Center. CCA is implemented as standard VoxPoint application (JavaScript) and handles lifespan of the call from call arrival to call release.

CCA may call IVR application, if defined.

Every call is processed by separate instance of CCA.

Interaction Server

Interaction Server performs following tasks:
maintains database of Contacts and Interactions (to be implemented later)
Creates, maintains and keep track of the runtime Interactions
Sends management messages via Bus (ObjectCreated, ObjectChanged, ObjectDeleted)
Stores runtime interactions in the database when Interaction completes (to be implemented later)
Store interaction data with runtime and permanent interactions (replaces current Data Server)
Provides TCP connectivity for clients (Agent Desktop, for example).
   SmartQueue Module

SmartQueue performs following tasks:
Keeps list of customer's calls
Keeps list of the free (Ready, not busy) agents
Matches calls and agents

SmartQueue keeps list of the calls, which are waiting for an agent and list of available agents. CCA puts calls to the SmartQueue. AgentServer reports all available (Ready) agents to the SmartQueue.

When new call is arrived to SmartQueue it checks all available agents for match with the call. If it finds the match—it reserves matched agent and sends “TargetAvailable” event to the CCA. If no available agent exists for this call—SmartQueue pits the call in the internal call list.

When new ready agent is reported to SmartQueue by AgentServer, SmartQueue checks all remembered calls for the match. If match is found—it reserves matched agent and sends “TargetAvailable” event to the CCA. If no call exists for this agent—SmartQueue pits the agent in the internal agent list.

Call/agent match algorithm is isolated in separate entity named Matcher. Matcher maybe implemented as external COM object (JavaScript or C++) and can be defined for every particular call or for the whole system.

Situation with no logged agents is handled separately. When last agent log out of Agent Server, it notifies SmartQueue about that. SmartQueue will send “NoLoggedAgents” event to all calls, which are waiting for agent. Also SmartQueue will respond with “NoLoggedAgents” event to all new calls.

SmartQueue resumes normal work when Agent Server notified it about first logged agent.

Matchers

Matchers are described in separate document “Call Distribution.doc”.

Data Storage

Data Storage keeps interaction data in memory. When CCA receives new incoming call it put all user data (CallProperties (“UserData”) node) into the Interaction. Data Storage then provides access to these data via TCP link.

Data Storage assigns cookie to that data and returns this cookie to CCA. CCA then passes this cookie to selected agent, so it's agent desktop may request call data from Data Storage.

Agent Desktop

Agent's desktop provides a possibility to login/logout/ready/not_ready. It is implemented as HTML document with embedded ActiveX controls.

Agent Desktop keeps two TCP connections:
To the Agent Server—to perform agent commands (Login, Logout, etc.) and receive notifications about new Interactions
To the Data Storage—to access Interaction data

When CCA is used along with SIP VoIP, it also utilizes SIP client, which allows agent to send and receive IP calls directly from the desktop, using computer's speakers and microphone.

This section defines some basic information used by the Call Center.

Call Properties

This section categorizes the various Call Properties that may be associated with a call. The call properties maybe divided onto following categories:
Common call attributes
Telephony type specific call attributes (CTI, VoIP, . . . )
User-defined properties (User data)

There are a number of properties which are assigned at call creation and should not be changed during call life. Other properties are user-definable and maybe changed. The following table summarizes existing call properties.

| | | | | Read | |
|---|---|---|---|---|---|
| | Name | Name | | or | |
| Category | (level 1) | (level 2) | Mandatory | write | Description |
| Common | TelephonyType | | Yes | R | Telephony type: |
| attributes | | | | | “CTI” |
| | | | | | “Standalone” |
| | | | | | “VoIP” |
| | ChannelID | | Yes | R | Call's channel |
| | | | | | configuration ID |
| | CRN | | Yes | R | Call reference number |
| | ANI | | No | R | Automatic number |
| | | | | | identification (if supported |
| | | | | | by telephony layer) |
| | DNIS | | No | R | Dialed number |
| | | | | | identification (if supported |
| | | | | | by telephony layer) |
| Analog | CallName | | No | R | Caller ID name |
| specific | CallTime | | No | R | Caller ID time |
| attributes | | | | | |
| CTI | CTIData | ConnID | Yes | R | T-Server connection ID |
| specific | | | (CTI) | | |
| attributes | | CallType | Yes | R | T-Server call type |
| | | | (CTI) | | |
| | | ThisDN | No | R | TEvent ThisDN |
| | | ThisQueue | No | R | TEvent ThisQueue |
| | | OtherDN | No | R | TEvent OtherDN |
| | | OtherQueue | No | R | TEvent OtherQueue |
| VoIP | SIPData | FullRemote | Yes | R | Full SDP of the remote |
| specific | | SDP | | | end. Always present for |
| attributes | | | | | inbound calls. Present for |
| | | | | | outbound calls after |
| | | | | | appctx.RequestMedia( ) call |
| | | | | | and “MediaReceived” |
| | | | | | event. |
| | | FullLocalSDP | Yes | R | Full SDP of the local end |
| | | | | | (VoxPoint). Always |
| | | | | | present. |
| | | AcceptedRemote | Yes | R | Accepted SDP of the |
| | | SDP | | | remote end. Present after |
| | | | | | call is connected. |
| | | AcceptedLocal | Yes | R | Accepted SDP of the local |
| | | SDP | | | end. Present after call is |
| | | | | | connected. |
| | | Codec | Yes | R | Current RTP codec |
| | | CSeq | Yes | R | Initial INVITE CSeq |
| | | | | | header |
| | | Call-ID | Yes | R | Initial INVITE Call-ID |
| | | | | | header |
| | | Contact | No | R | Initial INVITE Contact |
| | | | | | header |
| | | Content- | Yes | R | Initial INVITE Content- |
| | | Length | | | Length header |
| | | Content- | Yes | R | Initial INVITE Content- |
| | | Type | | | Type header |
| | | Expires | No | R | Initial INVITE Expires |
| | | | | | header |
| | | From | Yes | R | Initial INVITE From |
| | | | | | header |
| | | To | Yes | R | Initial INVITE To header |
| | | User-Agent | No | R | Initial INVITE User-Agent |
| | | | | | header |
| | | Via | Yes | R | Initial INVITE Via header |
| | | <any other | | R | All other SIP headers of |
| | | SIP | | | the initial INVITE |
| | | header> | | | message. |
| User data | UserData | <any> | Yes | R/W | User properties. |
| | | | | | Represented as |
| | | | | | IIVRParameters of level 2. |
| | | | | | Nodes of second level are |
| | | | | | user-definable, read/write. |
| | | | | | Pre-filled with TEvent |
| | | | | | UserData for CTI version |

Call Center Basics

This section defines design of the Call Center. First, each of the main entities in Call Center are defined.

Address

Address represent single terminal of media type (voice, VoIP, email etc.).

Address is a final target of the routing procedure.

Agent—

Agent is a person, who works with customer. Each agent has several attributes:
ID—unique identifier (username) of the agent in Call Center
Password
Address—default address
Attribute properties (collection)

Agent may be in one of several states. The state machine of agent is illustrated in Figure xas.

Desktop transition requests:
Login
Logout
Ready
Not Ready

Application transition requests:
Reserve (agent found)
Busy (transfer complete)
WrapUp
Undo reservation (automatic on object release)

When an agent comes to the office, he/she should log into the Agent Server first. During login, agent has todefine his/her AgentID, and password. Agent may also define his address when logging, if address is different that agent's default address.

When agent's working day finished, agent should log himself out of Agent Server.

When agent is away from his desk during working day, he should make himself Not Ready.

Interaction

Interaction is an entity, which represents a single interaction of the customer (call, e-mail, chat etc.) with one and only one Agent.

The lifecycle of the Interaction extends beyond the physical call (email, chat) length. When phone call disconnects, Interaction continue to live until agent finishes working with this call.

In general, Call Center may persistently store Interaction in the Interaction Database. This will make Interactions data available even after Interaction ends.

Each Interaction comes through two periods of its lifecycle: Active and Archive.

Active Interaction

When new call (chat, email etc.) arrives in Call Center, new Interaction is created. Such Interaction is considered Active. Active interaction maybe queued, handled by an agent etc.

Active interaction lifecycle is described by Active State Machine, mentioned in the next chapter 0.

Note, that Active interaction lifecycle is reflected by Management Protocol bus events, lice ObjectCreated, ObjectChanged and ObjectDestoryed. When interaction becomes Archive, ObjectDeleted management message is sent to the bus.

State Machine

During its lifecycle, Active interaction transits through several states and generates management events. The state diagram of Interaction is represented on the picture below:

Figure ZIS. Interaction state machine

The following Call Center entities communicate to Interaction:

Figure XR. Relations to other objects

Archive Interaction

When agent completes working with interaction, Interaction is stored in persistent database and becomes Archive.

Archive interactions maybe viewed, but cannot be sent back to an agent(s).

Currently Archive Interactions are not implemented.

Case

When customer calls Call Center to get some service, new Case is created. Case may involve one or many phone calls, e-mails and/or chat sessions with one or many Call Center Agents.

A single Case is usually consists of one Interaction, but it may involve multiple Interactions. For example, when Agent transfers call to another Agent, there will be two Interactions: one is reflections conversation of the customer with first Agent, and another reflections conversation of the Customer with second Agent. These two Interactions will be linked to each other. Two (or more) such Interaction will compose single Case.

Call Flow (CCA)

Figure zCCA1 illustrates basic Call Center Application call flow.
Incoming call arrives to VoxPoint
VoxPoint starts CCA application (based on regular application selection rules)
CCA create Interaction for this call
CCA answers the call
If CCA configuration defines greeting message (“PromptGreeting” parameter), CCA plays it
If CCA configuration defines IVR application ProgID (“IVR” parameter), CCA creates this application and runs it
IVR application may attach user data to the call—those data will be used later for searching for agent
CCA calls SmartQueue module—QueueCall and passes incoming call to the SmartQueue (asynchronous call) and waits for event during 1 second
If CCA receives “NoLoggedAgents” event—it plays “PromptNoAgents” message and returns
If CCA does not receive any events during this 1 second, it starts built-in queuing application
When SmartQueue find appropriate agent it will put “TargetAvailable” event in the application context event queue (standard VoxPoint)
When CCA gets “TargetAvailable” event—it terminates queuing
CCA reports new interaction to the reserved Agent
Depending on the version, CCA will either flash-transfer call to the agent's address or make outbound call to the agent. Selected agent automatically gets reserved by SmartQueue before issuing event. This guarantees availability of selected agent
When agent's call connected or transfer is completed, CCA makes agent busy (Busy method)
If CCA performed outbound call to an agent, it switches customer and agent and waits for disconnect of any leg. Otherwise CCA just exists.
   Interaction Transfer

An agent may decide to transfer current active Interaction to another agent or IVR. During this step, current Interaction behave as call was terminated (it goes into Wrap-Up state). New interaction is created to reflect the fact, that customer will talk to another agent.

Two interactions will be linked to each other, so it would be possible to restore full path of the single customer's call (email, chat) through the Call Center.

The full transfer process looks like this:
Interaction is delivered to agent 1, interaction 1 is in Delivered state
Agent 1 initiates transfer. Interaction 1 goes to Held state, new Interaction 2 is created in Idle state.
Interaction 2 goes to Delivery Pending state
When destination answers, Interaction 1 goes to Wrap-Up state, Interaction 2 goes to Delivered state

Interaction 2 will have attribute “AgentID’ set to ID of the destination agent (if this is an agent). If destination is not an agent, this attribute will not exist.

Interaction 2 will have attribute “PreviousInteractionID” set to the ID of Interaction 1.

If transfer destination cannot be reached for any reason, Interaction 1 goes back to the Delivered state, Interaction 2 goes to Completed state.

Call and Interaction Data

Both VoxPoint telephone call object and Interaction have some attributes and user data. These data accessible via IIVRProperties interface from COM applications. Interaction data also accessible via TCP interface.

When call-related Interaction is created by CCA, the pointer to the Interaction data is placed in associated Call data as InteractionData KV-pair. This allows IVR Point application to have an access to the Interaction data without being aware of Interaction object itself.

Also, when CCA creates new Interaction, it copies all call data into Interaction data. Since call data are destroyed when call disconnects, such approach allows to keep call data even after call is destroyed.

When call is transferred from one agent to another agent, all data of the previous interaction are copied into the new interaction. However, all changes in second interaction data will NOT be propagated to the first interaction.

Figure Interaction_Data shows call and interaction data and their relationships.

Management (Bus) Events

Interaction Bus Events

Interaction generates following events (ObjectType is always “Interaction”):
ObjectCreated—when Interaction arrives. Content:
   ObjectID—[mandatory] unique interaction ID
ObjectChanged—whenever Interaction's state or attribute changes. Content:
   ObjectID—[mandatory] unique interaction ID
   AgentID—[optional] ID of the Agent, who handles the interaction. Present, when Interaction is in DeliveryPending, Delivered, Wrap-Up and Held states. Not present in Arrived, DataCollection and Queued states. For Completed state AgentID is present, if interaction comes from Delivered, Wrap-Up and Held states and absent when interaction arrives from any other state.
   ServiceType—[optional] type of the interaction's service. May appear, when service is determined for Interaction (after DataCollection state).
ObjectDeleted—when Interaction enters Completed state
   ObjectID—[mandatory] unique interaction ID
   AgentID—[optional] ID of the Agent, who handles the interaction. Present, if Agent was assigned to Interaction during Interaction lifecycle.
   ServiceType—[optional] type of the interaction's service. May appear, if service was ever determined for Interaction.
      Agent Bus Events

Agent generates following events (ObjectType is always “Agent”):
ObjectCreated—when Agent is created (during Call Center startup). Content:
   AgenttID—[mandatory] unique interaction ID
   Address—[mandatory] address of the agent's place (phone)
   State—[mandatory] agent's state
   CRN—[mandatory] agent's call, 0 if agent does not process any calls
ObjectChanged—whenever Agent state or attribute changes. Content:
   AgenttID—[mandatory] unique interaction ID
   Address—[mandatory] address of the agent's place (phone)
   State—[mandatory] agent's state
   CRN—[mandatory] agent's call, 0 if agent does not process any calls
ObjectDeleted—when Interaction enters Completed state
   AgenttID—[mandatory] unique interaction ID
   Address—[mandatory] address of the agent's place (phone)
   State—[mandatory] agent's state
   CRN—[mandatory] agent's call, 0 if agent does not process any calls
      IP Connection TCP/IP Protocol

Agent Desktop talks to Agent Server and Data Storage via two separate TCP/IP connections. Both connections utilize IP Connection Protocol, based on the VoxPoint binary protocols framework.

Both Agent Server and Data Storage listen on specific port (each server listens on its own port) for incoming connections. When new incoming connection arrives, server(s) accept this connection and open separate socket. After that Desktop may send messages to the server and server may send messages to desktop.

IP connection Protocol (C:IPP Protocol ID 0x2000) allows clients send arbitrary Commands to the servers and receive arbitrary events from the Servers. Each command and event consists of the list of Key-Value pairs.

The following messages constitute the protocol:

| Packet | Direction | Description |
|---|---|---|
| Command Packet | Command/Event | Client sends this packet to server to |
| (ID = 0) | | request command. Server sends |
| | | same packet to the client to report |
| | | event. |

The Command packet consists of the following elements:

| # | Element | Type | Description |
|---|---|---|---|
| 1 | Packet ID | 8-bit unsigned integer = 0x00 | Identifier of packet. |
| 2 | Attributes | 16-bit unsigned integer | Number of packet |
| | count | | attributes |

| | | |
|---|---|---|
| 3 | Attributes list | Sequence of structures that represent pairs of |
| | | attribute names and values. Layout of an |
| | | individual structure explained below. |

The following table shows the layout of an attribute structure:

| # | Element | Type | Description |
|---|---|---|---|
| 1 | Attribute name | 16-bit unsigned integer | Number of Unicode |
| | length | | characters that follow the |
| | | | length. |
| 2 | Attribute name | Sequence of Unicode | Characters that constitute |
| | | characters | name of the attribute. |
| 3 | Attribute value | 16-bit unsigned integer | Number of Unicode |
| | length | | characters that follow the |
| | | | length. |
| 4 | Attribute value | Sequence of Unicode | Characters that constitute |
| | | characters | value of the attribute. |

AgentDesktop—AgentServer Interface

Commands are generated by desktop user interface in response to agent actions (press buttons). Agent Server does not generate any response on commands. Instead, it will generate StateChanged event when actual agent's state changed.

Login

Command: Login
AgentID: <id>—[string] agent id as defined in agent server configuration, mandatory
Password: <password>—[string] agent password as defined in agent server configuration, mandatory
Address: <address>—[string] agent address (DN), optional. If omitted—configuration address will be used.
All other parameters are treated as agent attributes and will be added to the configuration's attributes list
   Logout
Command: Logout
   Ready
Command: Ready
   NotReady
Command: NotReady
Reason: <reason>—[string] reason, optional.
   GetState
Command: GetState
   Busy
Command: Busy
   Reserve
Command: Reserve
   UndoReserve
Command: UndoReserve
   Server→Desktop

These are the messages, sent by Agent Server to the agent's desktop.

StateChanged

Event: StateChanged
NewState: <integer state>
NewStateStr: <string state>

Sent to desktop as a result of state change or GetState request.

<integer state>:
0—AS_INIT,
1—AS_LOGGED_OUT,
2—AS_NOT_READY,
3—AS_READY,
4—AS_RESERVED,
5—AS_BUSY,
6—AS_WRAP_UP,
7—AS_FINAL

<string state>:
“initialization”,
“Logged out”,
“Not ready”,
“Ready”,
“Reserved”,
“Busy”,
“Wrap up”,
“Final”,
   Shutdown
Event: Shutdown

Sent to desktop when agent server shuts down

NewInteraction

Event: NewInteraction
InteractionID: <integer>

Reports a new interaction.

InteractionID is a cookie for interaction data in data storage.

CallAttached

Event: CallAttached
CRN: <integer>

Reports a new call assigned to that agent.

CallDetached

Event: CallDetached
CRN: <integer>

Reports a call removed from that agent.

Desktop→Storage

Agent desktop sends commands to the Data Server. Data Server will respond to command by event.

Result codes:
0—OK
1—node not found
2—node is a subtree
3—cookie is invalid (no such cookie)
4—cookie is valid, but data has expired
−1—Generic error

Data key (path) may represent path in data tree. Nodes are separated by backslash symbol (\). Path may or may not begin from backslash.

Path samples:
name1 (just one top level node)
\name1—same as name 1
name1\name2\name3 (without first flash)
\name1\name2\name3 (with first flash)
   PutItems
Command: PutItems
IntreractionID: <integer>
Path: <path>
Value: <value>

Data Storage responds with PutItems event.

GetItems

Command: GetItems
IntreractionID: <integer>
Path: <path>

Data Storage responds with DataRetrieved event.

DeleteItems

Command: DeleteItems
IntreractionID: <integer>
Path: <path>

Data Storage responds with DeleteItems event.

Storage→Desktop

DataRetrieved

Event: DataRetrieved
IntreractionID: <integer>
Result: <code>
ResultText: <string>—textual representation of result
Path: <path>
Value: <value>—data value (only if Result=0)
   PutItems
Event: PutItems
Result: <code>
ResultText: <string>—textual representation of result
IntreractionID: <integer>
Path: <path>
   DeleteItems
Event: DeleteItems
Result: <code>
ResultText: <string>—textual representation of result
IntreractionID: <integer>
Path: <path>
   Call Center Application

This document describes the Contact Center Applications of the Call Center.

Common Information

COM Implementation

The CCA is implemented as Jscript COM object. It is standard VoxPoint application, which implements IIVRApplication COM interface.

New CCA instance is created for each incoming call. This instance will keep track of the incoming call during its entire lifecycle.

Tasks

CCA performs the following tasks:
Answers incoming call
Optionally calls external IVR script to collect data from the customer or for service selection
Queues call until most appropriate agent is found
Connects customer with selected agent
Performs call transfer if requested by an agent
Maintains Interactions
   CCA Implementations

There are two CCA implementations:
CCA_Refer.wcs
CCA_Bridge.wcs
   Bridge

This implementation of CCA uses following features:
CreateConnection( ) method of application context to switch calls
DTMF tones to transfer the call

CCA_Bridge does not depend on the telephony technology and may work with all four VoxPoint flavors (Plain Telephony, CTI telephony, Cisco CallManager and SIP).

Refer

This implementation of CCA uses following features:
Selectable SIP ReINVITE or CreateConnection( ) method to switch calls
SIP REFER mechanism to transfer the call

Using ReINVITE for call switching allows greatly reducing loading of the VoxPoint computer because it passes RTP voice streams directly between SIP endpoints (customer and agent). However, this makes impossible conversation recording and detection of DTMF digits, sent in RTP stream.

The BridgeRTP parameter defines the call switching method. It it is TRUE—CreateConnection( ) will be used, which keeps control of the RTP streams on the VoxPoint. Otherwise ReINVITE will be used, which keeps RTP stream out of VoxPoint server.

CCA_Refer works only for SIP VoIP technology. It has following limitations:
Supports only standard SIP transfer according to draft-ietf-sipping-cc-transfer-01 IETF document
Works only with SIP phones, that support this protocol (like Cisco 7912m Cisco 7960)
If BridgeRTP parameters is missing or FALSE, VoxPoint cannot receive DTMF digits, if they are sent in RTP stream (RFC2833 or Cisco)
   Algorithm

Figure zCCA2 illustrates basic Call Center Application call flow.

Call Arrival

Upon call arrival CCA performs following:
Answers the call
Creates new Interaction and associates Interaction with incoming call

When CCA creates new Interaction, it passes all call parameters into the new interaction. After that, it places Interaction attributes into the “InteractionData” node of the call's parameters.

All subsequent changes must be made in the Interaction data, which are accessible to the IVR application trough the CallProperties (“InteractionData”) property.

If any of the actions above cannot be performed or fail, CCA plays error prompt to the customer, then disconnects the call.

Data Collection and Service Selection (IVR)

If “IVR” parameter is defined for CCA in the Application Selector, CCA will create IVR application and call it. If there is no such parameter—CCA will continue directly to the Interaction queuing.

IVR application is NOT a standard VoxPoint application. Instead it must implement the following two methods:
Initialize(IIVRAppContext*_piAppCtx)—initializes IVR and starts it
HandleEvent(IIVREvent*_piEvent)—handles VoxPoint event asynchronously
   Initialize

Method Initialize( ) must return true if everything is OK and IVR has started. Otherwise it must return false.

If Initialize returned false, CCA will not continue IVR, but will queue Interaction instead.

HandleEvent

Method HandleEvent must process event and return immediately. It must return TRUE, if IVR has finished and FALSE, if it should continue.

Before returning TRUE, IVR application must place following KVpairs in the Interaction data:
“IVRResult”—result. Maybe one of following:
   “Transfer”—call must be transferred to the destination. The transfer destination is defined by “TransferDN” KVpair in the Interaction data (IVR must place this)
   “Complete”—CCA must continue normal call processing (queuing)

When CCA begins IVR processing, it changes Interaction state to the “CollectData”. When IVR finishes, Interaction state is changed back to “Idle”.

Interaction Queuing—Agent Selection

Next step is locating the most appropriate agent for the call. CCA performs following:
Places the interaction to the SmartQueue (calls SmartQueue.QueueInteraction( ) method)
If there is no any completion events from the SmartQueue during 1 second, CCA starts queue treatment application

When interaction is placed into the queue, the Interaction state is changed to “Queued”.

Configuration parameter may limit the total time of queuing. If time limit is exceeded, CCA will remove interaction from the queue and transfer call to the configurable DN, without waiting for an agent.

Queue time limit is defined by the following two configuration parameters:
“QueueTimeout”—time limit, seconds
“DefaultDestination”—telephone number call must be transferred to

If either of these parameters is missing, interaction will sit in the queue indefinitely.

The following conditions stop queuing:
Matching ready agent is found (TargetAvailable event received). In this case CCA tries to dial an agent and connect it to the customer
Some agent explicitly pulls this interaction from the queue (it works event if agent is in Not Ready state)
Last agent logs out (NoLoggedAgents event received). In this case CCA plays error message to the customer, then disconnects the call
Queue size is over configured limit (QueueLimitExceeded event received).). In this case queue treatment plays error message to the customer, then disconnects the call
Customer hangs up

If “QueueApplication” parameter is defined for CCA in the Application Selector, CCA will create treatment application and use it for treatment. If there is no such parameter—CCA will use built-in treatment application.

Queue Treatment Application API

Queue treatment application is NOT a standard VoxPoint application. Instead it must implement the following methods:

Initialize

bool Initialize(varAppCtx);

Parameters:
varAppCtx—application context of the CCA

Return value: Boolean.

Method initializes internal application resources. CCA calls this method one time right after object is created.

Start

bool Start(varInteraction);

Parameters:
varInteraction—queued interaction, maybe used to obtain EWT

Return value: Boolean.

CCA calls this method right after interaction is placed in the queue. Method may start playing music, for example.

The sample method may look like this:

```
function Start(varInteraction)
{
    m_objInteraction = varInteraction;
    //  Remember interaction estimated waiting time
    m_nEWT = m_objInteraction.Attributes(“EWT”);
    //  Start playing music
    m_objLib.StartMusic(m_Prompts[“Music”]);
    //  Start periodic timer to play reminder
    m_objAppCtx.StartTimer(“TimerReminder”, m_nTimeout, true);
    return true;
}
```

Stop

bool Stop( );

Parameters: none

Return value: none.

CCA calls this method to stop treatments.

The sample method may look like this:

```
function Stop( )
{
    //  StopVoice may fail, if call is already disconnected
    try
    {
      m_objAppCtx.StopVoice( );
      m_objAppCtx.StopTimer(“TimerReminder”);
    }
    catch(e)
    {
    }
    return true;
}
```

HandleEvent

bool HandleEvent(varEvent);

Parameters:
varEvent—event to be processed

Return value: set of the following values:
“EventConsumed”—Boolean, true, if event is processed
“Finish”—Boolean, true if interaction may not be routed.

CCA calls this method when any event is received. If queuing application returns “EventConsuled”=true, CCA will not try to handle the event further. Otherwise, CCA will handle event.

If “Finish” return value is TRUE, CCA will not continue processing the call further. It will end.

The sample event handling method may look like this:

```
function HandleEvent(varEvent)
{
  var varRC = {EventConsumed : false, Finish : false);
  switch (varEvent.Type)
  {
```

| | |
|---|---|
| case “TimerReminder”: | // Time was set in the Start( ), |
| | play EWT reminder |

```
    m_nReqID = m_objLib.PlayStream(CreateEWTPrompt( ));
    varRC[“EventConsumed”] = true;
    break;
  case “PlayCompleted”:
    if (varEvent.ReqID == m_nReqID)  // Reminder is played
    {
      varRC[“EventConsumed”] = true;
    }
```

| | |
|---|---|
| else if (varEvent.ReqID == m_nFinalReqID) | // Final prompt |
| | played |
| { | |
| varRC[“EventConsumed”] = true; | |
| varRC[“Finish”] = true; | // Do not continue... |
| } | |
| break; | |

```
  case “QueueLimitExceeded”: // The service queue limit exceeded - stop
and return
    varRC[“EventConsumed”] = true;
    m_objAppCtx.StopVoice( );
    m_nFinalReqID =
    m_objLib.PlayFile(m_Prompts[“TooManyCalls”]);
    break;
  default:
    break;
  }
  return varRC;
}
```

Built-In Treatment Application

Built-in queue treatment application plays music to the customer. It also plays reminder prompt to the customer every N seconds (configurable via “EWTPeriod” parameter, default is 30 seconds).

Switching with Agent

When CCA receives TargetAvailable event from the SmartQueue, it dials selected agent's phone number and switches customer and agent. After that CCA monitors for the following:
Ether customer or agent disconnects
Agent requests call transfer

When CCA starts dialing agent, it places Interaction into the “PendingDelivery” state.

When agent answers, CCA places Interaction into the “Delivered” state.

If agent cannot be connected (busy or does not answer) CCA changes agent's state to the NotReady and places call back into the queue. Interaction state is changed to “DeliveryError”.

Transfer

When CCA receives transfer request from an agent, it performs transfer. The transfer algorithm depends on the CCA (REFER or Bridge).

Bridge (DTMF Version)

CCA_Bridge uses DTMF tones to interact with agent. It implements attended or blind transfer.

Attended Transfer

Initiate

Attended transfer is initiated when agent press ‘*’ key on the telephone. The following actions are performed:
Customer is placed on hold (music treatment)
Interaction moved to the “Held” state
Dialtone is presented to an agent
Agent enters destination number using DTMF keys

Agent finishes entering destination number by one of the following conditions:
‘#’ key
Timeout (5 seconds)

When agent finishes entering destination number, CCA does following:
Looks agent by entered destination number. If found, CCA tries to reserve this agent. If agent cannot be reserved, CCA still continues transfer
Creates new interaction with all attributes of the original interaction and links new interaction with original one
Initiates outbound call to the destination.
Places consult interaction into “Delivery Pending” state

When destination is reached (OutboundCallDialing event is received), CCA starts playing ringback tone to the agent.

When destination answers, CCA does following:
Connects original agent with destination

If target cannot be connected, CCA does following:
Plays busy tone to the agent and waits to the cancel transfer.
   Complete

Agent completes transfer by hanging up.

When transfer completes, CCA does following:
Terminates call to the original agent
Places original agent into “WrapUp” state
Places original interaction into “WrapUp” state
Connects customer to the destination
Places consult interaction into “Delivered” state
If destination is an agent, places agent into “Busy” state
   Cancel

Agent may cancel transfer and reconnect back to the customer by pressing ‘*’ at any time (before or after destination answers).

CCA does following:
Places consult interaction into “Delivery Error” state and completes it
Terminates consult call
Resumes original interaction
Reconnects customer and original agent
   Blind Transfer
   Initiate

Blind transfer is initiated when agent press ‘*’ key on the telephone. The following actions are performed:
Customer is placed on hold (music treatment)
Interaction moved to the “Held” state
Dialtone is presented to an agent
Agent enters destination number using DTMF keys

When agent finishes entering destination number it just hangs up. At this time CCA does following:
Places original agent into “WrapUp” state
Places original interaction into “WrapUp” state
Looks agent by entered destination number. If found, CCA tries to reserve this agent. If agent cannot be reserved, CCA still continues transfer
Creates new interaction with all attributes of the original interaction and links new interaction with original one
Initiates outbound call to the destination.
Places consult interaction into “Delivery Pending” state

When destination is reached (OutboundCallDialing event is received), CCA starts playing ringback tone to the customer. Consult interaction is changed to “Delivery Pending” state

When destination answers, CCA does following:
Connects customer to the destination
Places consult interaction into “Delivered” state
If destination is an agent, places agent into “Busy” state

If target cannot be connected, CCA does following:
Completes consult interaction
Places customer back into the queue
   Cancel

Agent may cancel blind transfer at any time before hanging up. He does that by pressing ‘*’.

CCA does following:
Resumes original interaction
Reconnects customer and original agent
   REFER (SIP VoIP Version Only)

CCA_Refer uses SIP REFER transfer mechanism. It implements attended or blind transfer.

Attended Transfer

Initiate

Transfer is initiated when agent press Transfer button on the SIP telephone. At this point SIP telephone notifies CCA that call has been put on hold.

The following actions are performed:
Customer is placed on hold (music treatment)
Interaction moved to the “Held” state

Agent finishes entering destination number by SIP phone means (usually it is pound ‘#’ key or Dial button). SIP phone initiates consult call.

When destination is reached SIP telephone connects agent and destination.

If target cannot be connected, agent may resume customer's call by SIP phone means. CCA receives Resume message and does following:
Stops playing hold music to the customer
Reconnects customer and agent
Resumes original interaction
   Complete

Agent completes transfer by SIP phone means (usually Transfer button). When this happens, SIP phone sends REFER event to the CCA.

CCA does following:
Places original agent into “WrapUp” state
Places original interaction into “WrapUp” state
Connects customer to the destination by sending INVITE with SIP Replace header.
Places consult interaction into “Delivered” state
If destination is an agent, places agent into “Busy” state
   Cancel

Agent may cancel transfer and reconnect back to the customer by pressing appropriate button on the SIP phone. CCA receives resume event and does following:
Resumes original interaction
Reconnects customer and original agent
   Blind Transfer
   Initiate

Transfer is initiated when agent press Transfer button on the SIP telephone. At this point SIP telephone notifies CCA that call has been put on hold.
Customer is placed on hold (music treatment)
Interaction moved to the “Held” state

Agent finishes entering destination number by SIP phone means (usually it is pound ‘#’ key or Dial button). SIP phone sends REFER SIP message. At this time CCA does following:
Places original agent into “WrapUp” state
Places original interaction into “WrapUp” state
Looks agent by entered destination number. If found, CCA tries to reserve this agent. If agent cannot be reserved, CCA still continues transfer
Creates new interaction with all attributes of the original interaction and links new interaction with original one
Initiates outbound call to the destination (using SIP Replace header).
Places consult interaction into “Delivery Pending” state

When destination answers, CCA does following:
Connects customer to the destination
Places consult interaction into “Delivered” state
If destination is an agent, places agent into “Busy” state

If target cannot be connected, CCA does following:
Completes consult interaction
Places customer back into the queue
   Cancel

Agent may cancel blind transfer at any time before hanging up. He does that by SIP phone means. SIP phone sends resume event to the CCA.

CCA does following:
Resumes original interaction
Reconnects customer and original agent
   CCA Parameters

All CCA parameters are defined in the Application Configuration Console.

| | | Default | |
|---|---|---|---|
| Name | Mandatory | value | Description |
| PromptMusic | | “Music” | Hold music and queuing prompt. See note below for |
| | | | more information. |
| PromptReminder | | “Reminder” | Prompt to play as reminder in queue. See note below |
| | | | for more information. |
| PromptNoAgents | | “Error” | Prompt for playing when no logged agents exist. See |
| | | | note below for more information. |
| PromptError | | “Error” | Error prompt. See note below for more information. |
| IVR | | None | ProgID of the IVR service selection application. If |
| | | | absent - no IVR will be performed. |
| PBXPrefix | | “” | Prefix to dial before destinations for transfer and |
| | | | agents. |
| EWTPeriod | | 30 | Timeout to play reminder prompt when call is in the |
| | | | queue, seconds. |
| QueueTimeout | | −1 | Time limit for call queuing, seconds. Must be |
| | | | accompanied by DefaultDestination parameter, |
| | | | otherwise has no effect. |
| DefaultDestination | | None | Destination number to transfer call to, if |
| | | | QueueTImeout expired. If absent or empty, queuing |
| | | | time is not limited and QueueTimeout parameter is |
| | | | ignored. |

Note:
all voice files should be defined WITHOUT file extension because it depends on the current voice format and will be selected by CCA automatically.

Agent Directory

The Agent Directory represents a list of currently logged agents and their phone numbers to any user of the Directory. The typical user of this Directory is an agent, who needs to dial another agent or transfer existing call to another agent. Each Call Center agent defines the phone number when logging into the Call Center. This number may change from session to session. For example, agent may work at the desk with phone 1000 one day. Next day he may work on another desk, which has phone number 2000. Therefore, if someone wishes to dial this agent, he must know the current number of the destination agent. Agent directory feature presents a list of currently logged agents to an agent, so he can just select target agent from this list instead of entering his phone number manually. Soft phone will use directory to determine current phone number of the target agent and dial this number automatically

Design

Objects and Connections

The internal design of the feature is illustrated in Figure ZAgent.

Soft phone obtains Agent Directory through ACL component, which runs on every agent's desktop. ACL keeps TCP connection to the Agent Server.

When ACL starts, it requests the initial list of logged agents by sending RequestAgentsList packet over its TCP connection to the Agent Server. In response, Agent Server sends information about each logged agent in AgentItem packet. The list is completed by EndOfList packet, which carries a number of transmitted agents for control purposes. ACL keeps a list of received agents and their attributes in memory.

When another agent logs into the Call Center, Agent Server sends AgentLoggedIn packet to all other connected ACLs. This allows ACL to update its internal memory list.

When agent logs out of the Call Center, Agent Server sends AgentLoggedOut packet to all other agents. Their ACLs will remove logged out agent from internal memory lists.

Soft Phone may obtain Agent Directory data from local ACL by accessing IACLAgent::AgentDirectory property. This property returns enumerator of logged agents. Each item (agent) is represented as IIVRParameters object, which holds all accessible agent's attributes.

Agent Data

The following attributes currently exist in the Agent Directory entry:
AgentID—the AgentID of the agent. This attribute is always present and cannot be empty. Also this attribute is unique.
Address—phone number of the agent. Corresponds to the number, which was entered by agent during login
FirstName—agent's first name from configuration. Optional, maybe empty string
LastName—agent's last name from configuration. Optional, maybe empty string

Other attributes maybe added in the future, if necessary.

Task Split

The following product parts and components are affected by this feature.

Agent Server

Provides ACLs with initial directory content
Notifies ACLs about newly other agent log ins and log outs
   ACL
Requests initial directory after login
Keeps agent directory in memory
Updated memory directory when receiving notifications about agent log ins and log outs
Provides COM API (automation compatible—see Error! Reference source not found.) for accessing agent directory be clients (like Soft Phone)
   Configuration

Two new attributes are added to the Agent object:
FirstName—agent's first name, optional
LastName—agent's last name, optional

Web Configuration Interface must provide fields for editing these attributes on the Agent's page.

Soft Phone

Soft Phone uses Agent Directory for transfers and outbound calls. It must provides GUI means for displaying directory, selecting an agent from directory and using the phone number of the selected agent for initiating transfer or outbound call.

The following property (read only) added to the IACLAgent interface:

[id(13), helpstring(“AgentDirectory”), propget]
HRESULT AgentDirectory([out, retval] IACLAgentDirectory**
ppiDirectory);

The following interface provides an access to the directory:

```
[
    object,
    uuid(4e398889-cb42-4bec-ab01-f5edb575401c),
    helpstring(“Agent directory interface”),
    dual,
    pointer_default(unique)
]
interface IACLAgentDirectory : IDispatch
{
    [id(DISPID_VALUE), helpstring(“Get agent by index”), propget]
    HRESULT  Item([in,  defaultvalue(0)]  int  nIndex,  [out,  retval]
VARIANT* pValue);
    [id(1), helpstring(“Items count”), propget]
    HRESULT Count([out, retval] int* pnCount);
    [id(DISPID_NEWENUM),  propget,  helpstring(“Enum  items”),
hidden, restricted]
    HRESULT NewEnum([out,  retval]  IUnknown**
ppEnum /* IEnumVARIANT** */);
};
```

This JavaScript code displays full content of the directory:

```
var objACL = new ActiveXObject(“VpccACL.AgentACL”);
var objDir = objACL.AgentDirectory;
vWScript.Echo(“Directory contains ” + objDir.Count + “ agents”);
var vEnum = new Enumerator(objDir);
for (; !vEnum.atEnd( ); vEnum.moveNext( ))
{
    var vAgent = vEnum.item( );
    vWScript.Echo(“Agent ” + vAgent(“AgentID”));
    var eAttrs = new Enumerator(vAgent);
    for (; !eAttrs.atEnd( ); eAttrs.moveNext( ))
    {
      vWScript.Echo(“  \“”  + eAttrs.item( )  +
“\”  =  ”+ vAgent.item(eAttrs.item( )));
    }
}
```

### Call Queuing and Call Distribution

Call Handling

This section describes how calls are handled:

Modes of Operation

SIP stack may operate in one of the two modes. These modes mainly differs in the way of handling incoming REFER messages. REFER messages are received as result of call transfers, made by the remote party.

The mode of operation is set when SIP stack starts and cannot be changed without restarting the stack.

Client Mode

When SIP stack operates in client mode, it handles incoming REFER messages internally as required by SIP transfer protocols (IETF Internet-Draft draft-ietf-sipping-cc-transfer-01).

SIP stack should be used in client mode when working as part of the SIP soft phone.

Server Mode

When SIP stack operates in server mode, it accepts incoming REFER messages and notifies the client application about these REFERS. It is up to the client application how to handle REFER further.

SIP stack should be used in server mode when working as part of the VoxPoint telephony platform (IVR).

Call Models

Inbound Call Setup

Figure Inbound_call_setup

Outbound Call Setup

Figure Outbound call setup

Call Disconnect by Local Party

Figure CallDisc_Local

Call Disconnect by Remote Party

FIG. 1. CallDisc_Remote

Call Transfers—Client Mode (SIP Phone)

Blind Transfer Initiated by Local Party

Blind transfer is initiated by calling BlindTransfer( ) method.

Blind transfer is usually not recoverable (in case destination cannot be reached) because original call gets terminated before consult call outcome is known.

Figure Blind_Xfer1

Successful Attended Transfer Initiated by Local Party

Attended transfer is initiated by calling InitTransfer( ) method. This places original call on hold and initiates consult call.

When consult call is connected, transfer maybe completed by calling CompleteTransfer( ) method.

Figure Xfer2

Cancelled Attended Transfer Initiated by Local Party

To cancel attended transfer, client should call Drop( ) method for consult call. This will terminate consult call and leave original call in the held state.

To return to the original call client should call Resume( ) method for original call.

Figure Xfer_Cancel3

Failed Attended Transfer Initiated by Local Party

If destination of the attended transfer cannot be reached for any reason, client application will receive DISCONNECTED event for consult call. In this case original call still be in the held state until client calls Resume( ) method.

Figure Xfer_fail4

Blind Transfer Initiated by Remote Party

This scenario happens when remote party performs blind transfer. Remote party may terminate original call right after receiving first NOTIFY from SIP stack.

Figure Blind_xfer5

Consult Transfer Initiated by Remote Party

When remote party decides to complete transfer, SIP stack will initiate new call to the destination, which replaces old call.

If remote party decides to cancel the transfer, SIP stack will just resume original call.

Figure Consult_xfer6

Call Transfers—Server Mode (VoxPoint IVR)

Blind Transfer Initiated by Remote Party

Figure Blind_xfer7

Attended Transfer Initiated by Remote Party

When remote party decides to complete transfer, SIP stack will initiate new call to the destination, which replaces old call.

If remote party decides to cancel the transfer, SIP stack will not receive REFER message, therefore remote party may just resume original call.

Figure Consult_xfer8

Call Center Interaction

Definitions

Interaction

Interaction is an entity, which represents a single interaction of the customer (call, e-mail, chat etc.) with one and only one Agent.

The lifecycle of the Interaction extends beyond the physical call (email, chat) length. When phone call disconnects, Interaction continue to live until agent finishes working with this call.

In general, Call Center may persistently store Interaction in the Interaction Database. This will make Interactions data available even after Interaction ends.

Case

When customer calls Call Center to get some service, new Case is created. Case may involve one or many phone calls, e-mails and/or chat sessions with one or many Call Center Agents.

A single Case is usually consists of one Interaction, but it may involve multiple Interactions. For example, when Agent transfers call to another Agent, there will be two Interactions: one is reflections conversation of the customer with first Agent, and another reflections conversation of the Customer with second Agent. These two Interactions will be linked to each other. Two (or more) such Interaction will compose single Case.

Goals

The main goals of introducing Interaction are:
Provide means for tracking call after its physical disconnection or transferring outside the telephony control
Provide case data after call is disconnected
Provide permanent storage for interactions
Provide unified way for calculating interaction metrics
   Active and Archive Interactions

Each Interaction comes through two periods of its lifecycle: Active and Archive.

Active Interaction

When new call (chat, email etc.) arrives in Call Center, new Interaction is created. Such Interaction is considered Active. Active interaction maybe queued, handled by an agent etc.

Active interaction lifecycle is described by Active State Machine, mentioned in the next chapter 0.

Note, that Active interaction lifecycle is reflected by Management Protocol bus events, lice ObjectCreated, ObjectChanged and ObjectDestoryed. When interaction becomes Archive, ObjectDeleted management message is sent to the bus.

Archive Interaction

When agent completes working with interaction, Interaction is stored in persistent database and becomes Archive.

Archive interactions maybe viewed, but cannot be sent back to an agent(s).

Currently Archive Interactions are not implemented.

Active Interaction States and State Machine

State Machine

During its lifecycle, Active interaction transits through several states and generates management events. The state diagram of Interaction is represented on the picture below:

FIG. 2. Interaction State Machine

Interaction Bus Events

Interaction generates following events:
ObjectCreated—when Interaction arrives. Content:
   ObjectID—[mandatory] unique interaction ID
ObjectChanged—whenever Interaction's state or attribute changes. Content:
   ObjectID—[mandatory] unique interaction ID
   AgentID—[optional] ID of the Agent, who handles the interaction. Present, when Interaction is in DeliveryPending, Delivered, Wrap-Up and Held states. Not present in Arrived, DataCollection and Queued states. For Completed state AgentID is present, if interaction comes from Delivered, Wrap-Up and Held states and absent when interaction arrives from any other state.
   ServiceType—[optional] type of the interaction's service. May appear, when service is determined for Interaction (after DataCollection state).
ObjectDeleted—when Interaction enters Completed state
   ObjectID—[mandatory] unique interaction ID
   AgentID—[optional] ID of the Agent, who handles the interaction. Present, if Agent was assigned to Interaction during Interaction lifecycle.
   ServiceType—[optional] type of the interaction's service. May appear, if service was ever determined for Interaction.
      Using of Interaction in Phone Call Center

The following Call Center entities communicate to Interaction:

Figure Object_Relations

Interaction Transfer

An agent may decide to transfer current active Interaction to another agent or IVR. During this step, current Interaction behave as call was terminated (it goes into Wrap-Up state). New interaction is created to reflect the fact, that customer will talk to another agent.

Two interactions will be linked to each other, so it would be possible to restore full path of the single customer's call (email, chat) through the Call Center.

The full transfer process looks like this:
Interaction is delivered to agent 1, interaction 1 is in Delivered state
Agent 1 initiates transfer. Interaction 1 goes to Held state, new Interaction 2 is created in Idle state.
Interaction 2 goes to Delivery Pending state
When destination answers, Interaction 1 goes to Wrap-Up state, Interaction 2 goes to Delivered state

Interaction 2 will have attribute “AgentID’ set to ID of the destination agent (if this is an agent). If destination is not an agent, this attribute will not exist.

Interaction 2 will have attribute “PreviousInteractionID” set to the ID of Interaction 1.

If transfer destination cannot be reached for any reason, Interaction 1 goes back to the Delivered state, Interaction 2 goes to Completed state.

Call and Interaction Data

Both the telephone call object and Interaction have some attributes and user data. These data accessible via IIVRProperties interface from COM applications. Interaction data also accessible via TCP interface.

When call-related Interaction is created by CCA, the pointer to the Interaction data is placed in associated Call data as InteractionData KV-pair. This allows the IVR application to have an access to the Interaction data without being aware of Interaction object itself.

Also, when CCA creates new Interaction, it copies all call data into Interaction data. Since call data are destroyed when call disconnects, such approach allows to keep call data even after call is destroyed.

When call is transferred from one agent to another agent, all data of the previous interaction are copied into the new interaction. However, all changes in second interaction data will NOT be propagated to the first interaction.

The following picture shows call and interaction data and their relationships:

Figure Interaction_data

Implementation

Interaction objects are implemented by Interaction Server. Interaction Server is a separate component of the Call Center.

Interaction Server performs following tasks:
maintains database of Contacts and Interactions (to be implemented later)
Creates, maintains and keep track of the runtime Interactions
Sends management messages via Bus (ObjectCreated, ObjectChanged, ObjectDeleted)
Stores runtime interactions in the database when Interaction completes (to be implemented later)
Store interaction data with runtime and permanent interactions (replaces current Data Server)
Provides TCP connectivity for clients (Agent Desktop, for example).
   COM Interfaces

IVPInteractionServer

```
interface IVPInteractionServer : IDispatch
{
  [id(1), helpstring(“Create new interaction”)]
  HRESULT CreateInteraction([in, unique] IIVRParameters*
piAttributes, [out, retval] IVPInteraction** ppiInteraction);
};
```

IVPInteraction

```
interface IVPInteraction : IDispatch
{
    [id(1), helpstring(“Interaction state”), propget]
    HRESULT State([out, retval] BSTR* pbstrState);
    [id(2), helpstring(“Interaction state ID”), propget]
    HRESULT StateID([out, retval] ULONG* pulState);
    [id(3), helpstring(“Interaction ID”), propget]
    HRESULT ID([out, retval] ULONG* pulID);
    [id(4), helpstring(“Interaction's data”), propget]
    HRESULT Data([out, retval] IIVRParameters** ppData);
    [id(5), helpstring(“Interaction's system attributes”), propget]
    HRESULT Attributes([out, retval] IIVRParameters** ppAttributes);
    [id(6), helpstring(“Queue interaction”)]
    HRESULT Queue( );
    [id(7), helpstring(“Idle interaction”)]
    HRESULT Idle( );
    [id(8), helpstring(“CollectData”)]
    HRESULT CollectData( );
    [id(9), helpstring(“Start delivery to an agent”)]
    HRESULT StartDelivery( );
    [id(10), helpstring(“DeliveryError”)]
    HRESULT DeliveryError( );
    [id(11), helpstring(“Delivered”)]
    HRESULT Delivered( );
    [id(12), helpstring(“Hold”)]
    HRESULT Hold( );
    [id(13), helpstring(“Resume”)]
    HRESULT Resume( );
    [id(14), helpstring(“WrapUp”)]
    HRESULT WrapUp( );
    [id(15), helpstring(“Complete”)]
    HRESULT Complete( );
    [id(16), helpstring(“Get auto-complete clone”)]
    HRESULT CloneComplete([out, retval] IVPInteraction** ppiClone);
};
```

Transfer Types

There are three transfer types implemented:

Two step. Implemented by CCA_Bridge. Applicable to all telephony types (VoIP, standalone, CTI) and all protocols. Algorithm:
Initiate transfer (dial destination)
Agent 1 may cancel transfer before destination answers
When destination answers, it is connected to agent 1
Agent 1 does either or:
Complete transfer—destination is connected to the customer, agent 1 disconnects
Cancel transfer—destination disconnects, agent1 is connected back to the customer

Single step. Implemented by CCA_ReInvite. Applicable only to VoIP. Algorithm:
Initiate transfer (dial destination)
Agent 1 may cancel transfer before destination answers
When destination answers, it is connected to the customer, agent 1disconnects. No transfer cancel is possible after destination answers

Blind. Implemented by CCA_Flash. Applicable only to analog and CAL standalone and CTI. Algorithm:
Initiate transfer
VoxPoint disconnects agent 1 immediately. No cancel available.
   Transfer Means

Depending on the transfer type and used equipment, agent may control transfer by three means:

Desktop softphone. Applicable only to VoIP (both CCA_Bridge and CCA_Reinvite).
Initiate transfer—“Dial” button
Complete transfer—“Complete” button
Cancel transfer—“Cancel” button

DTMF transfer. In general, applicable to all telephony types. For VoIP maybe used only if IP telephone send DTMFs as SIP INFO messages
‘*’—put customer on hold, get dialtone to an agent
DTMF number, followed by the ‘#’ or timeout—initiate transfer
‘*’ during consult dialing—cancel transfer
hangup—complete transfer (before or after destination answers)

IP phone “Transfer” button. Applicable only to CCA_Bridge and CCA_Reinvite, VoIP only. Works only when IP phone implementation sends SIP REFER request, when Transfer button is pressed.
“Transfer”+number—initiate transfer
hangup—complete transfer
cancel is not possible
   Transfer Procedure

Using IP Phone Built into Agent Control:
During the conversation
Enter the number
Press Transfer button
Listen to call progress (customer listens for hold music at this time)
When destination answers it is connected to agent
Press “Complete” or “Cancel” to complete the transfer or return back to the original call
Wait until Agent State changes to “After Call Work” or the phone rings (failed transfer, call returns)
Agent can complete or cancel transfer before destination answers.

Using Desktop (Hardware) IP Phone:
During the conversation
Request transfer as specified by phone manufacturer
Listen to call progress
When destination answers it is connected to agent
Hang up to complete the transfer or request another transfer to return back to the original call
Wait until Agent State changes to “After Call Work” or the phone rings (failed transfer, call returns)
Agent can complete or cancel transfer before destination answers.
   OR:
During the conversation
Dial “*”
Wait for dialtone—if no dialtone present, feature is not supported (for ReINVITE connections this feature will be supported ONLY if phone send DTMFs as SIP INFO messages, no RTP).
Dial number to transfer, end by ‘#’
Listen to call progress
When destination answers it is connected to agent
Hang up to complete the transfer or request another transfer (press ‘*’) to return back to the original call
Wait until Agent State changes to “After Call Work” or the phone rings (failed transfer, call returns)
Agent can complete or cancel transfer before destination answers.
   Using Plain Telephony, Bridge Call CCA Mode:
Exactly like previous scenario
   Using Plain Telephony, Flash-Hook CCA Mode:
During the conversation
Initiate two-step transfer (consult call) using PBX means (usually Hold, dial, and hangup to complete transfer)
When connected to destination, advise about the call number in data server, so destination agent could pick up call data.
Complete the transfer
   Transfer Implementation
   IP Telephony

IP Phone object sends SIP INFO messages with the following content to CCA:
transfer(number)
complete( )
cancel( )
   CCA

Implements transfers started with:
REFER (using hardware IP Phone)
Dial “*”+number+hangup (for some IP Phones and plain telephony)
SIP INFO from IP Soft Phone on Agent Desktop

When dialing transferred call, CCA attempts to get agent object for that call and set it to busy. If no destination agent is found, assume the call is placed to non-agent, do not attempt further agent state changes. If the agent is already in busy state, return call to original agent.

If transferred call has failed or destination agent is in busy state or both, the call must be returned to original agent. Three attempts, must be made, if all of them fail “sorry” must be played to caller and call should be hang up with error message to log stating agent's ID and DN.

Until transfer is successfully complete, original agent is kept in busy state, so no new calls are distributed to it. Only when transfer succeeds original agent is put to After Call Work state.

If original call was connected using re-invite (direct media connection), most phones would not be able to send DTMFs to VoxPoint, therefore in the re-invite connection mode “*”+number+hangup transfer method would not work in most cases.

REFER (as requested by hardware phone transfer button) is responded to as declined in all cases, so the CCA-agent call is retained. The CCA, though, will initiate call to destination specified in REFER and connect agent to it. When agent hangs up, the outbound call will be connected to inbound call thus completing the transfer. Requesting transfer on the hardware phone again, would cancel the transfer, so the outbound call would be dropped and original inbound call connected back to agent that initiated the transfer.

Skill Based Call Matching

One of the most used call distribution strategies in Call Centers is skills based strategy. Each Call Center agent has one or more skills, which are rated as number from 0 to 100. From the other side, each interaction requires different skills. The task of the skills based strategy is to find the agent, who has most appropriate skills for particular interaction. In the Call Center of the present invention this task is performed by Skills Based Matcher. This section defines specification of standard skills-based matcher, which is included in Call Center installation.

Terminology

Skills Group—a set of skills, grouped by their nature. For example, Language skills group may consist of English, Russian and Spanish skills
Skill (also Skill Name)—represent particular skill from the group. For example, skill English belongs to the skills group Language
Skill Value—the value of the particular skill, which is applicable to an agent. The skill value is measured as numeric value from 0 to 100.
   Match Algorithm
   Matcher's Task

The main task of the matcher is to calculate weight of the agent-interaction match. Weight reflects how good (or bad) is this agent for this interaction. If weight is 0—that means an agent is not appropriate for the interaction. If weight is 100—this agent is most appropriate for the interaction.

Weight Items

The total weight is composed of several different items. These items include:
One or more skills
Interaction's time in the queue
Agent's idle time
   Skills and Skill Groups

During IVR stage of the call processing in Call Center, the customer may select, which skills are important for him in the one or more skill groups. For example, IVR may offer customer to select desired language and desired product and customer chooses English language and Call Center product. IVR application then will attach the skill groups and selected skills as KVpairs to the interaction.

From other side, each agent capable of each skill at certain level. Therefore, the skill level maybe assigned for agent for each skill he is capable of. Figure InteractionAgent illustrates data records that may be kept for Interactions and Agents.

Interaction Time in Queue

Interaction has a predefined “NormalizedTimeInQueue” key, which represents interaction's time in the queue (normalized relatively all other call's queue times, so it would be in range from 0 to 100).

The Interaction from the example above sits in the queue for 90 seconds and requires following skills from an agent:
Language=English
Service=Sales
Product=VoxPoint
   Agent Idle Time

Agent has a predefined “NormalizedIdleTime” key, which reflects agent's idle time (normalized relatively to all other logged agents, 0-100) and “IdleTime” key, which represents absolute value of the agent's idle time in seconds.

The Agent from the sample is idle for 35 seconds and has following skills:
English—80
Spanish—100
Sales—20
Service—50
VoxPoint—70
OutboundLite—10
   Importance Factors

Not all items are equally important for the match. In order to reflect importance of the particular item (skill or idle time or time in queue) to the match, the importance factor is added to the each item.

The importance factor defines a portion of the total weight, which is brought by this item.

On our sample items, required by Interaction, have the following importance factors
Agent must speak “English” (“English” skill, maximum priority, importance factor 4)
Agent must be familiar with “Sales” (“Sales” skill, medium priority, importance factor 2)
Agent must be familiar with “VoxPoint” product (“VoxPoint” skill, minimum priority, importance factor 1)
The agent's idle time is taken into account with importance factor 1
The interaction's time in queue is taken into account with importance factor 1

That means that idle time, time in queue and skill from the Product group are equally important. The skill from the Service group is twice important than that. And, finally, the skill from the Language group is four times more important.

Importance factors maybe different on each escalation interval.

Escalation Intervals

In order to minimize interaction waiting time, some compromise must be introduced as call sits in the queue. The more call sits in the queue—the less restrictive requirements should be. That means required skills, their default values and minimum levels and their scale factors may change during interaction queue life.

The life of the interaction in the queue maybe divided onto different escalation intervals.

When interaction just arrives into the Contact Center, it belongs to the first escalation interval. The requirements for an agent are most restrictive on this interval. For example, agent MUST have English skill level not less that 100.

When interaction spends some time in the queue and no available agent is found, it moves to the next escalation interval. The agent requirements are usually easier here. For example, agent who has English skill level 50 and higher may handle the interaction on the second interval.

The more time call spends in the queue—the less tight requirements are.

Example (Based on the Previous Sample):
First interval (0-30 seconds)—Agent must have English skill al least 90, Service skill at least 70 and VoxPoint skill at least 50
Second interval (31-60 seconds)—agent must have English skill at least 50, Service skill at least 30 and VoxPoint skill is not required at all
Third interval (61-90 seconds)—agent must have English skill at least 30. Service and VoxPoint skills are required on this interval
All other time (91 seconds and up)—any agent may handle the interaction (no skills are required)
   Matcher Configuration

Based on all conditions, skills based matched must have following configuration parameters:
For each escalation interval:
   a. Escalation interval end duration beginning from the moment, when interaction was places to the queue, seconds (−1 means waiting forever)
   b. Importance factors for time in queue and agent idle time
   c. For each required skill group:
      Importance factor
      Default skill from the group (used when Skill Group—Skill KVPair is not present in interaction data)
      Minimum skill level (threshold)—the zero weight (0) would be returned if agent skill level is less than that threshold

Configuration is stored in XML format. All matcher's configuration is located in host configuration file under Contact Center application.

Each matcher must be configured in this XML file. Each matcher is represented by Matcher node, which must have following attributes:
ID—integer configuration ID of the matcher. Must be unique number. This ID is attached to the interaction by CCA or maybe defined as DefaultMatcher attribute of the CallDistribution node for all interactions
Name—test string, representing name of the matcher. Optional, for information purposes (GUI) only
ProgID—ProgID or CLSID of the matcher's COM implementation. Same COM implementation maybe used with different configurations as separate matchers

If matcher requires configuration (and generic skills-based matcher does that), the configuration must be located under Configuration node. Smart queue does not parse this node. Instead, it creates instance of MSXML parser, loads it with content of this node and passes pointer to the MS DOM document to the OnCreate matcher's method.

Sample skill-based matcher configuration with one skill selector and four escalation steps:

```
<Matcher ID=“1” Name=“Generic skills-based matcher”
ProgID=“VPCC.SkillsMatcher”>
  <Configuration>
    <EscalationStep Time=“45” TIQFactor=“2” IdleTimeFactor=“1”>
      <Skill Name=“Product” DefaultValue=“GoldMine”
MinLevel=“80” ScaleFactor=“4”/>
    </EscalationStep>
    <EscalationStep Time=“90” TIQFactor=“2” IdleTimeFactor=“1”>
      <Skill Name=“Product” DefaultValue=“GoldMine”
MinLevel=“50” ScaleFactor=“4”/>
    </EscalationStep>
    <EscalationStep Time=“120” TIQFactor=“2” IdleTimeFactor=“1”>
      <Skill Name=“Product” DefaultValue=“GoldMine”
MinLevel=“20” ScaleFactor=“4”/>
    </EscalationStep>
    <EscalationStep Time=“−1” TIQFactor=“2” IdleTimeFactor=“1”>
      <Skill Name=“Product” DefaultValue=“GoldMine”
MinLevel=“10” ScaleFactor=“4”/>
    </EscalationStep>
  </Configuration>
</Matcher>
```

Matcher Actions

Matcher must perform the following actions:
Extract required skill groups and skills from the Interaction data.
Obtain skill values from the Agent
Determine current escalation interval (based on interaction's time in queue)
Calculate weight, based on current skill importance factors and skill values
Return calculated weight and timeout for the next escalation interval (if exist)
   Weight Calculation Algorithm

For each escalation step the weight calculation algorithm maybe represented as following pseudocode:

```
// Calculate divider. This would be sum of all scale factors
Var dDivider = 0;
For each Skill
  dDivider = dDivider + Skill.ScaleFactor;
End
dDivider += TimeInQueue.ScaleFactor + AgentIdleTime.ScaleFactor;
// Calculate weigth
Var dWeigth = 0;
For each Skill
  If (Agent.Skill < Skill.MinLevel)
    Return 0; // Do not match
  End If
  Var dFraction = Skill.ScaleFactor * Agent.Skill;
  dWeigth = dWeigth + dFraction;
End
dWeigth += TimeInQueue.ScaleFactor * TimeInQueue;
dWeigth += AgentIdleTime.ScaleFactor * AgentIdleTime;
dWeigth /= dDivider;
Return dWeigth; // Match, return calculated weight
```

### Unified Messaging Subsystem

This section explains internal design of the Unified Messaging Subsystem. The document intended for understanding main functionality and internal structure of the subsystem).

Architecture

Structure

The Unified Messaging brings voicemail functionality to any standards-based (SMTP/POP3/IMAP) e-mail system (includes Microsoft Exchange). VPUM does not store any messages—all messages are stored on e-mail server.

Voicemails recorded by VPUM are sent as e-mails with compressed audio attachments. Both e-mail and voicemail are accessible via text-to-speech-based telephone interface. Voicemail-recorded audio attachments are played unchanged.

VPUM can operate with on plain telephone lines and in Voice over IP network (SIP). Telephone lines can range from analog to T1/E1, both CAS and ISDN PR1, connected to public telephone network or PBX.

Interaction VPUM with other subsystems presented on the next picture:

VPUM configuration is stored in XML files. Users and address book configuration could be synchronized by LDAP with directory configuration.

Figure Unified_Messaging

Internal Architecture

Internal Architecture consists of user counteracted components: TUI, Configuration Web Access; and pure internal components: Voice Converter, XML configuration

Voice Converter

Aim: Convert voice data from all VoxPoint Voice Format to GSM 6.10 and otherwise (first version mu-law and a-low to GSM and otherwise only).

Subsystem Configuration

Aim: Store client and user information (ANI, PIN, E-mail address, etc.).

Configuration Web Access

Aim: Configure VPUM by the web.

Implementation: HTTP Service that used standard VoxPoint HTTP server wrote on Python

Attendant TUI

Aim: Receive inbound call and try to redirect. If redirect impossible transfer call to answering TUI.

Implementation: VoxPoint Application.

Answering TUI

Aim: Receive inbound call. Record and convert voice message. Send E-mail.

Implementation: VoxPoint Application using Python mail module and Voice Converter object.

Access TUI

Aim: Receive inbound call. Authorize client. Receive E-mail. Read by TTS E-mail body and (or) to play attachment file.

Implementation: VoxPoint Application using Python mail module and Voice Converter object.

Components

Voice Converter

Voice Converter is COM component with ProgID: “VoiceConv.FileConv” that implemented interface IFileConv. The above interface includes the next methods:

WAVToGSM ( )

Convert A-law, Mu-law or GSM file to GSM 6.10 file

Parameters:

bstrSrcFile—path to source voice file
bstrDstFile—path to destination voice file
   WAVToALaw ( )

Convert A-law, Mu-law or GSM file to A-law file

Parameters:

bstrSrcFile—path to source voice file
bstrDstFile—path to destination voice file
   WAVToMuLaw ( )

A-law, Mu-law or GSM file to Mu-law file

Parameters:

bstrSrcFile—path to source voice file
bstrDstFile—path to destination voice file
   Subsystem Configuration

Static part of Unified Messaging Subsystem configurations are stored in common HostConfiguration.xml file. Users properties stored in separated UserCfg.xml files in directory data\um\User_<x>.

System

The System element could be configured by system administrator only.

System Element stored in the next node

```
...
<Application Type=“SIPProxy”>
    <UM>
        <System ... />
    </UM>
</Application>
```

Example of configuration presented below

<System AccessTransferType=“COM” AccessTUIPath=“AccessTUI.IVR”
ForwardPrefix=“501” EMail=“abc@cayocomm.ru”
SMTPServer=“MOW-EXCH” SMTPPort=“25”
SMTPUser=“abc” SMTPPassword=“086a3b41ffa03d93”
LDAPType=“ADS”
LDAPServer=“server.int.glxy.net” LDAPPort=“389” LDAPLogin=“abc”
LDAPPassword=“3f85b2f6a830eb79” LDAPUsersPath=“Accounts/
Active”
UsersContanerType=“OU” LDAPContactsPath=“Contacts”
ContactsContanerType=“OU”
DefaultExt=“150” ExtSuffix=“ ext ” DomainName=“” SALogin=“”
SAPassword=“”
PermitSAAccess=“False” CertificatePath=“” KeyPath=“”>

System node has following attributes:

| Attribute name | Mandatory | Type | Default | Description |
|---|---|---|---|---|
| AccessTransferType | Yes | String | “COM” | The way to transfer from |
| | | | | Answering TUI to Access TUI. |
| | | | | Possible values are: “COM”, |
| | | | | “Phone” |
| AccessTUIPath | Yes | String | “AccessTUI.IVR” | Path to Access TUI. The value |
| | | | | depends on |
| | | | | AccessTranferType. |
| | | | | For “COM” - ProgID, “Phone” - |
| | | | | Phone Number |
| ForwardPrefix | Yes | String | “” | Forwarding prefix for |
| | | | | Answering TUI. Used for get |
| | | | | User Phone by DNIS |
| EMail | Yes | String | “” | Default system e-mail. Used to |
| | | | | sending mails to users. |
| SMTPServer | Yes | String | “” | SMTP Server for default e-mail |
| SMTPPort | Yes | Integer | 25 | TCP Port for SMTM Server |
| SMTPUser | Yes | String | “” | Username for default e-mail |
| SMTPPassword | Yes | Encrypted | “” | User password for default e- |
| | | string | | mail |
| DefaultExt | No | String | “” | Default extension for attendant |
| LDAPType | Yes | String | “ADS” | LDAP Server Type. |
| | | | | Possible values are: “ADS”, |
| | | | | “Novel”, “OpenLDAP”, |
| | | | | “LotusNotes” |
| LDAPServer | Yes | String | “” | Lightweight Directory Access |
| | | | | Protocol server name |
| LDAPPort | Yes | Integer | 389 | LDAP TCP port (use 636 for |
| | | | | SSL) |
| LDAPLogin | Yes | String | “” | LDAP Username |
| LDAPPassword | Yes | Encrypted | “” | LDAP Password |
| | | string | | |
| LDAPUsersPath | Yes | String | “” | Internal path to user directory |
| UsersContanerType | Yes | String | “OU” | Type of LDAP container type |
| | | | | for contacts Possible values |
| | | | | are: “OU”, “CN” |
| LDAPContactsPath | Yes | String | “” | Internal path to contacts |
| | | | | directory |
| ContactsContanerType | Yes | String | “OU” | Type of LDAP container type |
| | | | | for contacts Possible values |
| | | | | are: “OU”, “CN” |
| ExtSuffix | No | String | “” | Suffix to parsing phone number |
| | | | | (used by LDAP |
| | | | | synchronization) |
| DomainName | No | String | “” | Domain Name (used by System |
| | | | | Administrator) |
| SALogin | No | String | “” | Login for System |
| | | | | Administrator (person who has |
| | | | | access to all user mailboxes) |
| SAPassword | No | String | “” | System Administrator |
| | | | | password |
| PermitSAAccess | No | String | “” | Enable System Administrator |
| | | | | Access to user mailboxes |
| CertificatePath | No | String | “” | Path to SSL certificate |
| KeyPath | No | Stirng | “” | Path to SSL key |

Users

Users configuration is stored in separated XML files in data\um\User_X folder.

The User_<UserID>.xml file has the next structure:

<User/>

Example presented below

<User UserID=“1” PIN=“b59c67bf196a4758191e42f76670ceba”
FirstName=“Andre”
LastName=“Aqua” Extension=“900” Phone=“70959375651”
Comment=“”
EMail=“dubashov@cayocomm.ru” Login=“046fa00ce42f8504”
Password=“307bb11ee0289816” InType=“POP3”
InServer=“pop.abc.com” InPort=“110”
OutServer=“smtp.abc.com” OutPort=“25” MaxRecTime=“30”
Language=“English”
SortOrder=“Recent” CurrentPosition=“Oldest” DeletedFolder=“Deleted
Items”
IMAPRecentDetection=“Combined”/>

User node has following attributes. All attributes except for UserID could by configured by user.

| Attribute name | Mandatory | Type | Default | Description |
|---|---|---|---|---|
| UserID | Yes | Integer | Auto | Users (mailbox) identifier |
| | | | Increment | |
| PIN | Yes | String | “” | Users PIN. Using for TUI |
| | | | | authorization. Only secure hash is |
| | | | | stored |
| FirstName | No | String | “” | First user name |
| LastName | No | String | “” | Last user name. |
| Phone | No | String | “” | User contact phone |
| Comment | No | String | “” | Auxiliary information |
| Email | Yes | String | “” | E-mail address |
| Login | Yes | String | “” | E-mail login |
| Password | Yes | String | “” | E-mail password |
| InType | Yes | String | “POP3” | Incoming mail server type. |
| | | | | Possible values are: “POP3”, |
| | | | | “IMAP4”, “IMAPSSL” |
| InServer | Yes | String | “” | Incoming mail server |
| InPort | Yes | Integer | 110 | Incoming mail TCP port |
| OutServer | Yes | String | “” | Outgoing mail server |
| OutPort | Yes | Integer | 25 | Outgoing mail TCP port |
| MaxRecTime | Yes | Integer | 30 | Maximum time for message recording |
| | | | | in seconds |
| Language | Yes | String | “English” | Communication Language. Used for |
| | | | | prompts and Text-to-Speech |
| | | | | Possible values are: “English” |
| | | | | “Russian” |
| SortOrder | Yes | String | “Recent” | Order of sort messages |
| | | | | Possible values are: “Recent”, |
| | | | | “Oldest” |
| CurrentPosition | Yes | String | “Recent” | Current position for sorted messages |
| | | | | Possible values are: “Recent”, |
| | | | | “Oldest” |
| DeletedFolder | Yes | String | “Deleted | Name of Deleted Items |
| | | | Items” | |
| IMAPRecentDetection | No | String | Combined | Ways to detect recent messages. |
| | | | | Possible values are: “Seen”, |
| | | | | “Combined”, “Proprietary” |

Address Books

To store information concerning not user contacts Unified Messaging used Address Books. There are two types of Address Books: Global Address Book and Personal Adders Book. Global Address Book includes contacts that are accessed for all users. Personal Address Book includes only private contacts. Only one user (owner) could to get information from Personal Address Book.

Global Address Book is stored in GlobalAddressBook.xml file into data folder. Personal Address Book in stored in folder data\UM\User_X\PersonalAddressBook. Both Address Book types have one structure described below:

```
<AddressBook>
    <Contact/>
    ...
    <Contact/>
</AddressBook>
```

Example of Address Book:

```
<AddressBook>
  <Contact CID=“1” FirstName=“John” LastName=“Jhonson”
CompanyName=“CDF Neworks” EMail=“jhonson@cdf.ru”/>
  <Contact CID=“2” FirstName=“Peter” LastName=“Pen”
CompanyName=“XXX” EMail=“peterpen@abc.ru”/>
</AddressBook>
```

Contact Element

Contact node has following attributes:

| Attribute name | Mandatory | Type | Default | Description |
|---|---|---|---|---|
| CID | Yes | String | Auto | Contact identifier |
| | | | Increment | |
| FirstName | Yes | String | “” | First contact name |
| LastName | No | String | “” | Last contact name. |
| CompanyName | No | String | “” | Contact company |
| | | | | name |
| EMail | Yes | String | “” | E-mail address |

Configuration Web Access

To read and change mandatory configuration and address book UM Web Configurator could by used. In addition to, the UM Web Configurator takes possibility to Synchronize users and address book data by LDAP.

Internal configuration for Web Access (TCP port, log files, Authentication parameters, etc.) is stored in WebCfg.cf file

Supported Directory Services:

1. MS Active Directory Service (ADS)
2. IBM Lotus
3. SurgeLDAP
   Attendant TUI

Attendant is front edge application. The application receives calls and ask client to input user's extension number. If it possible the application perform connection client and user. Otherwise, call is redirect to Answering TUI.

Figure Attendant_TUI

Answering TUI

Answering TUI answers calls forwarded from PBX or IP extensions when they do not answer or busy.

Scenario:

If received with call correct phone number caller hears standard or pre-recorded custom message and tone.
Else system ask user to put employer phone number. If try success, then caller hears standard or pre-recorded custom message and tone. In other case depends on configuration caller could send message to default user or system break connection without sending message.
Message is recorded until caller hangs up message reaches maximum recording time.
Message is compressed and sent as an attachment to e-mail server using SMTP. Audio format is widely supported GSM6.10 WAV (1.6 kb/sec).
If “*” is pressed at any time, the call is passed to Access TUI
If ANI number is available, it is matched against voicemail directory (possibly synchronized from enterprise LDAP directory) and caller's name and e-mail address are put into from field, otherwise message is tagged from “VoiceMail server”. Subject is “voicemail from X” where x is caller's name or telephone number.
Message waiting lamp is set

All prompts are interruptible by DTMF input, allowing DTMF cut-through mode for faster access.

Logical scheme presented in Figure Answering_TUI.

Access TUI

Access TUI can be activated by dialing a special access number or interrupting Answering TUI. In case of correct Domain Name, System Administrator parameters and flag PermitSAAccess is true authorization for work with e-mail server could be performed by System Administrator account. There is possibility to choose detection ways for “new” messages. Choosing is possible only in case of using IMAP protocol for inbound messages. The particular way must be determined for each user.

“Seen”—new messages is all messages that doesn't read by any e-mail client (Outlook, But, Access—TUI, etc.)

“Proprietary”—new messages is messages up to recent (oldest) message that doesn't read by only Access—TUI

“Combined”—new messages is messages up to recent (oldest) message that doesn't read by any e-mail client.

Scenario:

It tries to obtain mailbox number from ANI (when calling access number) or DNIS (when interrupting Answering TUI) and plays it, if successful.
Otherwise caller is prompted for mailbox(extension) number
It then asks for PIN, for invalid PIN the system asks to enter extension number one more time
Incorrect extension/PIN combinations may be re-entered up to 3 times, after which system hangs up.
Correct extension/PIN pair is used to decrypt POP3 or IMAP login and password, then application accesses POP3/IMAP mailbox using decrypted credentials. In case of invalid user credential System Administrator account could be used instead.
Number of total and new messages is played. For details see the above definitions
New message headers are played next:
   “Voicemail from XXX received on YYY” or “E-mail from XXX regarding YYY received on ZZZ”. Voicemails are detected based on subject and attachment information
After a pause, a list of navigation keys is played:
   1—five seconds rewind (when playing)
   2—change folder (IMAP only)
   3—five seconds fast-forward (when playing)
   4—previous message
   5—play
   6—next message
   7—delete (message is marked, and this is noted in envelope play)
   8—forward or replay
      Destination is entered as mailbox number of a partial last name matched through Voicemail directory (possibly sourced from LDAP database)—result of search is an e-mail address.
      Forward recipient must not necessarily be VPUM user.
      A voice message can be recorded and attached to forwarded message.
   9—send
      Destination is entered as mailbox number of a partial last name matched through Voicemail directory (possibly sourced from LDAP database)—result of search is an e-mail address.
   0—settings
      1—play Greeting
      2—record Greeting
      3—empty deleted items folder
      4—set sort order
      5—set current position
      6—change PIN
      *—return to main menu
E-mail bodies are read without changes using text-to-speech (TTS). Standard TTS included with Windows is used; the system can use any SAPI5-compliant TTS engine.
Message waiting lamp is reset if there are no unread messages left

All prompts are interruptible by DTMF input, allowing DTMF cut-through mode for faster access. All menus and collect digits methods are set up digit time outs.

Figure Access_TUI

Name Search Mechanism (NSM)

For Forward and Send messages used special Name Search Mechanism.

User Manual.

The search is performed with fields “FirstName” and “LastName”. During the user input First name and Last name are divided by white space (“ ” is key “1” on phone). User can input either full name of the fields or only part of the name.

For example for person “John Smith” user can input:
“J SM” or “SM J”
or “SMITH JOHN” or “SMITH” (if there is only one Smith in the address book)
or others.

No difference which field is first in the search string—First name or Last name. Both variants will be checked.

User input the search string while more then one person is suited to the string and next letters can solve person selection. When only one person in suited person list or next letters can't change anything—the search is finished. When search is finished then user is prompted to verify selected person.

NSM Design.

The search is performed with fields “FirstName” and “LastName”.

Program steps:

On script starting any configuration element updated to have new fields: “FirstNameNSM” and “LastNameNSM”. These fields are counted from “FirstName” and “LastName” accordingly. They have digit values of original fields (the values which can be achieved by dialing on phone's keyboard). For example “John” will be transformed to “5646”.

On NSM state in Access.TUI when digit is received it is transmitted to NSM object in search( ) function.

search( ) function initiates person searching.

There are three levels of search aggregation:
NSMSearchElem—search string in known field (“FirstNameNSM” or “LastNameNSM”) in the list of persons and select suited persons.
NSMSearch—search person in known order of searching fields (“FirstNameNSM” and “LastNameNSM”), aggregates results of two NSMSearchElem elements.
NSM—search person, aggregates results of two NSMSearch elements.

Data processing structure is shown in FIGURE NSM.

### Statistics and Metrics Engine (SME)

This section explains internal design of the Statistics and Metrics Engine (SME).

Major Functional Components of SME

Figure SME shows the most important functional parts of SME.

Connectivity

Connectivity part is responsible for establishing a connection with the message bus and accepting connections from monitoring applications.

From the message bus SME receives information about telephone activity. Information comes as a single stream of events from various components of the Call Center.

Monitoring applications query information about monitored objects and subscribe for notifications about changes in values of metrics, applied to the objects.

Connection with the message bus is always local and is established over a named pipe. Monitored applications can connect to SME over TCP/IP or named pipes.

Inbound connections are fully independent; each connection is handled by a unique session object (not shown) which has access only to the Statistics Manager.

Timers

Timers produce periodical events that are used for calculation of metric values. There are two types of timers: clock timer and schedule timer.

Clock timer fires a clock timer event every 5 seconds. Each event is bound to a 5-second interval since the beginning of the current minute (m:00, m:05, m:10, etc.)

Schedule timer fires schedule timer events according to a set of schedules, defined in the configuration. A schedule is a set of times during the day when the timer must fire. Several schedules can be defined in the configuration, each identified by a unique name. The name is an attribute of the schedule timer event.

Statistics Manager

Statistics Manager is the core part of SME, responsible for calculation of metric values. Statistics Manager uses the outbound connectivity part to receive events from the message bus, timers to set up and receive timer events, and the inbound connectivity part to deliver metric values to the monitoring applications.

The following components constitute the Statistics Manager:
Objects Database—keeps a collection of objects that can be queried by monitoring applications.
Objects/Metric Containers—entities that can be queried by monitoring applications. Each object is a collection of attributes, identified by a unique combination of integer object type and object identifier. Some of the objects are metric containers. A metric container is a collection of metrics.
Metrics—objects that process events and produce values of the metric. Each metric object implements an algorithm that receives events, produced by the connectivity part and timers, and generates messages that are delivered to monitoring applications (over the inbound connectivity part).
   Historical Part

Historical Part collects aggregated values of some of the metrics over repeated time intervals and stores the collected values in a database (historical database).

Only “total” metrics can be collected and stored in the database.

External reporting tools may be used to build reports, based on data in the database.

Upon start, historical part builds historical report objects based on information in the configuration. Each historical report object creates a historical timer and a set of historical metrics that are inserted into the metric containers from the objects database.

Historical metrics are the same objects as the metric objects mentioned above, but they have different identifiers and clients cannot subscribe for updates of values of the historical metrics. For each historical metric the base metric's identifier and the metric alias are specified in the configuration. The alias is used to identify the metric in the database. Historical metrics are based on scheduled reset-based metrics, but they ignore schedule timer events. Configuration of the historical metrics is parsed by the historical metrics manager. After the configuration is parsed, the manager creates historical metric objects and remembers metrics containers into which historical metrics had been inserted by each historical report. Later, this information is used to deliver historical timer events only to the containers that actually contain historical metrics.

Historical timers periodically initiate storing of historical data in the historical database and resets values of historical metrics, included in the report. Period of each timer is specified in the configuration.

Historical database is an SQL Server database. For each historical report an OLE DB connection string, that identifies the database, must be specified. The database structure must be created before running SME with active historical part, but contents of the database is maintained by SME.

All database access is done on a pool of threads (number of threads matches the number of system processors, but cannot exceed 64). Database actions are queued to the pool and are performed by available threads. This allows SME to continue processing of events that change values of metrics while database operations are being performed.

Historical Database

Figure DB shows tables of the historical database and relations between the tables.

Historical data consists of reports. Each report object (record in the REPORTS table) represents a report, configured in the historical part of configuration of SME.

Reports consist of time intervals (records in the TIME_INTERVALS table) for which values of historical metrics were collected.

Each time interval consists of metric values (records in the METRIC_VALUES table).

Each metric value refers to an object (record in the OBJECTS table) for which the value was collected and to a metric type (record in the METRICS table) that's produced the value.

Objects refer to object types (records in the OBJECT_TYPES dictionary table).

The dictionary of object types is populated when the database is initialized. All other tables are maintained by SME.

Reports Table

| Column | Type | Description |
|---|---|---|
| ID | int identity | Unique identifier of the report. |
| NAME | nvarchar(64) | Unique name of the report. The name is copied |
| | | by SME from configuration. |

Time_Intervals Table

| Column | Type | Description |
|---|---|---|
| ID | int identity | Unique identifier of the time interval. |
| REPORT | int | Reference to a report (REPORTS.ID) to |
| | | which the time interval belongs. |
| BEGIN_TIME | datetime | Beginning UTC time of the interval. |
| END_TIME | datetime | Ending UTC time of the interval. |

Object_Types Table

| Column | Type | Description |
|---|---|---|
| ID | int | Unique identifier of the object type. Identifiers are |
| | | the same as the internal object |
| | | type identifiers of SME. |
| NAME | nvarchar(64) | Display name of the object type. |

Objects Table

| Column | Type | Description |
|---|---|---|
| ID | int identity | Unique identifier of the object. |
| DISPLAY_NAME | nvarchar(128) | Display name of the object. |
| OBJECT_TYPE | int | Reference to the object type |
| | | (OBJECT_TYPES.ID). |

Metrics Table

| Column | Type | Description |
|---|---|---|
| ID | int | Unique identifier of the metric |
| | | type. Identifiers of metric types |
| | | are copied from configuration. |
| DISPLAY_NAME | nvarchar(128) | Display name of the metric. |

Metric_Values Table

| Column | Type | Description |
|---|---|---|
| ID | int identity | Unique identifier of the metric value. |
| INTERVAL | int | Reference to the time interval |
| | | (TIME_INTERVALS.ID). |
| METRIC | int | Reference to the metric type |
| | | (METRICS.ID). |
| OBJECT | int | Reference to the object (OBJECTS.ID). |
| VALUE | int | Value of the metric. |

Information Flow

This chapter explains how data flows in and out of SME.

In general, events from the message bus and internal timers (inbound events) are delivered to Statistics Manager. Statistics Manager processes the events and produces outbound events that are sent to the monitoring applications.

Delivery of Events to Statistics Manager

Figure SM_Events1 shows how the events are delivered to the Statistics Manager.

Events from the message bus are decoded by the outbound part of the connectivity component. Each decoded event is an object of a class, specific to the event. The event objects are delivered to the statistics manager for further processing.

When a timer fires, a special timer event object is created and delivered to the statistics manager.

Statistics Manager serializes incoming events so only one event can be processed at any moment.

Processing of Events by Statistics Manager

Figure SM_Events2 shows flow of inbound events in the statistics manager:

Events from the bus are separated into events, related to agents (events from the agent server), and events, related to interactions (events from the interaction server).

Agent-related events are converted into Agent Events by the Agent Manager. Attributes of events, received from the bus are converted into values, recognizable by internal data model of SME and events, not related to agents, that are not being monitored, are filtered out.

Interaction related events are converted into Interaction Events by the Interaction Manager. Attributes of bus events are converted into values, recognizable by internal data model of SME and interactions that begun before SME had started are filtered out.

Timer Events, Interaction Events and Agent Events are then delivered to all objects in the object database.

The following steps constitute processing of an event by an object:
Object attributes are updated;
If the object is a metrics container, the event is given for processing to all metrics.

Any changes in objects' attributes or metrics' values are delivered to all monitoring applications that had subscribed for changes in objects or metrics.

Delivering Notifications to Monitoring Applications

Figure MOS shows relationships between metrics, objects and subscriptions.

Subscriptions created by the monitoring applications.

Object subscriptions used to deliver information about changes of object attributes.

Metric subscriptions used to deliver information about changes of metric values.

When an object attribute is changing, the object sends information about the change to all associated object subscriptions. Each subscription sends a message over the media channel, associated with an inbound session to which the subscription belongs.

When a value of a metric is changing, the metric sends information about the change to all associated metric subscription. Each subscription then sends a message over the media channel, associated with an inbound session to which the subscription belongs.

Monitoring applications, connected to the sessions, receive the messages and display the updated information.

The following table shows all metrics calculated by SME.

| | Time Profile | | | |
|---|---|---|---|---|
| Friendly Name | Contiguous | Sliding | Schedule | Historical |
| Total busy time | | [symbol] | [symbol] | [symbol] |
| Average busy time | | [symbol] | [symbol] | |
| Total handling time | | [symbol] | [symbol] | [symbol] |
| Average handling time | | [symbol] | [symbol] | |
| Total after call work time | | [symbol] | [symbol] | [symbol] |
| Average after call work time | | [symbol] | [symbol] | |
| Total held time | | [symbol] | [symbol] | [symbol] |
| Average held time | | [symbol] | [symbol] | |
| Total time in queue | | [symbol] | [symbol] | [symbol] |
| Average waiting time | | [symbol] | [symbol] | |
| Number of calls answered | | [symbol] | [symbol] | [symbol] |
| Current logon time | [symbol] | | | |
| Total logon time | | [symbol] | [symbol] | [symbol] |
| Total ready time | | [symbol] | [symbol] | [symbol] |
| Total not ready time | | [symbol] | [symbol] | [symbol] |
| Total working time | | [symbol] | [symbol] | [symbol] |
| Number of calls received | | [symbol] | [symbol] | [symbol] |
| Number of calls abandoned | | [symbol] | [symbol] | [symbol] |
| Number of calls short-abandoned | | [symbol] | [symbol] | [symbol] |
| Number of calls answered in escalation period X¹ | | □ | □ | □ |
| Number of calls transferred to fallback targets² | | ⊙ | □ | □ |
| Number of calls transferred to mailboxes³ | | ⊙ | □ | □ |
| Maximum waiting time | | [symbol] | [symbol] | |
| Minimum waiting time | | [symbol] | [symbol] | |
| Average call abandon time | | [symbol] | [symbol] | |
| Percent calls answered | | [symbol] | [symbol] | |
| Percent calls abandoned | | [symbol] | [symbol] | |
| Percent calls short abandoned | | [symbol] | [symbol] | |
| Service factor | | [symbol] | [symbol] | |
| Number of calls in queue | [symbol] | | | |
| Calls queued | | [symbol] | [symbol] | [symbol] |

¹Metric development is frozen until we better define the escalation periods and their place in VoxPoint configuration.
²Metric development is frozen until transfer to a fallback target is implemented.
³Metric development is frozen until transfer to a mailbox is implemented.

### Call Logging Feature

The call logging feature allows the recording of voice conversations in the call Center. In one embodiment, a stereo file is used for conversation recording. The Left channel of the file contains recording of the first party and the right channel—of the second party.

Approach

Separate COM component (ProgID=“VoxPoint.StereoWavFile”, available for using in VoxPoint scripts, implements storing of two IStreams into the single stereo WAV file. VoxPoint application creates instance of this component for each conversation to be recorded. Component provides COM methods for obtaining separate IStream interface pointers for left and right channel. Application uses these pointers with appctx.RecordStream( ) method calls on each call (party) in conversation.

Component COM Interface

[id(1), helpstring(“Initialization”)-]
HRESULT Init([in] BSTR bstrFilePath, [in] VoiceFormat format);
[id(2), helpstring(“Get left channel stream”), propget]
HRESULT LeftStream([out] IStream** ppiStream);
[id(3), helpstring(“Get right channel stream”), propget]
HRESULT RightStream([out] IStream** ppiStream);
[id(4), helpstring(“Save file”)]
HRESULT Save ( );

Script Example

| // | Create and initialize file object |
|---|---|
| var objStereoFile = new ActiveXObject | |
| (“VoxPoint.StereoWavFile”); | |
| objStereoFile.Init (“c: \\VoiceFiles\\Conversation.wav”); | |
| // | Begin recording on both calls (channels) |
| appctx.RecordStream(objStereoFile.LeftStream, 60, true, crn1); | |
| appctx.RecordStream(objStereoFile.RightStream, 60, true, crn2); | |
| // | Wait until both call recordings complete |

var bLeftComplete = false;
var bRightComplete = false;
while (true)
{

var event = appctx.GetEvent ( );
if (“RecordComplete” ==event.Type)
{

| if (crn1 ==event.CRN) | |
|---|---|
| { | |
| | bLeftComplete = true; |
| } | |
| else if (crn2 ==event.CRN) | |
| { | |
| | bRightComplete = true; |
| | } |
| // | All recorded? |
| if (bLeftComplete && bRightComplete) | |
| { | |
| // | Save file |

objStereoFile.Save ( );

}

}

}

### Interactive Voice Response (IVR)

The interactive voice response system . . .

Interpreter is a part Application Builder (AppBuilder). It is used for executing AppBuilder applications.

An Application Builder application is an XML file of special format. Default encoding for application files is UTF-8 to accommodate text in national alphabets.

Each application has a separate directory; name of the directory is the name of application. Inside the directory, there is an application.xml file that contains application flow, prompt directories and automatic backups of unsaved application files (made when user session expires without saving changes).

5.1 Applications and Blocks Execution

When the Interpreter is started it checks ApplicationPath parameter and parses the application XML script. The blocks that were set in application XML script are executed by means of their ProgId. Every block (except Goto block) is a COM server. Blocks are executed in sequence, if block's return value matches value of one of its conditions, blocks from that conditions are executed. Before executing a block, Interpreter sets BlockFolder appctx.ConfigValue property to block's path. Block's method “handle” is invoked on each event until it returns “end” or “error”. Returning “error” stops application execution by throwing exception. Appctx, reference to interpreter (for GetPrompt) and XML DOM node corresponding to the block are provided as parameters. When block is finished, Interpreter retrieves “BlockResult” appctx ConfigValue property as block's return value.

In the current version the applications is searched from Interpreter folder (the folder from where the Interpreter is executing). I.e. AppFolder=“Interpreter folder”+“ . . . \Data\Applications\<AppName>”. The same for Block folder BlockFolder=“Interpreter folder”+“ . . . \Data\Blocks\<BlockName>”.

In the next versions of the Interpreter (on C++) the applications and blocks will be searched from RootDir of FrontRange Contact Center (stored in registry: HKLM\Software\FrontRange Solutions\Contact Center\RootDir). I.e. AppFolder=“RootDir”+“\AppBuilder\Data\Applications\<AppName>” and BlockFolder=“RootDir”+“\AppBuilder\Data\Blocks\<BlockName>”.

5.2 Prompts Processing

All prompts have to be declared before they can be referenced in blocks. Each prompt may have a number of textual representations for each language used. All languages to be used in application must be first declared in application file.

On start, Interpreter scans all declared prompts and their descriptions and compare them with prompt files in application directory.

If there is no file corresponding to a description, or if description mtime (modification time) attribute specifies later time than prompt file modification date, it is generated using text-to-speech for all encodings. This will generate initial prompt set or overwrite recorded prompt if description text was changed in editor.

TTS-generated prompts are supposed to be replaced later with recorded version, by simply overwriting initial prompt set.

If a prompt file in one of the encodings is substantially newer than others, interpreter regenerates all other encodings for this prompt. This is needed to automatically replicate prompt files manually replaced for one of the encodings.

Application prompt directory structure is “<ApplicationName>/Prompts/<LangId>/<Encoding>/”

The application can also use Block prompt for the Block execution.

Block prompt directory structure is “<BlockName>/Prompts/<LangId>/<Encoding>/”

Sharing of prompts between applications is not supported.

Appendix 1. Application XML File Structure
Application (mandatory, single)

DefaultLang (attr, mandatory, integer)—LangID of default language —the language application assumes on start; as well as the language the AppBuilder displays prompts in by default.

Prompts (mandatory, single)
Language (optional, multiple)
   Id (attr, mandatory, integer)—LangID of language used in application
   Name (attr, mandatory, string)—name of language used in application
Prompt (optional, multiple)
   Id (attr, mandatory, string) a unique (within app xml file) id, used for prompt references
   Name (attr, mandatory, string) a short descriptive name of the prompt
   Description (mandatory for each language declared, multiple)
      Lang (attr, mandatory, integer)—LangID of thedescription
      Empty (attr, mandatory, Boolean “true”/“false”)—if true this description is ignored—it is assumed that the prompt is used for other languages only (for example, a language choice prompt does not have other language counterparts)
      Mtime (attr, mandatory, float)—UTC modification timestamp of the description
      Text( )—textual representation of the prompt in language referred by Lang

Blocks (mandatory, single)
Block (optional, multiple)
   Type (attr, mandatory, string)—type of the block
   Id (attr, mandatory, string)—a unique (within app xml file) id, used for goto references
   ProgId (attr, mandatory, string)—block's implementing COM object's ProgID
   Depends (attr, optional, id)—id of a block this block depends on. If there is no such block, this block is displayed with red background.
   Conditions (optional, single)
      Condition (optional, multiple)
         Text (attr, mandatory, string)—textual description of condition
         Value (attr, mandatory, string)—value to be returned by the block for this condition blocks to be executed
         Block—see above
   Configuration (optional, single)—may contain any XML content. Param nodes is just a suggestion.
      Param (optional, multiple)
         Name (attr, mandatory, string)—name of parameter
         Value (attr, mandatory, string)—value of parameter

### Management Console

This section explains how configurable application views work in the management console.

Application Objects

The main purpose of Management Console is application management. Application objects are shown in the objects tree under computers. Each managed computer can run several applications. Each application has a name, displayed in the tree and type. Application type defines behavior of an application and the way the console displays the application.

Each application may have a set of “application components”—objects that belong to the application. Each application component is represented by a set of named attributes. Values of attributes are strings. Attribute “ObjectType” specifies the type of an object and uniquely defines attributes that the component may have.

Some attributes of an application component uniquely identify the component object. Such attributes are called “key attributes” and a combination of values of all key attributes is a unique key that identifies particular instance of a component. Typically, components are identified by one dedicated key attribute (in most cases, named “ObjectID”). Once a component is created, values of its key attributes cannot change.

Application Views

Application View is displayed in the object properties pane of the main window when an application object is selected in the objects tree. The view shows a tabbed set of application components lists. Each components list shows objects, belonging to the selected application, of a certain type.

The following picture shows layout of an application view:

[image]

The list above the tabs displays components on lines and component attributes on columns. Column headers show the names of attributes or localized text, specified in the configuration of the view (explained below).

Tabs show the component types of application components displayed on the tabs, or localized text, specified in the configuration of the view.

For certain types of applications, custom application views are shown. Such application types are VoxPoint and Contact Center. For other types of applications configurable generic views can be shown.

Configuration File

Object types and attributes, shown in configurable views, are defined in a special XML file named “cmcon.xlyt”. The console looks for the file first in the current directory, then in the directory where the console executable file (“cmcon.exe”) is located.

The file is optional. If the file is not found, configurable views are not displayed; instead, an empty view is shown for applications for which built-in customized views are not designed.

The file contains a list of <ApplicationView> elements each of which defines a view for applications of a certain type. Definitions of views for application types, for which the console shows built-in views, are ignored.

Each <ApplicationView> element has one mandatory attribute “type”. Value of the attribute specifies the type of applications for which the view, defined by the element, is shown.

<Tab> child elements of an <ApplicationView> element define tabs that will be displayed in the view. Each tab displays application components of certain type (value of the “ObjectType” component attribute). The type is specified by the value of mandatory “object” attribute.

The following sample shows a sample configuration file:

```
<Layout>
  <ApplicationView type=”AFBRuntime”>
    <Tab object=”Transaction”>
      <Key>
        <Attribute name=”ObjectID” />
        <Attribute name=”CardNumber” />
      </Key>
      <Columns>
        <Attribute name=”CardNumber” />
        <Attribute name=”State”>
          <Format class=”dictionary”>
            <Entry value=”1”>Active</Entry>
            <Entry value=”2”>Pending</Entry>
            <Default>(unknown)</Default>
          </Format>
        </Attribute>
      </Columns>
    </Tab>
  </ApplicationView>
  <ApplicationView type=”AgentSimulation”>
    ...
  </ApplicationView>
</Layout>
```

The sample defines configurable views for applications of types “AFBRuntime” and “AgentSimulator” (for the latter contents of the definition are not shown).

For “AFBRuntime” applications one tab will be displayed in the view. The tab is defined by the <Tab> element and will show application components of type “Transaction” (value of the “object” attribute of the <Tab> element).

Application components, displayed in the view are defined by <Key> and <Columns> elements—children of the <Tab> element.

Components' Keys

Attributes, that constitute key of an application component, are defined by optional <Key> elements.

If defined, <Key> element must be a child of a <Tab> element. Like the sample above shows, <Key> element contains a sequence of <Attribute> elements. Each <Attribute> element has one mandatory attribute “name”. Value of the attribute specifies the name of an attribute of an application component that must be included in the component's key.

Order of <Attribute> elements defines the order in which components' attributes are compared.

If the <Key> element is missing, all displayed component's attributes (attributes, specified in the <Columns> element described below) are included in key.

Components List's Columns

<Columns> element—a child of <Tab> element defines which columns will be displayed in the components list, shown on the tab.

The element contains a sequence of <Attribute> elements, like the sample above shows. Each <Attribute> element defines one column in the list. The column will display values of the component attribute, specified by the mandatory “name” attribute of the element.

Order of <Attribute> elements defines the order of columns in the list.

If not explicitly specified, title of the column, defined by an <Attribute> element is the value of the “name” attribute. The title can also be specified by adding a <Title> child element. Use of the <Title> element is described further in this document in chapter 4.4 Localization.

Data Formatting

<Attribute> element, found in a <Columns> element, may have an optional <Format> child element. When specified, the element specifies how values of the component's attribute must be formatted before displaying in the list.

<Format> element has one mandatory attribute “class”. Value of the attribute specifies the “class” of formatting.

Current version supports only one class: “dictionary”.

Dictionary Formatting

Dictionary formatting element (value of the “class” attribute is “dictionary”) defines translation of a set of values of a component's attribute into a set of other values.

Pairs of original and translated values are defined by <Entry> elements. Each <Entry> element has a mandatory attribute “value” that indicates an original value of component's attribute. Text of the element defines translated value which will be displayed in the list.

Text of an optional <Default> element may specify translated value for all original values, not found in the list if <Entry> elements. If <Default> element is not specified, the original value of the component attribute will be displayed whenever the translation is not found.

Localization

By default, types of application components are shown on the tabs and names of component attributes are shown in column headers in the component lists.

Component type is taken from the value of the “object” attribute of a <Tab> element. Component attribute name is taken from the value of the “name” attribute of an <Attribute> element.

Both texts can be specified by adding <Title> child element to <Tab> and <Attribute> elements.

<Title> element allows specifying of text, localized for several locales (combinations of language and sorting order) as well as the default text that will be displayed if text, localized for the current user's locale, is not available.

<Title> element may have a sequence of <Locale> elements, each of which defines text for one locale, and one optional <Neutral> element that specifies the default text that will be used if localization for current locale is not available.

<Locale> element has one mandatory attribute “Icid”. Value of the attribute must be a positive integer number that identifies Windows' locale. Text of the element is the text, localized for the specified locale.

<Neutral> element has no attributes. Text of the element is the text that will be used if a <Locale> element for the current locale is not found.

If a <Default> element is not specified, value of the <Locale> element with locale identifier 1033 (US English) is used as the default. If a US English localized text also is not specified, no text will be displayed on the corresponding tab of column header.

The following sample shows use of the <Title> element:

```
<Tab object=”Transaction”>
  <Title>
    <Locale lcid=”1033”>Transactions</Locale>
    <Locale lcid=”1049”> [symbol] </Locale>
    <Neutral>Transaction</Neutral>
  </Title>
  <Key>
    <Attribute name=”ObjectID” />
  </Key>
  <Columns>
    <Attribute name=”State” >
      <Title>
        <Locale lcid=”1033”> Transaction State</Locale>
        <Locale lcid=”1049”> [symbol] </Locale>
        <Neutral> Transaction State</Neutral>
      </Title>
    </Attribute>
    ...
  </Columns>
  </ApplicationView>
</Tab>
```

### Screen Pop Feature

To provide agents with information about the customer, a ‘screen pop’ feature is provided. Essentially, the screen pop feature pops open a window containing information about the caller on the agent's computer screen . . .

Transfer of ScreenPop

When an agent working with caller needs to transfer a call to another agent (or just needs to consult another agent about customer's call) he/she needs to transfer his existing business application screen to the destination agent. One of possible approaches to this issue is using manual screen synchronization. In such scenario transfer originator will have to click a “Synchronize screens” button in the business application (Such as the FrontRange HEAT and GoldMine applications) or in the agent dashboard to send his current screen to the destination manually

Screen Transfer

Agent-to-Agent Messages

To implement such scenario we will use TCP connection to the CC server, which already exist on both originator and destination agent's dashboards.

To implement generic messaging channel between two agents we will introduce “UserMessage” message, which agent may send to other agent.

When Agent Server receives “UserMessage” request it will check if destination agent is logged in. If destination agent is not found or not logged in—Agent Server will send appropriate error packet to the origination agent's desktop.

If destination agent is logged in, Agent Server just forwards message to that agent.

The UserMessage request is sent to the AgentServer via TCP connection as IPP packet encoded into the UniTCP packet

The IPP packet is KVlist with the following keys:
“Command”=“UserMessage”
“MessageID”=“<message ID>”
“OriginationAgentID”=<origination AgentID>
“DestinationAgentID”=<destination AgentID>
arbitrary set of KV pairs—message parameters

To simplify sending and receiving user messages the new method is added to IVxConnection CCL interface:

HRESULT SendtUserMessage(([in] BSTR bstrAgentID,
([in] BSTR bstrMessageID, IIVRParameters* piParams);

And new method is added to the IACLConnector interface:

HRESULT OnASUserMessage([in] BSTR bstrFromAgentID,
([in] BSTR bstrMessageID, IIVRParameters* piParams);

Screen-Pop Transfer Process Description

When originator clicks that button the following happens:
1. Business application creates a new CCL connection object and initiates it from existing dashboard connection credentials. See 0 for more details
2. Business application calls SendCurrentScreen( ) method of that connection. This method has no parameters
3. IVxConnection::SendCurrentScreen method calls active connector's GetScreenData( )method, which should return a information, which identifies current screen from business application. This information is returned as list of KV-pairs. The content of that list depends on the business application.
4. CCL sends “UserMessage” message to the Agent Server, passing AgentID of the destination agent, SendScreen as command and screen identification as parameters. See 0 for details about destination AgentID
5. Agent server forwards received message to the destination agent's desktop
6. Destination agent's desktop calls its connector method ReceiveScreen( ), passing screen identification parameters, which came with the message
7. Destination agent's connector calls business application to do a screen-pop

Figure Screen_Pop illustrates simplified diagram of that screen pop process.

Dashboard Connection COM Object

This object is implemented as COM DLL and exports one COM class VPCC.DashboardConnection with IVxConnection COM interface.

The only goal of that object is to encapsulate obtaining shared connection to the server.

Dashboard will write connected server name into well known shared memory location after it is successfully connected to the server. The name of that location is “Dashboard.ConnectedServer”.

Dashboard must also destroy this shared memory location when disconnected from the server.

DashboardConnection object will first check if that shared memory exists. If it does not exist—that means dashboard is not running or not connected, so no screen maybe sent.

If that memory exists, DashboardConnection will use the value in the IVxConnection::Connect( ) method.

CCL

Obtaining Destination AgentID

When agent performs “Dial from Directory” or “Transfer from Directory” command, dashboard remembers destination agent ID in the shared memory location “Dashboard.ConsultAgentID”. When dialed call terminates (normally or as result of transfer completion) dashboard clears that location.

CCL checks this shared memory when SendCurrentScreen( ) method is called. If it is found—CCL will call active connector GetScreenData( ) method. If AgentID was not found—CCL returns error and does not call connector.

Sending “UserMessage” Request to Agent Server

After CCL receives call data from connector it will send “UserMessage” message to the Agent Server with “MessageID”=“SendScreen”. All screen data are transmitted as KVpairs of the UserMessage.

Receiving “UserMessage” Message from Agent Server

When CCL receives “UserMessage” message from Agent Server it will call OnASUserMessage( ) method of the local connector.

Connector checks the “MessageID” parameter. If it is “SendScreen”—it will do the screen-pop.

Implementation Actions

Existing Server/Client Components

CCL—add new methods:

HRESULT SendCurrentScreen([in] BSTR bstrAgentID);
HRESULT SendUserMessage(([in] BSTR bstrAgentID, ([in] BSTR
bstrMessageID, IIVRParameters* piParams);

Connector interface—add new methods:

HRESULT GetScreenData([out, retval] IIVRParameters** ppiData);
HRESULT OnASUserMessage([in] BSTR bstrFromAgentID, ([in] BSTR
bstrMessageID, IIVRParameters* piParams);

Dashboard
   Store connected server name in the shared memory after successful connect
   Clear server name from shared memory after disconnect
   Store AgentID of the destination agent after “ . . . from Directory” command in shared memory
   Clear AgentID from shared memory when outbound call to that agent terminates
   Implement DashboardConnection COM DLL
      HEAT Connector

The following new methods should be implemented in HEAT connector:

HRESULT GetScreenData([out, retval] IIVRParameters** ppiData);
HRESULT HRESULT OnASUserMessage([in] BSTR bstrFromAgentID,
([in] BSTR bstrMessageID, IIVRParameters* piParams);

GoldMine Connector

The following new methods should be implemented in GoldMine connector:

HRESULT GetScreenData([out, retval] IIVRParameters** ppiData);
HRESULT HRESULT OnASUserMessage([in] BSTR bstrFromAgentID,
([in] BSTR bstrMessageID, IIVRParameters* piParams);

### Agent Systems

The agent systems allow agents to couple to the Call Center Server and use its services.

Introduction

Currently each agent's computer must have server parameters configured in Registry. The following parameters must be defined:
Computer name
TCP port of Agent Server
TCP port of Interaction Server
TCP port of Smart Queue

When such approach is used, any changes in server's environment (like moving server on another computer or changing TCP ports) require changing configuration on all agent's computers. It is relatively easy to do if you have 5-10 agents, but becomes hard task if Contact Center grows further.

The automatic server discovery feature allows all Call Center servers to advertise themselves using UDP broadcasts, so agent software may present user a list of known servers and allow agent to select Contact Center Server from the list.

This feature also allows using dynamic allocation of the TCP ports when starting servers. Therefore, there TCP port numbers maybe excluded from server configuration. Currently, this is done for Agent Server, Interaction Server and Smart Queue.

Design

The idea of this feature is using UDP packets for requesting dynamic server information and advertising this information. To obtain initial servers list ACL broadcasts UDP request. To advertise newly started (or stopped) application server broadcasts appropriate UDP message.

Both server and ACL broadcast to all addresses by default (255.255.255.255). In some cases it maybe necessary to limit broadcast recipients. This maybe done by specifying broadcast destination in configuration.

To limit server advertisement broadcasts the appropriate value must be set in the server's configuration.

To limit client (ACL's) broadcasts, the appropriate value must be set on the ACL's local configuration.

Server part is always listening on the UDP port number 1973. All clients (ACLs) are using UDP port number 1974. This allows sever and client co-exist on the same computer.

Server Behavior

The following components advertise themselves when starting and stopping:
Host (Management Agent)
Any manageable application, like:
   Contact Center Server
   VoxPoint Server

All advertising is made by Management Agent NT service. When message must be set to all clients, server will broadcast it. The broadcast destination is 255.255.255.255 by default, but maybe changed in server's configuration. Server performs broadcasts to the UDP port number 1974 (which is client port).

The computer IP address is not transmitted in the broadcast packet body. It is determined as UDP source address instead.

Host Advertising

When Management Agent starts, it broadcasts Host Advertise UDP packet with the following data:
Host computer name (“Name” attribute of the Host XML tag in configuration)
Management Agent TCP port
VoxPoint Server installed Boolean flag
Contact Center Server installed Boolean flag

When Management Agent discovers new client (receives Client Advertisement UDP packet), it responds with its advertising information to the client.

When Management Agent service stops, it broadcasts Host Gone UDP packet.

Manageable Servers Advertising

When Management Agent successfully executes Start command for any application (server), it advertises this application. The following data included in advertisement:
Application (Server) name from configuration
Application type string (like “VoxPoint”)
KV-list of application-supplied attributes, if exist

When Management Agent discovers new client (receives Client Advertisement UDP packet), it also sends advertisement packet about each started application to the client.

When application is stopped, Management Agent broadcasts Application Gone UDP packet. Only application name and type are broadcasted in this case.

Contact Center Advertisement Data

The following data is transmitted for Contact Center Server (beside application name and type):
Agent Server TCP port number—the number of TCP port for connections to the Agent Server
Interaction Server TCP port number—the number of TCP port for connections to the Interaction (Data) Server
Smart Queue TCP port number—the number of TCP port for connections to the Smart Queue Server
   Agent's Behavior

When started, ACL broadcasts client advertisement over UDP. All running Contact Center Servers respond with advertisement to this ACL, so new ACL may collect list of currently installed Contact Center Servers and present this list to the agent during login.

When message must be set to all servers, ACL will broadcast it. The broadcast destination is 255.255.255.255 by default, but maybe changed in ACL configuration. ACL always send broadcasts to the UDP port number 1973 (server port).

ACL keeps list of the running servers in memory and updates this list when other servers start or stop.

ACL still have possibility to use locally stored configuration.

Figure ACL illustrates configuration of the ACL:

If “Use automatic server configuration” box is checked, ACL will use server's discovery to present list of servers in the login dialog. Otherwise, it will use locally stored server information, which is set in the Static Server settings frame.

If automatic server configuration option is checked, the IP address for UDP broadcasts maybe entered in the Broadcast UDP field.

The Static Server Settings fields are disabled, if “Use automatic server configuration” box is checked.

Figure A_LOGIN illustrates the agent Login dialog.

The very bottom field lists all discovered servers. If “Use automatic server configuration” box is not checked in the Settings, this field will be disabled to reflect using of locally stored configuration.

The last selected server is remembered in the Registry, so it is selected during next login.

If new Contact Center servers are discovered when Login dialog is displayed on the screen, these servers will be added to the servers list on the fly, so there is no need to close and open Login dialog again.

Configuration

Server may use statically configured TCP ports or allocate TCP ports dynamically during startup. Al three ports (Agent Server, Data Server and Smart Queue) must be configured in the same way (either static or dynamic). By default, server uses dynamic port allocation, which allows customers skip configuration of these ports in 99 percent of installations.

If local network prevents server from using broadcasts, the system maybe configured statically.

The following changes are made on the Server configuration:
BroadcastIPAddress optional attribute added to the ManagementAgent node. Default value is “255.255.255.255”
UseDynamicPorts boolean attribute added to the Contact Center Application node. Default value is true
Web configuration Interface must allow changing this parameter in the advanced settings of the Contact Center
If this parameter is checked (true), the Agent Server TCP port, Data Server TCP port and Call Distribution TCP port fields must be grayed (disabled) to reflect the fact that these fields are not used
   IP Protocol

The Server Broadcast Protocol is defined to implement the feature. The protocol is based on standard Call Center protocols framework. The ID of the protocol is 0x8000.

The following messages constitute the protocol:

| Packet | Direction | Description |
|---|---|---|
| Client Advertise | Broadcast | Client broadcasts this packet when |
| Packet | | starting. |
| Host Advertise | Broadcast, | Management Agent sends this |
| Packet | Response | message in response for Client Version |
| | | Report message and during Management |
| | | Agent NT service startup |
| Host Gone Packet | Broadcast | Management Agent sends this message |
| | | when stopping Management Agent |
| | | NT service |
| Application | Broadcast, | Management Agent sends this message |
| Advertise Packet | response | for each started server application in |
| | | response for Client Version Report |
| | | message and after starting application |
| Application Gone | Broadcast | Management Agent sends this message |
| Packet | | when stopping server application |

Client Advertise Packet

This packet consists of the following elements:

| # | Element | Type | Description |
|---|---|---|---|
| 1 | Packet ID | 8-bit unsigned intege = 0x00 | Identifier of packet. |
| 2 | Name length | 16-bit unsigned integer | Length of the Unicode |
| | | | string that represents |
| | | | name of the client |
| 3 | Name | Sequence of Unicode | Name of the client. |
| | | characters | |

Host Advertise Packet

This packet consists of the following elements:

| # | Element | Type | Description |
|---|---|---|---|
| 1 | Packet ID | 8-bit unsigned | Identifier of packet. |
| | | integer = 0x01 | |
| 2 | Name length | 16-bit unsigned | Length of the Unicode |
| | | integer | string that represents |
| | | | name of the server |
| 3 | Name | Sequence of | Name of the host. |
| | | Unicode characters | |
| 4 | VoxPoint flag | Byte | 1, if VoxPoint Server is |
| | | | installed, otherwise 0 |
| 5 | Contact | Byte | 1, if Contact Center Server is |
| | Center flag | | installed, otherwise 0 |

Host Gone Packet

This packet consists of the following elements:

| # | Element | Type | Description |
|---|---|---|---|
| 1 | Packet ID | 8-bit unsigned integer = 0x01 | Identifier of packet. |

Application Advertise Packet

This packet consists of the following elements:

| # | Element | Type | Description |
|---|---|---|---|
| 1 | Packet ID | 8-bit unsigned integer = | Identifier of packet. |
| | | 0x01 | |
| 2 | Name | 16-bit unsigned integer | Length of the Unicode string |
| | length | | that represents name of the |
| | | | application (server) |
| 3 | Name | Sequence of Unicode | Name of the application |
| | | characters | (server) |
| 4 | Type | 16-bit unsigned integer | Length of the Unicode string |
| | length | | that represents type of the |
| | | | application (server) |
| 5 | Type | Sequence of Unicode | Type of the application |
| | | characters | (server) |
| 6 | Attributes | 16-bit unsigned integer | Number of server specific |
| | count | | attributes that's new values |
| | | | follow the count. |

| | | |
|---|---|---|
| 7 | Attributes | Sequence of structures that represent pairs |
| | list | of attribute names and values. Layout of an |
| | | individual structure explained below. |

The following table shows the layout of an attribute structure:

| # | Element | Type | Description |
|---|---|---|---|
| 1 | Attribute name | 16-bit unsigned integer | Number of Unicode |
| | length | | characters that follow |
| | | | the length. |
| 2 | Attribute name | Sequence of Unicode | Characters that constitute |
| | | characters | name of the attribute. |
| 3 | Attribute value | 16-bit unsigned integer | Number of Unicode |
| | length | | characters that follow |
| | | | the length. |
| 4 | Attribute value | Sequence of Unicode | Characters that constitute |
| | | characters | value of the attribute. |

Application Gone Packet

This packet consists of the following elements:

| # | Element | Type | Description |
|---|---|---|---|
| 1 | Packet ID | 8-bit unsigned integer = 0x01 | Identifier of packet. |
| 2 | Name length | 16-bit unsigned integer | Length of the Unicode string that represents name of the |
| | | | application (server) |
| 3 | Name | Sequence of Unicode | Name of the application (server) |
| | | characters | |
| 4 | Type length | 16-bit unsigned integer | Length of the Unicode string that represents type of the |
| | | | application (server) |
| 5 | Type | Sequence of Unicode | Type of the application (server) |
| | | characters | |

Task Split

The following product parts and components are affected by this feature.

Management Agent

Broadcasts itself when starting and stopping
Responds to client's advertisements with host information and servers information
   ACL
Broadcasts itself when starting
Receives responses from servers
Maintains servers list
   Configuration

The Host configuration page must add following field:
BroadcastIPAddress, corresponds to the attribute of the ManagementAgent node. Optional. Must be valid IP address or empty string

The Advanced Contact Center configuration page must contain following fields:
UseDynamicPorts boolean attribute (checkbox) reflects attribute of the Contact Center Application node.
The TCP ports (Agent Server, Data Server and Call Distribution) must be grouped in the visible frame. These three fields must be greyed if UseDynamicPorts is checked. Otherwise, these fields must be enabled.
   Installation (Setup)

Initial configuration must have following additional attributes:
BroadcastIPAddress attribute of the ManagementAgent node must have value “255.255.255.255”
Application node for Contact Center must have UseDynamicPotrs=”true” attribute
The Name attribute of each Application node must be set in form “Telephony Server on HOSTNAME” or “Contact Center Server on HOSTNAME” by installer to make these names unique out of the box.

IP Soft Phone Description

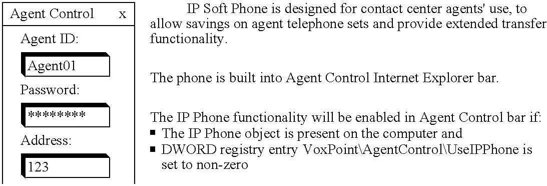

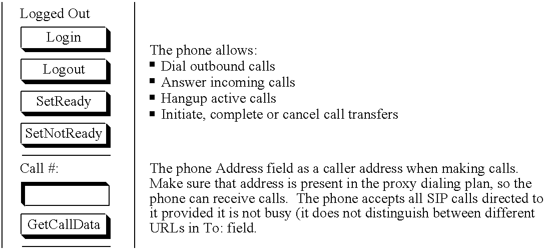

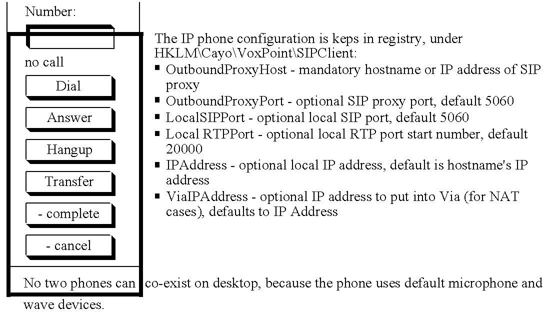

When running phone, make sure there are no programs using LocalSIPPort. If there are, the phone will complain and disable itself.

Agent Queue Monitoring

This section describes design of the Agent Queue Monitoring console.

Purpose

Agent Queue Monitoring Console (Agent Console) is a GUI application, which runs on the Agent's computer. Agent Console performs following tasks:
Presents configurable view
   Displays calls waiting in the queue
   Groups calls by configurable criteria (existence of specific call attached data keys)
   Displays call details from attached data (set of data is configurable).
   Each group including top node has its own set of call details to display
   Allows special formatting based on conditions (i.e. red font for calls with Time In Queue greater then X seconds)
   There is one view configuration per Call Center
   The configuration is kept on server
Identifies agent using it by login/password
Allows agent to pull the selected call provided that the agent is in Ready or in Not Ready state
   System Components
   Components and Their Relationships

The Agent Console works together with Call Center server and Agent Desktop components.

The Agent Console must be able to perform following requests:
Request list of interactions currently in the queue
Request state of the associated agent
Request a list of interaction attributes
Pull particular interaction from the queue (distribute this interaction on the particular agent immediately)

The Agent Console needs to receive the following notifications:
Associated agent state change
New interaction arrival in the queue
Interaction removal from the queue
Change of value of interaction attributes (subscription)

Figure Components illustrates the components and their relationships

In order to perform everything mentioned above, Agent Console must have access to the following server components:
Agent Server (to receive agent state notifications and request agent state). Since TCP connections to AgentServer are stateful (they are associated with an agent and AgentServer logs agent out when connection is terminated), Agent Console must reuse same connection to the Agent Server which Agent Desktop uses.
Data Server (to request interaction attributes and receive notifications about their changes)
Smart Queue (to request list of currently queued interactions and receive notifications about interaction arrivals and removals)
   Agent Console
   GUI Design

In one embodiment, the agent console is implemented as separate application. It uses ACL to access server components.

Depending on configuration, the console may or may not provide means for changing state of the agent.
Figure GUI illustrates one embodiment of the GUI interface of the Agent Console.

Agent console window consists of three main elements:
Left pane. This pane contains configurable tree of filters that control which interactions are displayed in the right pane and which attributes are displayed for each interaction. If there are any interactions that match a filter, number of such interactions is displayed next to the filter name.
Right pane. Top part of the pane displays information about agent (agent identifier and current state) and the “Pull” button that initiates delivery of an interaction to the agent. Bottom part displays the list of interactions, selected by the filter, selected in the left pane.
   Configuration

Configuration of the console is a part of configuration of the Call Center. Upon start, the console requests configuration XML document from the remote management agent, which allows applying the same configuration for all consoles in the Call Center.

Configuration is retrieved from the agent via a TCP/IP connection. Host name/address and port number of the agent are specified in the registry key “HKEY_LOCAL_MACHINE\SOFTWARE\Cayo\VoxPoint\Queue Monitoring Console” as “AgentHost” and “AgentPort” values. “AgentHost” must be a string value; “AgentPort” must be a DWORD value.

The configuration contains the following:
Hierarchy of filters, displayed in the left pane.
For each filter—the localizable display name, filtering condition and definition of content of the right pane. Filters inherit all parameters except the display name from their parent filters.
Each content definition contains a set of definitions of columns that the console displays in the list in the right pane, and a set of formatting conditions. Each column represents one attribute of an interaction object. For each column the name of the interaction attribute and localizable title of the column are specified. Optional information about formatting of column data can also be specified.
Optional formatting conditions that can be specified for a filter include a condition and an action that must be taken when an interaction meets the condition. Conditions are simple comparisons of values of interaction attributes with constants. Actions are instructions about highlighting of list items that display interaction attributes.

The following sample shows a part of the configuration of Call Center that configures the console:

```
<QueueMonitor>
<Timers>
  <Timer name=”main” delay=”5” />
</Timers>
<Filters>
  <Filter id=“F-MAIN”>
    <Title>
      <Neutral>All Queued Interactions</Neutral>
    </Title>
    <View>
      <ItemFormat>
        <Conditions>
          <Greater attribute=”Result”
value=”25” type=”integer” />
        </Conditions>
        <Actions>
          <TextColor color=”red” />
        </Actions>
      </ItemFormat>
      <Attribute name=“InputHDA”>
        <Title>
          <Neutral>HDA</Neutral>
        </Title>
      </Attribute>
      <Attribute name=“Product”>
        <Title>
          <Neutral>Product</Neutral>
        </Title>
      </Attribute>
      <Attribute name=“SubProduct”>
        <Title>
          <Neutral>Subproduct</Neutral>
        </Title>
      </Attribute>
    </View>
    <Filter id=“F-HPCC”>
      <Title>
        <Neutral>HPCC Calls</Neutral>
      </Title>
      <Condition class=“attribute-match”
attribute=“Type” value=“InputHDA” />
    </Filter>
  </Filter>
</Filters>
</ QueueMonitor >
```

The root element of the configuration is <QueueMonitor>; the element is needed only to distinguish configuration of the console from other parts of VoxPoint configuration.

<QueueMonitor> element has one mandatory child element <Filters> and one optional child element <Timers>.

<Filters> element has no attributes and contains a sequence of <Filter> elements, each of which defines a filter. <Filter> element may have an optional attribute id. The attribute specifies the unique identifier of the filter. When identifier is specified, the console stores the layout of the list of interactions in system registry as a binary entry in the key “HKEY_CURRENT_USER\Software\Cayo\Queue Monitoring Console\Layout\Filters”; name of the entry is the same as the filter identifier.

<Timers> element contains a sequence of <Timer> elements that define timers that will be created by the console.

<Filter> element may have three types of child elements: <Title>, <View>, <Condition> and <Filter>.
<Title> element specifies the localizable title of the filter that will be displayed in the left pane. The element is mandatory and there must be only one <Title> element in each <Filter> element. Contents of the element will be described below.
<View> element defines contents of the list of interactions in the right pane (the interactions view). The element may be omitted in all <Filter> elements except for the immediate children of the <Filters> element (top level filters). If the element is omitted, all parameters of the view are inherited from the parent <Filter> element. Contents of the element will be described below.
<Condition> element defines a condition that must be satisfied in order for an interaction to be displayed in the interactions view. Contents of the element will be described below. If more than one <Condition> element is specified, all conditions must be met before an interaction will be displayed. All conditions of all parent <Filter> elements must also be satisfied.
<Filter> element defines a child filter that will be displayed in the filters tree (the left pane) under the filter, defined by the parent <Filter> element.

<Timer> element (a child of the <Timers> element) has two mandatory attributes: name and delay. The former attribute specifies the unique name of the timer to which other parts of the configuration may refer. The latter attribute specifies delay between timer events in seconds. Values from 1 through 60 are permitted for the delay.

<Title> Element

The element defines a set of strings that represent the same phrase, translated in different languages. Languages are specified by Windows locale identifiers (a Windows locale is an integer number that represents a combination of language, sub-language or dialect, and sorting order).

The element may contain a sequence of <Locale> elements and a <Neutral> element. Both elements can be omitted, but not at the same time.

The following sample shows a <Title> element with text, translated in different languages:

```
<Title>
  <Locale lcid=”1033”>Interaction</Locale>
  <Locale lcid=”1049”>$$HTepaK$$</Locale>
  <Neutral>Interaction</Neutral>
</Title>
```

<Locale> element represents text, translated into a specific language. The language is specified by the value of the lcid attribute. The value must be a decimal positive integer number and must represent a valid Windows locale identifier. Text of the element represents the title.

<Neutral> element represents the default text that will be displayed if text, localized for the current user's locale is not specified by a <Locale> element. Text of the element represents the title.

In order to properly decode non-Latin characters of national languages, the configuration XML document must be saved in a valid UTF (UTF-8, a UTF-16s or a UTF-32). Standard XML localization requirements must be met (header of the document must specify the encoding and an appropriate Byte Order Mask or BOM must precede the document data).

<View> Element

The element defines the set of interaction attributes that will be displayed in the interactions list. Each attribute is displayed in a column in the list.

Each attribute represented by an <Attribute> element that have one mandatory attribute name and optional child elements <Title> and <Format>.

An optional attribute “refresh-timer” may also be specified. Value of the attribute must match the name of one of the timers, defined in the <Timers> element described above. If the element is specified, the console requests value of the attribute from Data Server when the timer fires an event.

name attribute specifies the name of an interaction attribute, displayed in the column.

<Title> element specifies the title of the column; if the element is omitted, name of the attribute is displayed in the column title. Contents of the <Title> element are identical to the contents of the <Title> element from the <Filter> element, described above.

<Format> element specifies how value of the attribute must be formatted. The element has one mandatory attribute class. Value of the attribute specifies the class of data formatting. Other attributes, specific to particular classes, can also be added to the element. One embodiment of the console supports the following classes of formatting:
“dec”—format value as a decimal integer number.
“hex”—format value as a hexadecimal integer number.
“duration”—format value as a duration (days, hours, minutes and seconds); value of the attribute must represent an integer number of seconds.

For all supported classes an optional prefix can be specified by an attribute “prefix”, value of which is inserted at the beginning of the formatted attribute.

The following sample shows attribute definitions with specified formatting:

```
<Attribute name=“Result” type=“integer”>
  <Title>
      <Neutral>Result</Neutral>
  </Title>
  <Format class=“duration” />
</Attribute>
<Attribute name=“Number” type=“integer”>
  <Title>
      <Neutral>Number</Neutral>
  </Title>
  <Format class=“hex” prefix=”0x” />
</Attribute>
```

<Condition> Element

The element defines a condition against which interactions are matched before being displayed in the interactions list.

The element has one mandatory attribute class, which specifies the class of the condition. Other attributes and child elements depend on the class of condition.

One embodiment of the console supports one condition class—attribute-match, which defines “attribute match” conditions.

An attribute match condition element has two mandatory attributes: attribute and value; the former specifies the name of an interaction attribute, the latter—the value that is compared with the value of the specified interaction attribute to check if the condition is satisfied. If an interaction does not have the specified attribute, the condition is considered to be satisfied; otherwise, the exact match satisfies the condition. Value of the attribute of interaction and the value specified by the value attribute are compared as strings.

The following sample shows an attribute match condition that compares value of the “Type” interaction attribute with “InputHDA”:

<Condition class=“attribute-match” attribute=“Type”
value=“InputHDA”/>

Conditional Formatting of Displayed Interactions

Conditional formatting can be applied to interactions, displayed in the list in the right pane. If an interaction matches certain conditions, text and background colors can be changed to highlight the interaction.

Conditional formatting is defined by a set of optional <ItemFormat> elements in <View> elements as the sample above shows.

Each <ItemFormat> element defines a set of conditions in a <Conditions> element, and a set of actions in <Actions> element. For each displayed interactions that match all conditions, all actions are performed.

The following sample shows the layout of an <ItemFormat> element:

```
<ItemFormat>
  <Conditions>
      list of conditions
  </Conditions>
  <Actions>
      list of actions
  </Actions>
</ItemFormat>
```

One embodiment of the console supports conditions that compare values of interaction attributes with constants. The following condition elements are recognized:
<Greater> check if value of an attribute is greater than the specified constant.
<Less> check if value of an attribute is less than the specified constant.
<Equal> check if value of an attribute is equal to the specified constant.

All condition elements have the same set of attributes:
attribute (mandatory)—specifies the name of an interaction attribute, value of which is checked.
value (mandatory)—specifies the constant with which value of the attribute is compared.
type (optional)—specifies data type of the value. Value of this attribute can be “integer” or “string”.
   If the attribute is omitted, data type is considered to be string.
   If value of the attribute is “integer”, interaction attribute and the constant are converted to signed 32-bit integer values before comparison. If value of the attribute is “string” (or if the attribute is omitted), values are compared as strings.

One embodiment of the console supports two types of actions that set color of text and background for interactions, displayed in the list. The actions are defined by <TextColor> and <BackgroundColor> elements. Both elements have one mandatory attribute color. Value of the attribute can be an HTML name of a color or an HTML RGB color representation in form #RRGGBB, where RR, GG and BB are hexadecimal numbers that specify amounts of red, green and blue base colors in the color that the element sets.

The following sample shows use of conditional formatting:

```
<!--
  Highlight all interactions with wait time longer that 25
-->
<ItemFormat>
  <Conditions>
      <Greater attribute=”WaitTime” value=”25” type=”integer” />
  </Conditions>
  <Actions>
      <TextColor color=”darkred” />
  </Actions>
</ItemFormat>
<!--
  Highlight all interactions with high urgency and wait time longer
that 50
-->
<ItemFormat>
  <Conditions>
      <Greater attribute=”WaitTime” value=”50” type=”integer” />
      <Equal attribute=”Urgency” value=”High” type=”string” />
  </Conditions>
  <Actions>
      <TextColor color=”red” />
      <BackgroundColor color=”lightyellow” />
  </Actions>
</ItemFormat>
```

Pulling Interaction from the Queue

When agent decided to pull specific interaction from the queue, he selects this interaction in the right pane then hits Pull button. Agent Console calls IACLQueue::PullInteraction method, which sends appropriate request to the SmartQueue.

In response to this request SmartQueue does following:
Attaches special key “ReservedInteractionID” to the appropriate agent. SmartQueue will exclude agent with such key set from the regular agent matching algorithm, to ensure such agent will NOT be assigned to another interaction by the normal routing
Sends TargetAvailable event to the appropriate Application Context with agent interface attached

Call Center Application will then process TargetAvailable event in standard way (call agent and connect him to the customer).

Since agent may pull interaction from the queue even if he is in NotReady state, the agent reservation mechanism must be changed.

Agent's interface will be modified to add “InteractionID” parameters to the Reserve( ) and CloneReserved( ) methods. Using this parameter SmartQueue may tell Agent Server that agent is reserved for specific interaction. Agent's state model will allow transition from NotReady state to the Reserved state, if agent's “ReservedInteractionID” attribute match InteractionID parameter.

Registry Data

Queue Monitoring Console keeps some data in local Registry under the “HKLM\Software\Cayo\VoxPoint\Queue Monitoring Console” key. The following data is needed:
AgentHost—string, name of the computer, where Call Center Server is running, mandatory
AgentPort—DWORD, number of TCP port of the Management Agent on the server, optional, default 1971
Timeout—DWORD, timeout waiting for configuration data from server, milliseconds, default 3000

Example of Queue Monitoring Console Registry Data:

[HKEY_LOCAL_MACHINE\SOFTWARE\Cayo\VoxPoint\Queue
Monitoring Console]
“AgentHost”=“hostname”
“AgentPort”=dword:000007b3
“ Timeout ”=dword:00000bb8

Agent Connectivity Layer
Description

New agent side component is introduced here—Agent Connectivity Layer. The goal of this component is to provide unified means of access to different server components for different agent applications. In one embodiment, two agent applications which require access to the server—Agent Desktop and Agent Console. There maybe more such application in the future.

Since agent applications may (and will) reside in different processes, the ACL may not be implemented as DLL. Otherwise it is implemented as EXE module.

ACL exports a number of COM objects (separate object for each server component). It maintains TCP connections to every required server component and uses these connections to perform requests from its own clients (agent applications).

In one embodiment, Call Center server design requires separate TCP connections (sockets) to the Agent Server, Data Server and Smart Queue. In the future, these three connections (and possible connections to other server modules) maybe combined in the single TCP connection without affecting agent GUI application code.

ACL creates single instance of internal C++ object, which creates and maintains TCP connections to the server components.

COM Classes

ACL implements three COM objects:
AgentACL—allows to perform agent state changes (login, logout, ready, not ready) and receive agent state change events
DataACL—allows to request interaction data from the Data Server
QueueACL—allows requesting a list of queued interactions from the SmartQueue, requesting forceful distribution of specified interaction to specified agent (Interaction pull) and receiving notifications about interaction arrivals/departures to/from the queue.

Each COM object implements its own COM interface for application purposes.

Events Delivery

ACL reports events to the client applications as standard VoxPoint IIVREvent objects. This object is described in “VP Core Design (EN).doc”, chapter 6.4.1.

There are two different ways of receiving events in the ACL client applications. Therefore, there are two COM classes exist for each connection (Agent, Data and Queue).

Asynchronous Delivery—Connection Points

First method uses automation Connection Points technique. The COM class implements Connection Point and client implements notification (sync) interface. Events are delivered asynchronously by calling sync interface from the ACL.

This approach is useful when ACL client is Visual Basic application or scripting application (scripting applications may have limitations related to COM containers they are running in).

Synchronous Delivery—IVxEventsQueue Interface

Second method uses IVxEventsQueue interface. ACL client must implement this interface and pass pointer to it to the ACL COM class. Every synchronous ACL COM class implements IACLEventsQueueInit interface, which has SetEVentsQueue( ) method. This method is used to pass IVxEventsQueue interface pointer to the ACL.

Once this is done, ACL will put events into the client's events queue.

GUI Part

ACL provides GUI means for an agent to change his state. ACL places new icon in the system tray. This icon reflects server TCP connection state and agent state.

When user clicks on the icon the popup menu is provided with commands. The set of available commands depends on the current agent state and connection state and allows agent to login, logout, and set ready and not ready.

Custom Menu Commands

ACL tray menu maybe customized by Registry configuration. It is possible to define up to 100 custom commands.

All custom commands are stored under HKLM\Software\Cayo\VoxPoint\ACL\Commands Registry subkey. ACL reads registry during start and adds all configured commands at the end of the menu.

ACL does not monitors Registry and will not add new commands, which were configured after ACL started. To reflect newly configured commands ACL has to be restarted.

Each command is stored as separate subkey. The name of this subkey does not matter.

For each command the following values must be defined:
Default value—default name of the menu item, string. Used when no localized name is available
“Command”—command string of the application to be started, including all necessary arguments. If empty or absent—command will be ignored
“Index”—DWORD, optional index of the command in the menu. Default value 0. If more than one command have same index, the order will be undefined.
<LANGID, decimal>—string, localized name of the command. For example, to create Russian name of the command, add “1049” value

When user selects custom command from the menu ACL just starts new program like it would be done in command prompt.

The sample of Registry configured commands:

[HKEY_LOCAL_MACHINE\SOFTWARE\Cayo\VoxPoint\ACL\
Commands]
[HKEY_LOCAL_MACHINE\SOFTWARE\Cayo\VoxPoint\ACL\
Commands\Notepad]
@=“Notepad”
“Command”=“\”notepad.exe\“ c:\\winzip.log”
“Index”=dword:00000002
[HKEY_LOCAL_MACHINE\SOFTWARE\Cayo\VoxPoint\ACL\
Commands\RunIE]
@=“Start Internet Explorer”
“Command”=“\”C:\\Program Files\\Internet Explorer\\IEXPLORE.EXE\“”
“Index”=dword:00000001
[HKEY_LOCAL_MACHINE\SOFTWARE\Cayo\VoxPoint\ACL\
Commands\RunQueueConsole]
@=“Start Queue Monitoring Console”
“1049”=“ [symbol] ”
“Command”=“\”c:\\Program FIles\\Cayo\\VoxPoint\\Bin\\QCMON.exe\“”
“Index”=dword:00000000

Lifecycle

ACL process maybe started:
By Windows SCM when any ACL COM object is requested
By explicit startint of the ACL's executable

ACL process ends only by performing “Exit” command from the tray menu. Therefore, the lifecycle of ACL is not same as for regular COM servers, which are usually terminate when last COM object is released.

If Exit command is called when active COM objects exist, the process gets terminated anyway. In this case the ACL clients will get RPC_S_SERVER_UNAVAILABLE error on the next call to the ACL COM object.

Error Reporting

Since ACL is implements as out-of-proc COM server (EXE), we cannot use IErrorInfo automation mechanism for reporting errors (ErrorInfo object is designed for using in in-proc servers and associated with thread).

Instead, every ACL COM class reports errors as “Error” event.

ACL Agent State Model

ACL layer must be logged into the Call Center as agent before any data access can be provided. That means that first application willing to access server must perform Login operation. Once one application logged ACL (using Login method of IACLAgent interface) the ACL functionality is available for all other applications on this machine.

In typical scenario agent will first start desktop application and login. After successful login agent may run Agent Console application, which will use already logged ACL to access Queue and Data Servers.

Since agent state is maintained in the singleton C++ object inside ACL layer, all COM object instances will refer to the same C++ object and all COM objects will reflect agent state simultaneously.

Integration with External Applications

Integration interface is designed to provide custom event processing for external applications. The CLSID or ProgID of the connector COM object maybe defined in the Registry:

[HKEY_LOCAL_MACHINE\Software\Cayo\VoxPoint\ACL]
“Connector”=“Sample.ACLConnector”

Connector COM object must implement IACLConnector COM interface (which is dual, so connector maybe created using Jscript).

When new interaction arrives to the agent, ACL calls IACLConnector::NewInteraction( ) method passing Interaction ID. Connector may use all ACL COM classes to gain access to the interaction data or agent state.

ACL creates connector object during start and keeps it until ACL exists.

Registry Data

ACL keeps all its configuration data in local Registry under the “HKLM\Software\Cayo\VoxPoint\ACL” key. The following data is needed:
ServerHost—string, name of the computer, where Call Center Server is running, mandatory
AgentServerPort—DWORD, number of TCP port of the Agent Server, optional, default 3000
DataServerPort—DWORD, number of TCP port of the Data Server, optional, default 3002
QueueServerPort—DWORD, number of TCP port of the Smart Queue, optional, default 3006
Connector—string, ProgID or CLSID of the third party application connector. Optional, default none.

The configuration of custom commands is stored in the “Commands” subkey and described in chapter 0.

Example of ACL Registry Data:

[HKEY_LOCAL_MACHINE\SOFTWARE\Cayo\VoxPoint\ACL]
“ServerHost”=“VP-SERVER”
“AgentServerPort”=dword:00000bb8
“DataServerPort”=dword:00000bba
“QueueServerPort”=dword:00000bbe
“Connector”=“VPCC.Connector”
[HKEY_LOCAL_MACHINE\SOFTWARE\Cayo\VoxPoint\ACL\
Commands]
[HKEY_LOCAL_MACHINE\SOFTWARE\Cayo\VoxPoint\ACL\
Commands\IE]
@=“Start Internet Explorer”
“Command”=“\”C:\\Program Files\\Internet Explorer\\IEXPLORE.EXE\“”
“Index”=dword:00000001
[HKEY_LOCAL_MACHINE\SOFTWARE\Cayo\VoxPoint\ACL\
Commands\Notepad]
@=“Start Notepad”
“Command”=“notepad. exe”
“Index”=dword:00000002
[HKEY_LOCAL_MACHINE\SOFTWARE\Cayo\VoxPoint\ACL\
Commands\QCMon]
@=“Start Queue Monitoring Console”
“Command”=“\”C:\\Program Files\\Cayo\\VoxPoint\\Bin\\qmcon.exe\“”

ACL COM Interfaces
IACLAgent

This interface represents connection to the Agent Server.

IACLAgent Interface Methods

Login

HRESULT Login([in] BSTR bstrAgentID, [in] BSTR bstrPassword, [in,
defaultvalue (“”)] BSTR bstrAddress);

Logs agent into Call Center. Return values:
S_OK if login operation successful
E_ACCESSDENIED—if supplied credentials are invalid
S_FALSE—if ACL is already logged in
E_FAIL—if ACL is not connected to the server (no IP connection of server not started)
   Logout

HRESULT Logout( );

Logs agent out of Call Center. Return values:
S_OK if login operation successful
E_ACCESSDENIED—if ACL is not logged in
E_FAIL—if ACL is not connected to the server (no IP connection of server not started)
   SetReady

HRESULT SetReady( );

Sets agent into Ready state. Return values:
S_OK—if operation successful
S_FALSE—if current agent state does not allow transition into the Ready state
E_ACCESSDENIED—if ACL is not logged in
E_FAIL—if ACL is not connected to the server (no IP connection of server not started)
   SetNotReady

HRESULT SetNotReady([in, defaultvalue(“ ”)] BSTR bstrReason);

Sets agent into NotReady state. Return values:
S_OK—if operation successful
S_FALSE—if current agent state does not allow transition into the NotReady state
E_ACCESSDENIED—if ACL is not logged in
E_FAIL—if ACL is not connected to the server (no IP connection of server not started)
   IACLAgent Interface Automation Properties
   AgentID (Read Only Property)

HRESULT AgentID([out, retval] BSTR* pbstrAgentID);

Obtains ID of currently logged agent. Return values:
S_OK—if operation successful
E_ACCESSDENIED—if ACL is not logged in
E_FAIL—if ACL is not connected to the server (no IP connection of server not started)
   State (Read Only Property)

HRESULT AgentState([out, retval] ULONG* pulState);

Obtains state of currently logged agent. Return values:
S_OK—if operation successful
E_ACCESSDENIED—if ACL is not logged in
E_FAIL—if ACL is not connected to the server (no IP connection of server not started)
   Connected (Read Only Property)

HRESULT Connected([out, retval] VARIANT_BOOL* pbConnected);

Returns state of the TCP connection to the server. Return values:
S_OK—if operation successful
   LoggedIn (Read Only Property)

HRESULT LoggedIn([out, retval] VARIANT BOOL* pbLogged);

Returns TRUE if agent is logged in. Return values:
S_OK—if operation successful
E_FAIL—if ACL is not connected to the server (no IP connection of server not started)
   CloneAutoLogout

HRESULT CloneAutoLogout([out, retval] IACLAgent** ppiAgentACL);

Obtains IACLAgent interface, which will logout agent automatically upon releasing. Return values:
S_OK—if operation successful
   IACLData
   IACLData Interface Methods
   GetInteractionData

HRESULT GetInteractionData([in] ULONG ulInteractionID, [in] BSTR bstrKey);

Request a single interaction attribute. The request generates “DataRetrieved” response with result.

Return values:
S_OK—if operation successful
E_ACCESSDENIED—if ACL is not logged in
E_FAIL—if ACL is not connected to the server (no IP connection of server not started)

PutInteractionData

HRESULT PutInteractionData([in] ULONG ulInteractionID, [in] BSTR
bstrKey, [in] BSTR bstrValue);

Sets a single interaction attribute. The request may generate “Error” response.

Return values:
S_OK—if operation successful
F_ACCESSDENIED—if ACL is not logged in
E_FAIL—if ACL is not connected to the server (no IP connection of server not started)
   IACLData Interface Automation Properties
   AgentID (Read Only Property)

HRESULT AgentID([out, retval] BSTR* pbstrAgentID);

Obtains ID of currently logged agent. Return values:
S_OK—if operation successful
E_ACCESSDENIED—if ACL is not logged in
E_FAIL—if ACL is not connected to the server (no IP connection of server not started)
   State (Read Only Property)

HRESULT AgentState([out, retval] ULONG* pulState);

Obtains state of currently logged agent. Return values:
S_OK—if operation successful
E_ACCESSDENIED—if ACL is not logged in
E_FAIL—if ACL is not connected to the server (no IP connection of server not started)
   Connected (Read Only Property)

HRESULT Connected([out, retval] VARIANT_BOOL* pbConnected);

Returns state of the TCP connection to the server. Return values:
S_OK—if operation successful
   LoggedIn (Read Only Property)

HRESULT LoggedIn([out, retval] VARIANT_BOOL* pbLogged);

Returns TRUE if agent is logged in. Return values:
S_OK—if operation successful
E_FAIL—if ACL is not connected to the server (no IP connection of server not started)
   IACLQueue
   IACLQueue Interface Methods
   GetQueuedInteractions

HRESULT EnumQueuedInteractions( );

Requests server to report all currently queued interaction IDs. Return values:
S_OK—if operation successful
E_ACCESSDENIED—if ACL is not logged in
E_FAIL—if ACL is not connected to the server (no IP connection of server not started)

If request was successfully sent, server will report interactions as sequence of “NextInteraction” events followed by the “EndOfList” event.

PullInteraction

HRESULT PullInteraction([in] ULONG ulInteractionID);

Pulls specified interaction for logged agent. Return values:
S_OK—if operation successful
E_INVALIDARG—if provided InteractionID is invalid
E_ACCESSDENIED—if ACL is not logged in
E_FAIL—if ACL is not connected to the server (no IP connection of server not started)
   IACLQueue Interface Automation Properties
   AgentID (Read Only Property)

HRESULT AgentID([out, retval] BSTR* pbstrAgentID);

Obtains ID of currently logged agent. Return values:
S_OK—if operation successful
E_ACCESSDENIED—if ACL is not logged in
E_FAIL—if ACL is not connected to the server (no IP connection of server not started)
   State (Read Only Property)

HRESULT AgentState([out, retval] ULONG* pulState);

Obtains state of currently logged agent. Return values:
S_OK—if operation successful
E_ACCESSDENIED—if ACL is not logged in
E_FAIL—if ACL is not connected to the server (no IP connection of server not started)
   Connected (Read Only Property)

HRESULT Connected([out, retval] VARIANT_BOOL* pbConnected);

Returns state of the TCP connection to the server. Return values:
S_OK—if operation successful
   LoggedIn (Read Only Property)

HRESULT LoggedIn([out, retval] VARIANT_BOOL* pbLogged);

Returns TRUE if agent is logged in. Return values:
S_OK—if operation successful
E_FAIL—if ACL is not connected to the server (no IP connection of server not started)
   IACLEventsQueueInit
   SetEventsQueue

HRESULT SetEventsQueue([in] IVxEventsQueue* piEventsQueue);

Client calls this method to pass pointer to the events queue object. Events queue object is implemented by client.

Client may pass NULL pointer to the ACL if it does not want to receive events anymore.

_IACLEvents

EventReceived

HRESULT EventReceived([in] IIVREvent* piEvent);

ACL send this event when anything happens. Event is accessible via standard VoxPoint IIVREvent interface.

The particular events and their parameters are described for each COM class below.

IACLConnector

This dual (Dispatch) interface is implemented by external application connector.

OnCreate

HRESULT OnCreate( );

ACL calls this method immediately after connector object is created. Connector may perform one-time initialization here.

ACL does not check return value of this method.

OnDestroy

HRESULT OnDestroy( );

ACL calls this method immediately before it releases connector object. Connector may perform one-time deinitialization here.

ACL does not check return value of this method.

NewInteraction

HRESULT NewInteraction([in] LONG lInteractionID);

ACL calls this method when new interaction arrives to the agent. Connector may then use all available

ACL COM objects to receive interaction data or any other available information.

ACL COM Classes

Agent Connection Classes

AgentACL—Asynchronous Events

AgentACL COM class implements following COM interfaces:
IACLAgent—primary agent interface
_IACLEvents—notification interface to be implemented by client (connection point)
   AgentACLSync—Synchronous Events

AgentACLSync COM class implements following COM interfaces:
IACLAgent—primary agent interface
IACLEventsQueueInit—events queue initialization interface
   Events
   ConnectionLost

This event is sent when TCP connection to the Agent Server is lost. Event has no parameters.

Connection Resumed

This event is sent when TCP connection to the Agent Server is resumed. Event has no parameters.

StateChanged

This event is sent when agent changes his state.

Event has following parameters:
NewState—integer value of the new agent state
   NewInteraction

This event is sent when agent receives new interaction.

Event has following parameters:
InteractionID—ID of the interaction
   Error

This event is sent when error occurred.

Event has following parameters:
Command—name of the failed request
Result—HRESULT of the error
Reason—textual description of the error
   ACLShutdown

This event is sent when agent runs Exit command from the tray menu.

Event has no parameters.

Data Connection Classes

DataACL—Asynchronous Events

DataACL COM class implements following COM interfaces:
IACLData—primary agent interface
_IACLEvents—notification interface to be implemented by client (connection point)
   DataACLSync—Synchronous Events

DataACLSync COM class implements following COM interfaces:
IACLData—primary agent interface
IACLEventsQueueInit—events queue initialization interface
   Events
   ConnectionLost

This event is sent when TCP connection to the Data Server is lost. Event has no parameters.

ConnectionResumed

This event is sent when TCP connection to the Data Server is resumed. Event has no parameters.

Data Retrieved

This event is sent when requested data found.

Event has following parameters:
Result—HRESULT of the result code
ResultStr—string representation of the result
InteractionID—ID of the interaction
Path—name of the attribute
Value—value of the attribute
   NewInteraction

This event is sent when agent receives new interaction.

Event has following parameters:
InteractionID—ID of the interaction
   Error

This event is sent when error occurred.

Event has following parameters:
Command—name of the failed request
Result—HRESULT of the error
Reason—textual description of the error
   ACLShutdown

This event is sent when agent runs Exit command from the tray menu.

Event has no parameters.

Queue Connection Classes

QueueACL—Asynchronous Events

QueueACL COM class implements following COM interfaces:
IACLQueue—primary agent interface
_IACLEvents—notification interface to be implemented by client (connection point)
   QueueACLSync—Synchronous Events

QueueACLSync COM class implements following COM interfaces:
IACLQueue—primary agent interface
IACLEventsQueueInit—events queue initialization interface
   Events
   Connection Lost

This event is sent when TCP connection to the Smart Queue is lost. Event has no parameters.

ConnectionResumed

This event is sent when TCP connection to the Smart Queue is resumed. Event has no parameters.

InteractionQueued

This event is sent when new interaction arrives in the queue.

Event has following parameters:
InteractionID—ID of the new interaction
   InteractionUnqueued

This event is sent when interaction departs from the queue.

Event has following parameters:
InteractionID—ID of the interaction
Reason—reason of departure. Maybe one of the following values:
   0—agent found for interaction
   1—no logged agent exist or last agent logged out
   2—no matching agents exist for the interaction
   3—interaction abandoned (called disconnected)
AgentID—optional, ID of the agent, who will process interaction. Present only if Reason is 0.
   NextInteraction

This event is sent for each interaction in response to the EnumAllInteractions request.

Event has following parameters:
InteractionID—ID of the interaction
   EndOfList

This event is sent after all interaction were sent in response to the EnumAllInteractions request.

Event has following parameters:
Count—number of sent interactions
   Error

This event is sent when error occurred.

Event has following parameters:
Command—name of the failed request
Result—HRESULT of the error
Reason—textual description of the error
   ACLShutdown

This event is sent when agent runs Exit command from the tray menu.

Event has no parameters.

TCP Protocols—Logical Definitions

Agent Console talks with each of three server components via TCP connection. Each server component runs its own protocol (set of requests, solicited responses and unsolicited events), which reflects this server functionality.

ACL—Agent Server

This protocol consists of the following messages:

Requests/Responses

RequestAgentState

Console sends this message to the Server to request current state of an agent.

Parameters:
AgentID—ID of the agent

This request generates one of the following responses:
ResponseAgentState—Agent Server sends this message to Console if console has specified correct AgentID.
ResponseError—this message is sent to the Console in case of invalid AgentID
   Unsolicited Events
   EventAgentStateChanged

This event is sent to the Console every time agent state changes.

Parameters:
AgentID—agent ID
State—new agent state
   ACL—Smart Queue

This protocol consists of the following messages:

Requests/Responses

RequestInteractionsList

Console sends this message to the Server to request a list of Interactions currently in the queue.

Parameters: none

This request generates following responses:
ResponseInteractionItem—Agent Server sends one such message for each queued interaction. This response carries InteractionID as parameter
ResponseEndOfList—this message is sent to the Console after all interactions reported. Response carries number of sent interactions as parameter,
   RequestPullInteraction

Console sends this message to the Server to have particular queued interaction distributed on himself.

Parameters:
InteractionID—interaction ID
AgentID—ID of the agent

This request may generate the following response:
ResponseError—this message is sent to the Console in case of invalid AgentID or Interaction ID
   Unsolicited Events
   EventInteractionQueued

Smart Queue sends this event to the Console every time new interaction arrives in the queue.

Parameters:
ID—new interaction ID
   EventInteractionUnqueued

Smart Queue sends this event to the Console every time interaction gets removed from the.

Parameters:
ID—new interaction ID
   ACL—Data Server

This protocol consists of the following messages:

Requests/Responses

RequestInteractionData

Console sends this message to the Server to request Interaction attributes.

Parameters:
ID—interaction ID
All other parameters are considered requested attribute names

This request generates following responses:
ResponseInteractionData—Data Server sends this message if requested interaction exists. The message has following attributes:
   ID—interaction ID
   All other attributes are KV-pairs, each represents requested interaction attribute
ResponseError—this message is sent to the Console if requested Interaction does not exist
   Unsolicited Events
   EventInteractionDataChanged

Data Server sends this event to the Console every time new interaction data changes.

Parameters:
ID—interaction ID
All other attributes are KV-pairs, each represents changed interaction attribute. If value is empty—that means attribute was deleted.
   Personal Agent Queue

Each agent may handle multiple calls, thus each agent can have their own personal queue of calls. This section outlines Agent Personal Queue feature for the Call Center.

There might be situations, when Call Center interaction must be handles by some specific agent, instead of being routed to any agent. Some possible cases of such behavior may include:
Caller has identified his personal agent via IVR
Contact Center supervisor specifically assigned existing interaction to the agent
Interaction was routed to any agent, then this agent decided that interaction must be handled by other agent, but that other agent is not available at the moment. In this case first agent will park interaction—place is back to the queue and assign it to the destination agent
   Design
   “AssignedAgentID” Interaction Property

Such functionality maybe implemented by using special reserved interaction property. The name of that property is “AssignedAgentID”.

SmartQueue Interaction Handling

SmartQueue (queuing engine) handles such interaction differently.

When such interaction arrives in the queue, Smart Queue soed not try to match this interaction with all logged agents (as it does for all other interactions). Instead it will try to reserve assigned agent first. If that agent is not available (busy with other call or just not ready) the interaction will be kept in the queue until that agent becomes ready. Therefore, if assigned agent is Ready it will receive that interaction immediately.

When any agent becomes ready, Smart Queue performs matching procedure for all queued interactions.

When doing that it performs different actions depending on interaction assignment:
If interaction is not assigned to any agent—SmartQueue calls matcher
If interaction is assigned to the agent, who just became ready, SmartQueue uses interaction's normalized time in queue as matching weight.
If interaction is assigned to any other agent, SmartQueue considers matching weight 0.0 for such interaction

Such algorithm ensures that:
Interaction, assigned to specific agent will not be handled by any other agent
Each agent may handle both interactions which are assigned to him and all other interactions
Assigned interaction do not override other interactions, which have great match with that agent
If multiple interactions are assigned to specific agent, they will be handled in the order they arrived in the queue
   Personal Agent Queue—Dashboard

Each agent should be able to see all interactions, which are assigned to him, in the separate preconfigured node in the Queue Monitoring window.

This functionality will be implemented by Dashboard as built-in filter. The filter will match “AssignedAgentID” interaction property with ID of the currently logged agent.

Assigning Queued Interactions—Dashboard

When Call Center supervisor decides to assign currently queued interaction to some specific agent, he will select interaction in the Queue Monitoring window and click Assign button. Dashboard will present the list of currently logged agents to him, so supervisor can select desired agent and assign interaction.

When supervisor assigns interaction to an agent, dashboard sends “AssignInteraction” command to the SmartQueue via CCL interface, passing InteractionID and destination AgentID as parameters. Smart Queue will set “AssignedAgentID” property to that interaction, and then try to re-match that interaction.

The “AssignInteraction” packet is part of the SmartQueue IP protocol. It should be sent as UNITCP::Request packet, which carries binary encoded IPP::Request packet.

The packet should have following attributes:
Command=“AssignInteraction”
InteractionID—interaction ID
AgentID—ID of the agent

This request may generate the following response:
ResponseError—this response is sent in case of invalid AgentID or Interaction ID

To simplify that action, the AssignInteraction( ) method is added to the IVxConnection COM interface: HRESULT AssignInteraction([in] LONG lInteractionID);

This method wraps handling of the UniTCP packet.

Parking Interaction—Dashboard

When agent decides to park interaction to another agent (who is busy at the moment) he may press “Park” button on the dashboard. Dashboard should present a list of currently logged agents. The agent must select destination agent from that list.

After that, dashboard will issue “ParkInteraction” command to the Application Server (Application Context) via CCL interface, passing InteractionID and destination AgentID as parameters. CCA will set “AssignedAgentID” property to that interaction, and then place this interaction into the queue.

The “ParkInteraction” packet is part of the ApplicationPart IP protocol. It should be sent as UNITCP::Request packet, which carries binary encoded IPP::Request packet.

The packet should have following attributes:
Type=“UserEvent”
Action=“ParkInteraction”
AgentID—ID of the destination agent
   Agent's Personal Queue

Agent's Queue Monitoring Console has specific node named “Personal Queue”, which displays interactions, assigned to this agent. This node always exists.

Agent may pull interaction from his personal queue explicitly.

Assigning an Interaction to an Agent

The Call Center Manager has a possibility to assign any interaction, which is currently in common Call Center queue to some specific agent. After this action the interaction is placed in agent's Personal Queue for further distribution to this agent.

Call Center Manager uses GUI application, which displays al queued interactions:
Interactions in general queue (not assigned to any specific agents)
Personal queue of every logged agent

This GUI application allows manager to select any interaction in the general queue and assign thisinteraction to the specific logged agent (selected from currently logged agents list).

Note, that when interaction is already distributed to an agent (therefore it is removed from the queue) it cannot be assigned to any other specific agent (unless it is parked to that agent—lee below).

Parking an Interaction

The Call Center agent may park active interaction (the interaction he is currently working with) to the other agent's personal queue. That maybe done:
By pressing specific button on the Soft Phone (Park to agent)
When blind transfer is in progress (first agent does not control a call anymore) and destination isnot available, the system may ask customer if he/she wants to be parked to the agent. In this case call is placed in the destination agent's personal queue and will be delivered to that agent later
   Design
   Assigning Queued Interaction to the Agent

The manager's console is connected to the SmartQueue server via TCP interface. When manager decides to assign interaction to an agent, console sends “AssignInteraction” request via TCP connection.

The following actions are performed by the Smart Queue:
The target agent's login state is checked. If agent is not logged, the operation is considered failed. Smart Queue sends error message to the manager's console via TCP connection. The queued interaction does not get changed, so it will be routed using standard strategy.
If agent is logged in, Smart Queue sets AssignedTo attribute to the interaction and sends “OK” message via TCP connection to the manager's application. The assignment operation is considered successful.
If agent is ready, Smart Queue reserves the agent, then sends “TargetAvailable” event to the interaction's events queue

If requested agent is not available, the interaction is kept in the queue for further processing (when agent becomes available)

Interaction Parking

Interaction parking is performed by the Call Center Application in the following cases:
Customer selected particular agent while working in IVR application. In this case IVR attaches AssignedTo attribute to the interaction
Original agent initiated blind transfer to another agent and this agent is not available. In this case Call Center Application sets AssignedTo attribute of the interaction and places interaction back in the queue

In both these cases Call Center Application calls IVPSmartQueue::QueueInteractoin( ) method to place the call in the queue. In this method Smart Queue performs following actions:
Checks if requested agent is logged into the Contact Center. If agent is NOT logged, Smart Queue removes AssignedTo attribute and places “AssignmentChanged” event into the interaction's events queue to let CCA know that interaction was not placed in the agent's personal queue. After that, SmartQueue proceeds as usual (tries to match any agent with that interaction).
If requested agent is logged in, the Smart Queue tries to reserve the agent. If reservation was successful—the “TargetAvailable” event is sent to the interaction's events queue (to Call Center Application)
If requested agent is not available, the interaction is kept in the queue for further waiting
   Agent Becomes Ready

When any agent becomes Ready, Smart Queue performs the following:
Checks if there are any interactions, assigned to that agent (they have AssignedTo attribute set to the AgentID of this agent). If they exist, the oldest interaction (interaction with maximum time in queue) is distributed to this agent.
If there are no assigned interactions, the common routing continues—any other appropriate interaction is distributed to that agent
   Contact Center

The contact center is the overall server program that couples all of the features described.

Soft Phone

The telephony features include a ‘soft phone’ which is a PC based telephone program,.

### Integration with Other Systems

This section outlines the support of different telephony PBXes and switches by the Call Center.

How Call Center Interacts with a Switch

The interaction with switch includes following functions:
Answer
Hangup
Transfer

In order to receive telephony calls and control them, Call Center should interact to telephony switch (PBX). Call Center has two connections to the switch:
Signaling connection—the TCP-IP connection to the Genesys T-Server, which, in turn, is connected to the switch via CT1 link. The main goal of the signaling connection is to provide telephony signaling information, like events, coming from the switch to Call Center and commands, coming from Call Center to the switch. In addition, the signaling connection maintains a set of key-value pairs for each call (user data).
Line connection—T1 or E1 digital trunk, which is physically connected to Dialogic board (on the Call Center's side) and to the line side board in the switch. The line connection provides the voice path between the switch and Call Center. In addition, it may carry part of the signaling information in AB(CD) signaling bits, which are associated to each timeslot of the digital trunk.

Both of these connections are mandatory.

T-Server Signaling

T-Server is the main source of the signaling information for the Call Center.

The following events are utilized by Call Center:
EventRinging—notifies Call Center when new call arrives to the Call Center port
EventReleased—notifies Call Center when call is disconnected by remote user
EventAbandoned—notifies Call Center when call request is abandoned before it answered by Call Center
EventEstablished—notifies Call Center when outgoing call (or transfer) is answered by remote user
EventDestinationBusy—notifies Call Center that remote user is busy
EventAttachedDataChanged—notifies Call Center that data, attached to the call, has been changed
EventError—notifies Call Center when some error has occurred
EventServerConnected—notifies Call Center when connection to T-Server is established
EventServerDisconnected—notifies Call Center when connection to T-Server is terminated
EventLinkConnected—notifies Call Center when CTI Link connection is established
EventLinkDisconnected—notifies Call Center when CTI Link connection is terminated
EventRegistered—notifies Call Center when DN is registered with T-Server
EventUnregistered—notifies Call Center when DN is unregistered with T-Server

The following commands are utilized by Call Center:
TOpenServerEx—opens connection to T-Server
TCloseServer—closes connection to T-Server
TRegisterAddress—registers particular DN (Call Center port) with T-Server
TUnregisterAddress—unregisters particular DN (Call Center port) with T-Server
TAnswerCall—answers incoming call
TReleaseCall—initiates disconnect of the current call
TSingleStepTransfer—initiates single step transfer
TMuteTransfer—initiates mute transfer
TInitiateTransfer—initiates transfer
TCompleteTransfer—completes transfer
TupdateUserData—updates data, attached to the call
TsendEvent—send event to TServer

The actual set of supported events and commands depends on the particular switch and described in the next chapter.

Line Signaling

In addition to T-Server signaling, some switches require the presence of line signaling. The line signaling basically defines the state of the transmitted AB signaling bits for the hook state of the port. Call Center do not use received signaling bits state changes at this time.

Configuration Structure

The interaction of Call Center and switch is described in the Call Center CTI configuration XML file in TServers node. The TServers node should be somewhere inside root node. The node describes existing T-Servers. The group should be present in file—server will fail in other case.

Any number of T-Servers may be described inside the node. Each T-Server must be presented by corresponding Tserver node

Each Tserver node describes connection to single TServer and should have the following attributes.

Connection Parameters

ID—Number, T-Server identifier. Required and must be unique.
   TServer Signaling Parameters
Host—String, name of host where the T-Server runs. The attribute is required.
Port—Number, number of port on which the T-Server is listening. The attribute is required.
BackupHost—String, name of host where backup T-Server runs. The attribute is optional, but if presented, BackupPort attribute also required. Together the pair gives backup T-Server, which will be used in case if main T-Server is unreachable.
BackupPort—Number, number of port on which backup T-Server is listening. The attribute is optional, but if presented, BackupHost attribute also required. Together the pair gives backup T-Server, which will be used in case if main T-Server is unreachable.
AddpSupport—String, may be “true” or “false”. Optional attribute, default value is “false”. “True” means that addp protocol support should be used.
AddpTimeout—Number, “addp-timeout” attribute for addp protocol. Optional attribute, default is 30. Used only when AddpSupport is “true”.
AddpRemoteTimeout—Number, “addp-remote-timeout” attribute for addp protocol. Optional attribute, default is 30. Used only when AddpSupport is “true”.
AddpTrace—String, “addp-trace” attribute for addp protocol. May be “off”, “local”, “remote”, or “both”. Optional attribute, default is “off”. Used only when AddpSupport is “true”.
UseHookOnState—String, may be “true” or “false”. Optional, default is “true”. Actually the attribute is not used.
TAnswerSupport—String, may be “true” or “false”. The attribute says, should TAnswerCall method be called to answer call. Some switches just require OffHook operation for this. Optional, default is “true”.
TReleaseSupport—String, may be “true” or “false”. The attribute says, should TReleaseCall method be called to release call. Some switches just require OnHook operation for this. Optional, default is “true”.
WaitLineAnswer—String, may be “true” or “false”. The attribute says, should server wait for EventEstablished after answering call. Some switches do not send the event. Optional, default is “false”. Call Center will always wait for EventEstablished if TAnswerCall command issued (TAnswerSupport is true), so this parameter will be ignored, if TAnswerSupport is true.
TransferType—String, may be “single”, “two” or “mute”. The attribute says what type of transfer should be used. Optional, default is “two”.
   single—use TSingleStepTransfer command, then wait for EventReleased
   two—use TInitiateTransfer and TCompleteTransfer commands. The behavior depends on the values of DoCompleteTransfer and WaitInitiateTransferResult parameters.
   mute—use TMuteTransfer command, then wait for EventReleased.
WaitInitiateTransfer—String, may be “true” or “false”. The attribute says, should server wait for EventEstablished after TInitiateTransfer called while performs two step transfer. Some switches do not require it. Optional, default is “true”. This parameters is ignored in TransferType is not TwoStep.
DoCompleteTransfer—String, may be “true” or “false”. The attribute says, should server call TCompleteTransfer while performs two step transfer, or TInitiateTransfer will be enough. Optional, default is “false”. This parameters is ignored in TransferType is not TwoStep.

The following values should be user for some switches:

| | | | | Rockwell | | | |
|---|---|---|---|---|---|---|---|
| | | | Rockwell | Spectrum | Nortel | | |
| | Nortel | Alcatel | Spectrum | without | DMS- | Lucent | |
| Parameter | Meridian | 4400 | with agents | agents | 100 | G3 | Unknown |
| TAnswerSupport | FALSE | FALSE | FALSE | FALSE | FALSE | TRUE | TRUE |
| TReleaseSupport | TRUE | TRUE | TRUE | TRUE | FALSE | TRUE | TRUE |
| WaitLineAnswerResult | TRUE | TRUE | FALSE | FALSE | TRUE | TRUE | TRUE |
| TransferType | Two step | Two step | Two step | Two step | Mute | Mute | Two step |
| DoCompleteTransfer | TRUE | TRUE | FALSE | FALSE | TRUE | TRUE | TRUE |
| WaitInitiateTransferResult | TRUE | TRUE | TRUE | TRUE | FALSE | TRUE | TRUE |

Line Signaling Parameters

The Line Signaling parameters describe the signaling bits positions for OnHook and OffHook states.
OnHookBits—Number, bit mask used to OnHook operation for DTI device. Optional, default is 0x0002 (A off, B on).
OffHookBits—Number, bit mask used to OffHook operation for DTI device. Optional, default is 0x0003 (A on, B on.

The bits state is coded as long value. Each bit of the long value carries the value of one T1 (E1) signaling bit. The bit 0 (least significant bit) corresponds to signaling bit A, the bit 1—to signaling bit B, bit 2—to signaling bit C and bit 3—to signaling bit D. Bits C and D will be ignored for T1 trunks.

Call Control Functions

Answer

This function answers incoming call. The following steps may exist in this function, depending on the switch type:
Send TAnswerCall request. Only if TAnswerSupport parameter is true.
Change line signaling bits to OffHook state. This step will be executed always.
Wait for EventEstablished. This step will be executed if TAnswerSupport parameter is false and WaitLineAnswerResult parameter is false.
   Hangup

This function disconnects the call. The following steps may exist in this function, depending on the switch type:
Send TReleaseCall request. Only if TReleaseSupport parameter is true.
Change line signaling bits to OnHook state. This step will be executed always.
Wait for EventReleased. This step will be executed always.
   Transfer

This function transfers current call to another address. There are three flavors of the transfer. The particular type will be selected based on the switch type.

One Step
Send TsingleStepTransfer request
Wait for EventReleased.

Two Step
Send TInitiateTransfer request. This step always exists.
Wait for EventEstablished. This step exists only if WaitInitiateTransferResult parameter is true.
Send TcompleteTransfer request. This step exists only if DoCompleteTransfer parameter is true.
Wait for EventReleased. This step exists only if DoCompleteTransfer parameter is true.

Mute
Send TMuteTransfer request
Wait for EventReleased.
   Switches
   Nortel Meridian

No agent login information is necessary.

Supported DN Types

Analog (lineside T1/E1 physical interface)???
   Answer
Change line signaling bits to OffHook state.
Wait for EventEstablished.
   Hangup
Send TReleaseCall request.
Change line signaling bits to OnHook state.
Wait for EventReleased.
   Transfer
Send TInitiateTransfer request.
Wait for EventEstablished.
Send TCompleteTransfer request.
Wait for EventReleased.
   Alcatel 4400

No agent login information is necessary.

Supported DN Types

Analog (lineside T1/E1 physical interface)
   Answer
Change line signaling bits to OffHook state.
Wait for EventEstablished.
   Hangup
Send TReleaseCall request.
Change line signaling bits to OnHook state.
Wait for EventReleased.
   Transfer
Send TInitiateTransfer request.
Wait for EventEstablished.
Send TCompleteTransfer request.
Wait for EventReleased.
   Nortel DMS

No agent login information is necessary.

Supported DN Types

Answer

Change line signaling bits to OffHook state.
Wait for EventEstablished.
   Hangup
Change line signaling bits to OnHook state.
Wait for EventReleased.
   Transfer
Send TMuteTransfer request
Wait for EventReleased.
   Rockwell Spectrum

The behavior of the Rockwell Spectrum switch is very different from other supported switches (like Meridian).

Routing

Rockwell Spectrum switch provides three types of resource that are used for routing calls to Call Center applications. Those resources are:
Routing Point (RP)—resource that receives telephony calls. Each RP has an access number. Calls placed onto routing points by dialing their access numbers. Each RP has a script that fully defines RP's behavior. Among other things, scripts declare types of routing that are allowed on an RP. On a very basic level there are two types of routing, based on routing destination type: routing to LWN and routing to Agent ID (described later);
Logical Workstation Number (LWN)—resource that provides telephony functions for different endpoint devices. LWN can be associated with an agent station or with a logical channel in a telephone trunk. Call Center uses the second type of LWNs;
Agent ID—a number, associated with an agent. Agent can perform login operations on different LWNs. After a successful login, calls can be distributed to the agent by dialing his Agent ID (that's why Agent ID can also be called an Access Number).

There is no “preferred” or “most common” configuration for routing points. Any point can be configured in any way, based on the required routing model.

Agent ID can be permanently associated with LWN. In case of such permanent association LWN does not require separate agent login and it is always ready to accept calls (unless, of course, it already processes a call.) This kind of association is made on the switch and cannot be changed nor detected by any Genesys product. In case of such association Agent ID serves as an access number for the LWN and call can be placed on LWN by dialing Agent ID. For such kind of routing, Call Center implements ‘Spectrum signaling without agents’.

If RP script allows routing onto agents, the separate ‘Spectrum with agents’ signaling type should be used for Call Center. There is one major problem with such routing: calls routed to agent instead of DNs (called LWNsr), while T-Server events still carry LWN numbers in their ThisDN field. Before routing can be performed, agent must perform login on an LWN. In case of automated call processing there are no agents who could log in on LWNs. Fortunately, Rockwell thought about this and there is possibility to “attach” agents to LWNs so there is no need for logging in. LWNs with attached agents are always ready to accept calls.

Successful routing is possible when two conditions are met:
StatServer knows that there is an agent, logged in on an LWN;
T-Server receives from Router agent ID instead of LWN.

Switch does not tell StatServer about agent logins on LWNs that have associated agent IDs, so appropriate T-Server events (EventAgentLogin and EventAgentReady) must be distributed before routing will take place.

Router can replace LWNs with agent IDs. Special “translation” block can be added into strategy for modifying information before sending it to T-Server. Basically that block receives a data structure that represents routing request that Router will send to T-Server to route call to it's destination. Translation block will tell Router that value of the field “OtherDN” in routing request must be replaced with an agent identifier (another field of the same structure).

In order to successfully route call from an RP to an agent, T-Server must know the type of call destination.

Unfortunately, all information about destination is transmitted in one string member of event structure, declared by T-Library (T-Server API). This works perfectly on switches that can recognize resource type by resource identifier. Unfortunately, Rockwell Spectrum is not one of those switches.

To resolve this situation T-Server uses prefixes. Prefixes declared in T-Server configuration (either in a configuration file or in configuration database). There are two main types of prefix: LWN prefix and Target Party Number prefix. If DN in request begins with LWN prefix, T-Server cuts out the prefix and treats DN as LWN. If DN begins with Target Party Number prefix, T-Server cuts out the prefix and treats DN as “Target Party Number” which means “access number” or “Agent ID” depending on the resource type.

Supported DN Types

VRU (Voice Response Unit).
ACD Position
Extension
   Answer
Change line signaling bits to OffHook state.
   Hangup
Change line signaling bits to OnHook state.
Wait for EventReleased.
   Transfer
Send TInitiateTransfer request.
Wait for EventReleased.
   Lucent G3

No agent login information is necessary.

Supported DN Types

Analog (lineside T1/E1 physical interface)
   Answer
Send TAnswerCall request.
Change line signaling bits to OffHook state.
Wait for EventEstablished.
   Hangup
Send TReleaseCall request.
Change line signaling bits to OnHook state.
Wait for EventReleased.
   Transfer
Send TMuteTransfer request.
Wait for EventHeld.
Wait for EventDialing on the second leg.
Wait for EventReleased or EventAbandoned.

### Outbound Caller

Introduction

Outbound Caller is a lightweight (Win32 console) application that dials outbound calls based on information stored in a database. For each successfully dialed call a specialized Call Center application is executed. Application provides customizable logic of handling of an outbound call.

Command Line Syntax

outblite udl=“<OLE DB connection string>”[scn=<number of calls>]app=“<application ProgID>”

OLE DB connection string—string used to connect to the database. Syntax and content of connection strings vary for different OLE DB providers. The common most way of obtaining a connection string for a specific data source is using of DataLink manager application. To invoke DataLink manager one must create an empty text file in any directory for which one is granted read/write access (Windows desktop is a good example of such directory) and assign “.udl” extension to the created file. Once the extension is assigned, one must double-click on the file to invoke DataLink manager, which is quite intuitive and self-explanatory application. After data source was configured, a string, describing it before OLE DB will be stored in the created file. To access the produced connection string one can open the file with Windows Notepad.

Number of calls—number of calls that can be dialed simultaneously. If this parameter is omitted, application will dial one call at a time. It is important that the number of calls will not exceed number of telephony resources available for making outbound calls. Application won't check Call Center configuration, but just create requested number of outbound call processors and start all of them. In result, a lot of meaningless error messages will be produced.

Application ProgID—COM program ID of an application that will handle outbound calls. The application must be an outbound-aware Call Center application. Awareness comes from analysis of contents of the properties part of the application context object, given to the application by the Outbound Caller. Application obtains collection of properties from “CallProperties” property of the application context object. Outbound Caller appends its properties to the properties object as a standard Call Center parameters collection under the name “OutboundParameters”.

The following diagram displays hierarchy of outbound call properties:

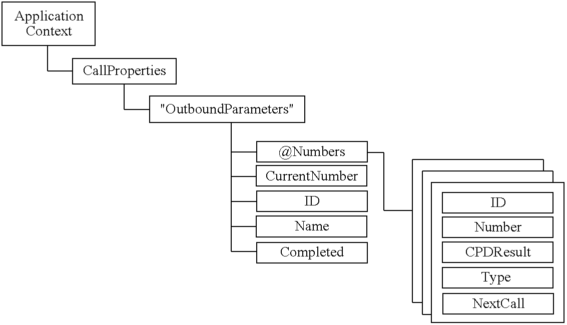

“OutboundParameters” node represents the current target object (see database description). It consists of the following properties:

| Name | Type | Description |
|---|---|---|
| @Numbers | VT_DISPATCH | Collection of telephone numbers (see description below). |
| ID | VT_I4 | Database identifier of the target. |
| Name | VT_BSTR | Name of the target in the database. |
| Completed | VT_BOOL | TRUE if target is completed in which case no more calls to this |
| | | target will be dialed. This property can be changed by outbound |
| | | applications. Target will be called until something or someone sets |
| | | value of this property to TRUE. |
| CurrentNumber | VT_BSTR | Telephone number that is being dialed. More information about the |
| | | number can be obtained from “@Numbers” collection. |

In addition to the above-mentioned properties, custom target properties from the database also appear in the target record. Values of those custom properties can be changed by outbound applications. All changes will be saved in the database after application exits.

Node “@Numbers” contains a collection of telephone numbers attached to the target. The following table describes contents of the number object (which is a standard Call Center parameters collection):

| Name | Type | Description |
|---|---|---|
| ID | VT_I4 | Database identifier of the number |
| Number | VT_BSTR | Telephone number that must be dialed. |
| Type | VT_I4 | Application-specific type of the number. Can be NULL. |
| CPDResult | VT_I4 | Result of dialing (call analyzer result). Result codes can be found in Call |
| | | Center documentation. |
| NextCall | VT_DATE | Time of next call to this number in local time zone. The number will not be |
| | | called until the specified time. Applications can change value of this |
| | | property to schedule calls at specific time. |

Running Outbound Caller

When application starts it opens connection to the specified database and initializes requested number of call processors. Once all call processors were initialized, application reads the database and collects targets that can be called at that moment. If no targets were collected, application quits. If there are targets that must be called in the database, but none of them can be called at the moment of reading of the database, application determines the nearest time available for calling and waits until then.

All collected targets queued to call processors. Each call processor cyclically obtains a target from queue and dials all collected numbers. Processor dials numbers and, if call is connected, invokes the specified Call Center application. Application processes voice part of the call. After call is processed, application can mark target as “completed” in which case no more calls to that target will be made.

When all queued targets were processed, application reads the database again and described above procedure is repeated.

Outbound Caller can be terminated at any moment by pressing Ctrl+C or Ctrl+Break. Once one of the combinations pressed, application displays a message, telling that request for termination was accepted (the exact text of the message may vary for different localized versions of the application) and starts termination process. It is important to wait until application terminates properly, which may take several minutes if calls are being processed at the moment of interruption. After termination request was accepted, no new calls will be dialed, but current processing won't stop.

Database

Outbound database represents one outbound campaign and consists of two tables: “targets” and “numbers”. Table “targets” lists all campaign targets (customers that must be reached on the telephone). Table “numbers” lists all telephone numbers and links the numbers to targets.

The following diagram displays database schema used by Outbound Caller:

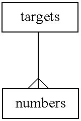

Outbound Caller uses lowercase letters for all database objects (tables and columns). This is not important on case-insensitive databases like SQL Server, Oracle or Access, but the application will not work properly with case-sensitive databases like Sybase when database objects below named use uppercase letters.

Microsoft JET 4 is preferred database engine of Outbound Caller. Sample JET database file is shipped with the application. In case poor database performance slows down outbound calling, database can be virtually effortlessly upgraded to MSDE or Microsoft SQL Server that share fundamental data types with JET.

Targets

This table must contain the following columns:

| Name | Type | Description |
|---|---|---|
| Id | Must be compatible with OLE DB | Unique identifier of a target. This column must be |
| | data type DBTYPE_I4 - 32-bit | the primary key of the table. |
| | integer number. | |
| name | Must be compatible with OLE DB | Name of a target. Value of this column cannot be |
| | data type DBTYPE_WSTR or | NULL because it is used in diagnostic messages. |
| | DBTYPE_STR. Maximum length of | |
| | Unicode representation of this | |
| | column must not exceed 64 | |
| | characters. | |
| Completed | Must be compatible with OLE DB | Completion status of a target. Outbound Caller will |
| | data type VT_BOOL or at least must | call targets until all of them are marked as |
| | be convertible to Boolean type. | completed. Value of this column cannot be NULL. |

Any number of additional (custom) columns can be added to the table. Values of additional columns must be compatible with the following OLE DB data types: DBTYPE_WSTR, DBTYPE_STR, DBTYPE_I4, DBTYPE_R8, DBTYPE_FILETIME and DBTYPE_BOOL.

Value of each custom column will be added to the target object in application context. Outbound applications can read and modify values of custom columns through the target object as mentioned above.

Numbers

This table must consist of the following mandatory columns:

| Name | Type | Description |
|---|---|---|
| Id | Must be compatible with OLE | Unique identifier of a number. This column must |
| | DB data type DBTYPE_I4. | be the primary key of the table. |
| ref_target_id | Must be compatible with OLE | Reference to a target to which the number belongs. |
| | DB data type VT_I4. | |
| phone_number | Must be compatible with OLE | Number that will be dialed. Numbers must include |
| | DB data type DBTYPE_WSTR | all prefixes or suffixes required by telephony |
| | or DBTYPE_STR. Maximum | configuration. Outbound Caller will ask Call |
| | length of Unicode | Center to dial numbers exactly as they are stored in |
| | representation of this column | the database. |
| | must not exceed 32 characters. | |
| cpd_result | Must be compatible with OLE | Outbound Caller stores latest result of dialing of |
| | DB data type VT_I4. | the number in this column. NULL value means |
| | | that number was not yet dialed. |
| number_type | Must be compatible with OLE | Outbound Caller just passes value of this column |
| | DB data type VT_I4. | to applications. Applications can treat different |
| | | types of numbers differently. |
| next_call_time | Must be compatible with OLE | Time of next call to the number. |
| | DB data type VT_FILETIME | |

Outbound Applications

Outbound Caller is a premium add-on for Call Center; therefore, it shares application model with other Call Center applications. Just like regular Call Center applications, outbound applications are COM components. There are differences, though.

The main difference is that outbound applications don't answer to inbound calls, nor they dial outbound ones. All dialing is done by the Outbound Caller and applications get an application context object on which a call was already dialed and connected.

Another difference is mentioned above “OutboundParameters” object in call properties collection. This object is created for every call that Outbound Caller dials. Theoretically, an inbound/outbound application can be developed that checks if “OutboundParameters” node exists in call properties and act accordingly, but that would make the application unnecessarily complicated.

Sample Application

The script below (a part of Outbound Caller testing package) is a simple outbound application that has no practical meaning, but displays use of contents of “OutboundParameters” object.

```
function Run( appCtx )
{
  var target = appCtx.CallProperties.Item( “OutboundParameters”
);
  var numbers = target.Item( “@Numbers” );
  var currentNumber = numbers.Item( target.Item( “CurrentNumber”
) );
  var nextCall = currentNumber.Item( “NextCall” );
  var result = currentNumber.Item( “CPDResult” );
  // Execute some telephony functions on appCtx;
  var nReq = appCtx.PlayFile( appCtx.ConfigValue(“VoxPointDir”)
+
              “\\outbCaller\\samples\\otest_1.vox”,
              0, /* use default CRN, set by Outbound Caller */
              1 /* VFMT_ADPCM8000 */ );
  // Wait for context to finish playing prompt;
  for (;;)
  {
        var evt = appCtx.GetEvent( );
        if( evt.ReqID == nReq && evt == “PlayCompleted”
        || evt == “Disconnect”
        || evt == “Shutdown” )
              break;
  }
  // Update counter of calls made to the current target.
  // modified value will be stored in the database (column
“total_calls”
  // of table “targets”) after application (function “Run”)
will exit;
  target( “total_calls” ) += 1;
  // If target was called 5 times in total, mark it as
completed;
  if( target( “total_calls” ) >= 5 )
        target( “Completed” ) = true;
}
```

Notice that application is not only not answering a call; it also does not hang it up. After application exits, the call is hung up by Outbound Caller.

Accessing Telephone Numbers Collection

The following line assigns reference to the collection of telephone numbers, attached to the target to the variable “numbers”:

var numbers = target.Item( “@Numbers” );

The key of the collection is a telephone number (string); the value is a telephone number object (collection of properties). Application can enumerate through all keys by creating an enumerator object or by using language support for enumerators. The following example shows how to enumerate telephone numbers in JavaScript:

```
...
var numbers = target.Item( “@Numbers” );
var enum = new Enumerator( numbers )
// 1. Enumerating through the numbers using JavaScript
Enumerator object.
for( ; !enum.atEnd( ); enum.MoveNext( ) )
{
  var strNumber = enum.item( );
  var objNumber = numbers.Item( strNumber );
  // strNumber now contains a string that represents a
telephone number;
  // objNumber is a telephone number object;
  // underlined text (“.Item”) can be omitted;
  ...
}
...
// 2. Enumerating through the numbers using JavaScript
for...in statement.
// The for...in statement supported by Microsoft
JavaScript version 5
// or greater. JavaScript 5 shipped with Internet
Explorer 5.
// Windows 2000 shipped with JavaScript 5.1.
var strNumber;
for( strNumber in numbers )
{
  var objNumber = numbers( strNumber );
  ...
}
```

Property “CurrentNumber” of the target object contains a string that identifies the number that was dialed before running the application (current number).

The following statement stores reference to the current number object in the “currentNumber” variable:

var currentNumber =
numbers.Item( target.Item( “CurrentNumber”) );

Scheduling Calls

Outbound applications can tell Outbound Caller not to call certain numbers until specific time comes. Time of next call is stored in the “NextCall” item of the number object stored in “@Numbers” collection of the target object. The following JavaScript code obtains reference to the “NextCall” item of the current number:

```
function Run( appCtx )
{
  var target = appCtx.CallProperties.Item( “OutboundParameters”
);
  var numbers = target.Item( “@Numbers” );
  var currentNumber = numbers.Item( target.Item( “CurrentNumber”
) );
  var nextCall = currentNumber.Item( “NextCall” );
...
```

The “target” variable receives reference to the target object (it is important to remember that most variables in JavaScript keep references to objects). Then, target object is used to obtain the collection of target's telephone numbers and the current number object is obtained from the collections. When current number is obtained, it is used to obtain the reference to the property that stores the time of next call to the current number. The reference is stored in the “nextCall” variable.

Application can modify value of the obtained property to schedule next call to the current number. The following script fragment displays how to schedule call for 30 minutes into the future:

...
var timeNextCall = new Date( );
timeNextCall.setMinutes( timeNextCall.getMinutes( ) + 30 );
nextCall = timeNextCall.getVarDate( );
...

The first line creates a Date object that's initialized with current time (adjusted current time zone). Second line adds 30 minutes to the created object. JavaScript automatically adjusts hours, days, months and years if necessary.

Last line sets the “NextCall” property of the current number (reference to the property was obtained in the sample above). Notice that method getVarDate( ) used to convert JavaScript's internal representation of the date to OLE date.

Application can modify time of next call only for current number. Changes, made to values of the time of next call property of other number objects, will not be stored in the database and will be discarded; application can examine those values, though.

### Application Builder for IVR

About Application Builder

Call Center can use several scenarios for inbound calls, with the choice of scenario depending on the call number prefix or on other criteria. Call processing in these scenarios may include caller-agent interactions or be completely automatic. Scenarios may be integrated with back-end applications specific for the business.

Each scenario is implemented as an application. When the call rings into the Call Center, Application Selector selects the proper application for a call using declared criteria. Then the selected application controls the call till the moment it is hung up. In this document, this kind of application will be referred to as Call Scenario.

In short, typical call scenario does the following:
It answers the call
Plays voice or music prompts (if defined)
Get Call Data connected to the incoming call
Get information from the caller
Places the call into the queue
Connects the call to an agent.

Application Builder can be used for developing such full-functional applications. Application Builder provides a set of building blocks with adjustable parameters. Even non-programmers can use it to develop new applications.

This document contains all the information necessary to:
develop new call scenario
deploy new developed call scenarios to be used in Call Center.
   Developing First Simple Call Scenario

To demonstrate that developing call scenarios with Application Builder isn't difficult, let's create a new scenario, in which all callers will hear the synthesized voice massage: Hello, World!
1. To start Application Builder, click Start at the left corner of the computer desktop. Select:
   Programs→Call Center→Application Builder.
2. Application Builder is implemented as Web interface, and it will be opened in the Internet Explorer Window. For Application Builder the authorization is required:
   username
   password.
      Default values are “admin” and “password”.
3. Application Builder opens with the list of available applications. Figure AppList illustrates an example list of such applications.
4. Click the New command. It's located on the top of the list of available applications. Empty application opens as illustrated in Figure EmptyApp

The window of Application Builder is divided into two parts:
The empty application is on the left. The application menu is under the red line, on the top of empty application.
The set of building blocks is on the right.
5. To start a new application, select one of blocks. To make the shortest working application, select the PLAY block. Place the cursor over the block and click on the block to select it.

Now, the PLAY PROMPT block is to be configured. On the right panel illustrated in Figure PlayPrompt, double-click the hyperlink Prompt. The prompt file name is not defined yet.
6. Prompt Manager opens as illustrated in Figure PromptManager. The list of selected languages is empty and the list of selected prompts is empty too:

The menu at the bottom has three commands:
Add/Remove/Edit Prompts.

Click the Add command which will open the Prompt Manager.
7. Now, the Prompt Manager requires to add a language. At least one language should be added, or prompts won't be generated. Select English (United States) and press the Add button to the right. [image]
8. On the refreshed page, a table titled “Language in use” appears. It contains one line for English (United States) language and a check box against it (which can be used to select and to delete the language).

The list of prompts at the bottom is still empty. In the empty field for the filename, type in:

HelloWorld

—this will be the name of the first prompt in new application. Click the Add button.
9. Now, refreshed page contains the Table of prompts with the line for the HelloWorld file name. Click the hyperlink HelloWorld.

The next page contains the description field for the text of the prompt. In the field Description, type in:

[image]

The audio file, containing this text, will be generated by Text-to-Speech module. Click the Update button and then the Close button under the right corner of the Table.

[image]

Select HelloWorld prompt and click the Close button.
10. Refreshed page of the Prompt Manager displays the list of prompt files with the file HelloWorld accompanied by its description: “Hello, World!” [image]
11. Click the Close button on the top of the page.
12. On the right panel of Application Builder, on the list of available prompts, the prompt will have name HelloWorld and proper description. Click the Apply button.
13. Refreshed left panel will show the Play block icon with the file name of the prompt: Play HelloWorld
14. Select the command Save. Type in the file name: Hello in the input field and press the Save button under the field.
15. Click the Log off command (to the right, under the red line of the Logo bar). The Internet Explorer will close the window.
   Registering New Call Scenario with Application Selector

The application or call scenario with the file name Hello should be registered through the Call Center Web Configuration.
1. Click Start at the left corner of the computer desktop. Select:
   Programs—Call Center—Configuration Web Interface
2. Welcome page of Configuration Web Interface opens. The menu at the top of the page under the Header blue bar contains commands:
   Call Center Server
   Telephony Server
   SIP Proxy Configuration
   Applications
   Users
   Host

Select Applications command from the Menu and click it.
3. Application Selector Page Opens. [image]
4. Click the Reload button. The list of applications will be refreshed, and will contain the newly created application. Click the Arrow browse button at the right of the application box. The drop-down list of available applications opens. Choose the name Hello from this list. The application's unique ID, generated by the Call Center will be displayed in the CLSID field.

Click the Add Application button.

The new page of Application Selector opens. The criteria how to use the application should be selected.

[image]

The radio button presents the options available:
Selected always
Disabled
Criteria Builder
Custom

Select Selected Always option. For other options see How Applications are selected. Click the Update button.

Click Application on the upper menu or on the left panel.
5. New call scenario is now included in the List of registered with Application Selector call scenarios, the criteria Selected Always is attached. Check the new application (to the left of the name) and click the Up button to move the application to the top of the list. The Application Selector looks through call scenarios starting from the top of the list: checks the condition, and if “true”, launches the call scenario, if “false”—continues along the list.
6. Click the Commit command on the right of the Header. Thus, the Configuration will be updated.
7. Close the Internet Explorer window.
   Testing the Application

Now, to see how the call scenario works, just dial into Call Center from another phone. Prompt:
Hello, world!
   should be heard.
   Application Builder Layout

Application Builder is designed as the Web interface, accessible in LAN. Application Builder can be launched from Front Range program group, doesn't matter the Call Center is started or not.

The access to Application Builder is protected by username and password. Default User name is—admin, password is—password.

Application Builder opens the main window with the list of available Applications. Each line of the list contains the name of application, the Open button and the Delete button with red cross sign. If there are open applications, they will be shown to the right of the window under the header Open Applications.

[image]

To open one of applications from the list, click on the Open button against the required application. The window will be divided vertically in two parts. On the left side of the window the chart flow of the Application will be presented, on the right side the specifications of the first block or the block under cursor will be shown.

To remove an application from the list of available applications, click the Delete button (with red cross sign) against the application (see FIG. 2.)

To create a new application, click the New command from the Menu. The left side of thewindow will contain the empty new application, while the right side—the list of building blocks.

Menu

Menu of the Application Builder is available when the existing application is open for editing or a new application is created. The menu is located on the top of the page, under the red line.

[image]

Menu contains the following commands:
Applications—returns to the main window and opens the list of available applications
Save—saves the edited application
Save As—saves the edited application under another name
Revert—reverts the application to the previously saved version (state)
Prompt Manager—allows adding languages to the list of languages in use and adding required prompts from the list of prompts available in this language.
Log off—logs off Application Builder.
   Editing Mode

The editing mode is available when the existing Application is opened for editing or when the new empty application is being developed (at least one block added).

On the top of the left side of the Application Builder Main window, on the grey bar, there is the New command. Clicking the New command opens a new empty application in the left part of the window and the list of building blocks in the right part of the window. When one of building blocks is selected (by clicking it), the Edit menu appears on the right side of the grey bar (see FIG. 3).

To set the editing mode for the existing application, open the application by clicking the Open button against the Application on the list of available applications or click a hyperlink with the name of the application on the list of opened applications.

Edit Menu

Edit menu is available in the editing mode, on the top of the right part of the Application Builder window (FIG. 3).

The menu contains the following commands:
Add—inserts the selected block after block properties have been defined
Remove—removes the selected block from the Application contents
Cut—removes the selected block from the Application contents and places it to a Clipboard.
Copy—copies the selected block to a clipboard
Paste—inserts the clipboard contents to the selected location
Clipboard—contains the selection that was copied by the last COPY or CUT operation.
   Building Blocks

To make the developing of new call scenarios easy even for non-programmers, Application Builder contains building blocks. Each block has predefined functionality, but it is configurable to some extent. All blocks contain parameters, some of parameter are mandatory. Blocks may contain conditions, other blocks. Some blocks have predefined conditional exits or branches. Most of blocks use voice fragments, prompts, to be played to the caller to indicate menu choices, invalid input and so on. Application Builder provides the following building blocks to create application:
IF block specification
ROUTE TO AGENT block specification
REQUEST SKILL block specification
MENU block specification
SET LANGUAGE block specification
GOTO block specification
PLAY block specification
CONNECt block specification
DATA BASE OPEN
DATA BASE ACCESS
SET PROPERTY
GET STRING
CUSTOM JAVASCRIPT Block
   Play

PLAY block unconditionally plays voice or music prompt. This block is most convenient for reporting errors or outcome of some operations. If some input is required from caller, it is more suitable to use MENU or GETSTRING blocks.

The prompt may be or may be not interrupted by the input from the caller. In some cases it is much friendlier to provide an opportunity to the caller to input at any time not only when the prompt has been played to its end.

Parameters:
Prompt—mandatory, File name and description of the prompt to be played
Interrupt prompt by DTMF—YES/NO radio button allows interrupting prompt by caller's input

Using PLAY Block

[image]

To create prompt to be played, use Prompt Manager (Application Builder menu) or click the Prompt hyperlink to be redirected to Prompt Manager.

Creating a prompt includes:
Attaching filename
Defining languages of prompt
Writing descriptions in defined languages.

Section Details contains Interrupt prompt by DTMF radio button. Choose YES to allow interrupting prompt with caller input.

Menu

MENU block provides voice menu functionality. First, menu block offers choices to a caller (Long Prompt), second, detects what key was pressed, if any; informs caller about invalid input (Invalid Prompt) or input timeout (Short Prompt), and repeats the cycle predefined times.

MENU block is configurable. Possible exits correspond to phone keys: 0-9, *, #.

MENU has a Label/Description (optional). And each exit may have a label too.

Conditional Exits
0-9, *, #—on telephone key press, optional. To add a branch for a key, check it. When key has been checked, the input field for comment text appears. If not checked, key has no meaning and is invalid.

MENU has a default exit: the following block will be executed, when input timeout or repetitions limit is reached

Prompts:
Long_Prompt—mandatory, file name of the prompt to be played first.
Short Prompt—mandatory, filename of the prompt to be played on input timeout and after Invalid_Prompt.
Invalid_Prompt—mandatory, file name of the prompt to be played if invalid key is pressed. Short_Prompt is played after this prompt.

Parameters:
Repetitions—mandatory, number of times timeout or invalid input is allowed
Input Timeout—mandatory, seconds. Defines how long to wait for input after Long Prompt to start playing Short Prompt again
Interruptible—mandatory, YES/NO. With YES selected, prompts can be interrupted with input., i.e. caller is allowed to input menu choices without listening to prompts.

Using MENU Block

[image]

[image]

In the input field at the top of the page, type in new menu name which will be used in Application flow-chart as this menu individual label.

To create prompts or to select already existed, use Prompt Manager.

To configure several conditional branches, check the phone keys to be used for branching and type in their labels to be used in flow-chart.

Press the Update button to

If

IF block provides conditional branching for Application. IF block allows to define the sequence of operation which will be executed on a certain condition or criteria.

Conditional Exits:

By default, contains one conditional exit for operations to be executed when the condition is “true”. When the condition was evaluated as “false”, no operations will be executed.

The number of conditional exits is configurable. Criteria for each exit may be based on Call Properties, VoIP properties, time conditions and so on. It can be created with the use of built-in logical forms.

The combined logical expression is formed automatically.

Using IF Block

To configure the IF block follow the step below.

Type in the individual name for the block in the Description input field.

[image]

Type of parameters includes a drop-down list of groups:
Call Property
User Property
Interaction Data
CTI property
VoIP Property
Time
Day Time

Each group of parameters has its own list of properties.

Call property group includes properties:
ANI
DNIS
Call Name
Call Time
Channel ID
Telephony Type

User Property parameters maybe used as a string or a number. Name should be typed in.

Interaction Data parameters are defined the same way as User Property Parameters.

[image]

CTI contains items:
Call Type
CoonnID
Other Queue
This DN
This Queue

VoIP property defines Codec to be used

Time

Day time

To create combined logical expression

The Add column button creates a new column or condition to be joined by logical AND

The Add Alternative button creates a new condition to be joined by logical OR

[image]

To define specific conditions, just click, and a dialog box with predefined for this group of parameters logical expressions (forms) will pop up.

For Call Properties, such as DNIS, ANI there will be forms:
No condition
Value
In range
Starts with
Ends with
Contains
<
>

For Time restrictions there will be forms:
No condition
Value
In range
<
>
   Goto

GOTO block can be used to change the sequence of operations. Usually is used in branches provided by IF or MENU blocks.

Parameters:

Destination block—mandatory, ID (description) of the block to continue execution with.

GOTO does not have default exits, i.e. blocks after GOTO have no meaning (unless one of them is pointed to by another GOTO).

Using GOTO Block

GOTO block properties page shows application flow chart with the selected block and allows selecting another one by clicking it. After the destination block has been selected, the refreshed page will show the flow chart with GOTO block commented as “Goto:”+description/label/of the selected block.

If block, which GOTO points to, is deleted or cut out, GOTO will be painted red until it is pointed to another existing block, or original block has been pasted somewhere in the document.

Set Prompt Language

SET PROMPT LANGUAGE block allows switching prompt sets by language for a conditional branch.

Parameters:

Language—mandatory, ID of the Language to be used in Prompts.

Using SET LANGUAGE Block

[image]

The page shows drop-down list of available languages (registered for the application) and the Apply button. When no languages were defined so far in the application, the list of languages will contain English (United States) as the default language.

On Apply, the SET PROMPT LANGUAGE block will be displayed in application flow-chart commented as “Set Prompt Language to <language name>”

Open Data Base

OPEN DATABASE block defines the name of database to be opened for query.

Parameters:
Data Base Name—mandatory, ID (description) of the Data base to be opened.
Connection name for Application Builder
Connection string

Using OPEN DATABASE Block

[image]

[image]

How to create connection string—see build 51 admin guide

Data Base Access

DATABASE ACCESS block provides an opportunity to set database query and retrieve caller-connected information from database.

Conditional Exits:
No data
Default exit—data has been retrieved.

Parameters:

Data Base Name—mandatory, ID (description) of the Data base which has been opened by OPEN DATABASE block.

SQL Statement—may contain references to interaction properties by inserting their names quoted by % symbol: select aa from bb where cc=‘%ANI%’ or use any other %propertyname% as the value to be validated.

Using DATABASE ACCESS Block

If no Database has been open so far, a warning is displayed:

Add a DB Open Block in the Beginning of the Application.

[image]

If databases were opened higher in flow chart, DB ACCESS block properties page shows a drop-down list of available in this Application opened databases.

If appropriate DB OPEN block is deleted or cut out or not defined, DB ACCESS block will be painted red.

Set Property

Set Property block allows setting values for interaction properties which can be used in back-end applications. The set of properties is not pre-defined. Which properties to use, is defined by the specifics of back-end application and call processing scenario. A property can have a piece of JavaScript code as a value, for example, to set a numeric value without it being quoted as a string. The code will be interpreted by the Interpreter when the application is selected for the call.

Parameters:
Set Interaction Property Name—mandatory, ID for Property
Set Interaction Property Value—mandatory, text string

There is a radio button to mark the Property Value as Text or JavaScript.

Request Skill

Set one of agent skill requirements to be used in Routing Rules. A list of skill groups and their skill items are displayed as several drop-down lists. The lists use the current Agents-Skills scheme defined at Configuration Web Interface as a source of information (HostConfiguration.xml file).

Reflects currently saved selection.

Parameters:
SkillGroup—mandatory, name of skill group.
SkillItem—mandatory, name of one of the skills from specified skill group

Using REQUEST SKILL Block

[image]

[image]

On Apply, inserts the block into chart and updates block's comment to selected value: “Request Skill<group>=<item>”.

Get String

GET STRING may be used to get data from the caller as a string in DTMF format. Provides the name of the variable to store the input string in.

Also such parameters as string length, maximum time to wait for input, and others, can be set. GET STRING block provides an opportunity to validate the caller input data by comparing to the data in database.

Conditional Exits:
No Input
Invalid Input

Prompts:
Main Prompt—file name of the Prompt to be played to invoke the input
Timeout Prompt—file name of the prompt to be played on input timeout
Invalid Input Prompt (when validation is on)—file name of the prompt to be played when input data doesn't match to appropriate DB entry

Parameters:
Interaction Property to Store Result in (Name)—mandatory
Max Number of Digits—optional, if empty, considered as infinite.
Finish Input Digit—optional, input to be considered as the marker of input end, as a rule—# key, empty=off
Clear Input Digit—optional, marks the last digit as absent (empty=off)
Timeout Before First Digit is Dialed—mandatory, (sec)
Timeout Between Digits (sec)—mandatory, (sec)

Validation
DB Connection Name (must be defined in OPEN DB block) implemented as adrop-down list of open databases. If no database is open, validation is disabled.
SQL Statement (must return non-empty record set, use %propertyname% as the value to be validated)
Retries—optional, number of times to repeat the block. If empty, block won't be repeated.

Using GET DTMF STRING Block

[image]

Route to Agent

ROUTE TO AGENT block places the interaction into the queue. Upon normal exit (agent found) this block sets interaction property Destination to agent's phone number. Use CONNECT block immediately after ROUTE TO AGENT to connect call to target agent.

Conditional Exits:
No Logged Agents
No Matching Agents
Escape Digit Entered
Max Wait time exceeded
Service Queue Limit Exceeded

The default exit is Agent Found.

Prompts:
Music Prompt—mandatory, ID of the prompt to be played when the call is placed in queue
Reminder Prompt,—optional, ID of the prompt to be played every %reminder Frequency% minutes. If absent, reminder is not played.
Estimated Waiting Time Prompt—optional, if present, plays prompt and EWT in the beginning of waiting

Parameters:
Reminder Frequency,—minutes; if 0, disabled
Maximum queue waiting time, minutes; if 0, disabled
Escape digit (0-9, * #)—a key may be selected to be used by caller to quit waiting and leave voicemail. If no key is defined, there is no escape.

Intervals

There is also the Intervals section on the page. New escalation intervals can be defined with all required parameters

Using Route to Agent Block

[image]

To set a new escalation interval, click on the New Interval button. This opens a Table for configuring new escalation interval and a dialog box to configure corresponding parameters:
Default Skill
Skill threshold
Importance

[image]

[image]

The changes will take place as Full Routing Rules configuration, at Configuration Web Interface

For details of configuring routing procedures (see Call Routing Rules)

Connect Call

CONNECT CALL Block provides possible conditional exits in case of connecting arrived call to an agent.

Block connects call to destination specified by interaction property “Destination”. This property is set by ROUTE TO AGENT block or by another CONNECT block when transfer is completed (it is set to transfer target's number then). If destination is an agent, agent is attempted to be set busy.

Conditional Exits:
No Answer
Busy
Target disconnected
Transfer—

Sets Destination interaction property to “transferred to” number. Application may choose to use different phone numbers for commands to send call to location within application, like some specific menu. The most simple case of using this exit is to have a GOTO to the beginning of this block.

Prompts:

Hold Music Prompt—optional, ID of the prompt to be played while the call is on hold.

Parameters:
Description/Label—optional, label of the block
Default Destination—mandatory, destination phone number, used in case if Destination interaction property is empty
Override Destination—optional, if call was transferred No, this is similar to default dest, it just ignores Destination interaction property
PBX Prefix—optional
No Answer Timeout—mandatory, seconds. Defines the time to wait for agent to answer.
Bridge RTP—mandatory, YES/NO radio button.

Using Connect Call Block

The Apply button inserts CONNECT CALL block with defined properties.

[image]

Custom JavaScript Code

Custom JavaScript Code Block inserts a fragment of programmer-defined JavaScript code into the Application flow-chart.

This block provides Description label and an input box for JavaScript fragment. Validation of the code is on programmer.

Prompts

Some building blocks contain music and voice prompts. FRCC platform allows playing prompts in every language possible, as they are audio data. An application itself must take care of managing and switching prompt sets by language so that some prompts can be played in other languages than the others. Applications developed in Application Builder have multilingual prompt management built-in.

All languages to be used in application must be first declared in application with the help of Prompt Manager. All prompts also have to be declared before they can be referenced in blocks. * [symbol] ?)

The prompts are placed in the subfolder PROMPTS of the folder with the name ofapplication.

C:\Program Files\Call Center\Applications\ApplicationName\Prompts\

For each supported language there should be separate subfolder, named as Windows Language ID in decimal form. For example, for US English prompts the full folder name will be:

C:\Program Files\Call Center\Applications\ApplicationName\Prompts\1033

Note, that currently only US English is supported.

VoIP calls may utilize one of three voice formats:
G.711 u-law 8000 Hz
G.711 a-law 8000 Hz
G.729 8000 Hz

Therefore, each prompt should exist as three separate voice files, one for each voice format (encoding).

All prompt files, which are in the same voice format, must be located in the separate subfolder, which therefore contains versions of all prompts for one application.

[image]

When a new file is placed into one encoding's directory, it is re-encoded and replicated to all other encodings. If the description of the prompt was changed, the prompt will be regenerated.

Prompts should be present in all codec formats for reliable application execution.

For several languages (the number of which to be extended), voice prompts can be generated by TTS according to the description texts in languages declared for the Application. Each prompt is generated in all available codec formats.

Recorded Prompts

Voice recorded prompts may replace generated prompts or may be used from the beginning.

To introduce them into application

To protect them from regeneration . . . —latest date

Prompt Manager

This Section explains how to create new and edit existing prompts for languages supported by TTS and how to introduce recorded voice prompts into Application.

Prompt Manager may be called from the Application Builder menu.

[image]

To add languages to be used in Call scenario, from the drop-down list of Languages, select one and click the Add Language button. New prompts may be defined right here in the input field: type in new file name and click the Add button. Here is the Prompt Manager page after two languages were defined and two prompts were reserved.

[image]

A prompt may be removed by clicking the Delete button.

[image]

To add descriptions to prompt, click the hyperlink with the prompt name. The table appears which contain all prompts parameters: file name in the header, input fields for descriptions in each language defined.

Use grammatically correct words. Make the sentences shorter and do not forget periods at the end of sentences.

The Update button refreshes the list of prompts for application. Check box “Not Used” lets to skip the generation of selected (checked) prompt.

Using Multiple Languages in Call Scenario

There may be situations when it's necessary to use several languages in call scenario, for example, if callers are supposed to be speakers of different languages and are supposed to request the interaction being held in specific language.

Developing this kind of call scenario, use the Prompt Manager to define several languages and then provide each prompt with descriptions in all defined languages. By default, any new prompt will have the same number of description fields as the number of languages defined in Application.

Then, call scenario must have a MENU which will offer a language choice. Menu branches should contain SET LANGUAGE blocks, switching prompts by language in the branch (actually it changes the folder name to take prompts from, so that appropriate language version of prompts will be chosen for playing).

Recorded Prompts

In case when only recorded prompts will be used (not TTS generated), it is necessary to manually place sets of voice prompts in Application folder, subfolders named as the Language code.

Developing New Call Scenario

This Chapter contains information necessary to develop call scenario. How to configure call routing by defining new agent skills and routing rules.

Call Routing Rules

Front Range Call Center has a flexible routing engine that:
Optimally distributes work load between agents in Call Center
Selects best specialized available agent for each interaction

Call routing strategies (agent/call matchers) are fully configurable and can be specified on per-call, per application or per-system basis, the strategies are implemented as matchers. Generic skill-based matcher (as default matcher) is supplied with FRCC. One of the most used call distribution strategies in Call Centers is skills based strategy. Each Call Center agent has one or more skills, which are rated as numbers from 0 to 100. From the other side, each interaction requires different skills. A caller may select skills while responding to menus in call scenario, for example, “For English, press one, para Espanol oprimo numero dos”. After the caller makes a selection, the call should have a skill requirement set for routing, Language=English (for example) in interaction data. The task of the skills based strategy is to find the agent, who has most appropriate skills for the particular interaction.

Besides these routing rules, which can be configured using Configuration Web interface, matchers also use other criteria for call distribution. As result, generic skill-based matcher implements something like the following skill-based strategy:
During first 120 seconds call is matched to agent, who has skill level at least 8.
If call sits in the queue between 120 and 180 seconds, it will be matched to agents with skill level at least 5.
If call sits in the queue between 180 and 240 seconds, it matches agents with skill level at least 2.
After 240 seconds, it matches any available agent
If no available agent found during ‘QueueTimeout’ seconds (900 seconds by default) AND ‘DefaultDestination’ configuration parameter is defined—call is removed from queue and transferred to the ‘DefaultDestination’.
If multiple skill matched agents are found on every escalation step, the agent with maximum idle time will be selected.
If multiple calls exist in the queue and single agent arrives, which match multiple calls, the call, which sits in the queue longer, will be dispatched to this agent.
   Configuring Routing Rules

To configure routing rules use Configuration Web Interface (FRCC program group). On Configuration Web Interface page select Call Center Server from the Upper menu. Left Menu contains topics:
Agents
Skills and Skill groups
Routing rules
Services
Queue Monitor Settings
Reporting
Advanced Configuration

First three topics will help to completely configure call routing rules.

Skills

Skills are arranged in skill groups. For example, there may be skill groups:
Language group with skills: English, Spanish
Product group with skills: “Microwave”, “Refrigerator”
ServiceType group with skills: “Sales”, “Support”.

First must be created skill groups. On the FIG. 1 there are two skill groups: Language and Technical Skills. The Language group contains the following skills: English and Spanish.

The Technical Skills group contains skills: Hardware and Software.

Note that skills in skill group with name ServiceType must have same names values are Services in Configuration Web Interface, Services. In that case this skill group will double as call's “Service” folder designator for statistics

To create new skill group, click the Create group button on the top of the Table or just replace the words: “New group” with the name for new skill group at the bottom of the Table.

[image]

[image]

To add new skill to already existing skill group, type skill name in the reserved empty field at the bottom of appropriate skill group and click the Add button.

[image]

There may be other schemes of defining skill groups and skills for use in call routing and Call scenarios.

Group Based Routing

For a group routing, a new skill group should be created, with agent group names as skills for example: skill group “AgentGroups”, skills: “SupportGroup”, “SalesGroup”.

All support agents must be then set to SupportGroup=100 and SalesGroup=0, and all sales agents must have SupportGroup=0 and SalesGroup=100.

Now in routing rules a skill group AgentGroups must be used with threshold set to 1, for example. This allows limiting agents considered for a call to a specific group.

To enhance this scheme varying skill values could be used 2 to 100 to denote how good a particular agent is in that group.

Priority Based Routing

Priority usually means some calls jumping ahead of some other calls in the queue.

A new skill group should be created, with priority levels as skills, for example skill group “CustomerLevel”, skills “Gold”, “Silver”, “Bronze”.

Agents have to be assigned values of skills in order of importance, for example Bronze=30, Silver=60, Gold=90.

Now in routing rules we should put skill group “CustomerLevel” in routing rules above Time in Queue using higher importance. This will reorder all calls by priority first and only then by time in queue.

To enhance this scheme, skills values can be different for different agent, while staying in order compared to each other (Bronze 1-30, Silver 31-60, Gold 61-90). For example John is good in handling Bronze customers and Peter is very good with Gold-level callers. So John needs Bronze skill to be s et to value greater than Peter's and Gold skill's value lesser than Peter's.

Configuring Matcher

By default, the Call Center uses Generic skill-based matcher.

To configure routing rules parameters or Matcher's parameters, select the Routing Rules topic on the left menu of the Call Center Server page of Configuration Web Interface.

[image]

The parameters of the matcher may be adjusted. To set new values for its parameters, click on the Matcher's hyperlink.

Matcher's parameters include:
Escalation intervals
Default skill
Skills thresholds
Importance factors

The meaning of parameters is explained below.

[image]

Skill Thresholds

For each skill selected by a call, a threshold can be defined in routing rules. This will effectively limit available agents in “ready” state to ones that have values of requested skills higher than thresholds. This means that if caller wants to speak to agent with skill in certain language, agent's skill in this language should be at least of threshold level.

Escalation Intervals

The time in queue for a call can be divided into several escalation intervals, i.e. periods of different requirements to agents or possibly different sorting priorities for agent/call matches.

For each interval, a set of skill groups, their thresholds, default skills and importance can be specified. Usually, the skill thresholds are relaxed with time (lower thresholds are used), up to dropping entire skill groups with time (example: after 45 seconds in queue we want the call answered, period, so we drop Product skill group requirement and leave only Language).

At least one escalation interval must be defined. If the last escalation interval has a finite end time (not −1 or infinity), upon reaching it, the call will leave the queue with “No Matching Agents” result code.

If the last interval is set as infinite, the call will leave the queue only if caller hangs up.

Importance Factors

For each skill group used in routing rules an importance value must be specified. The importance lets specify that Language is more important than Product knowledge and not vice versa. It is recommended to set importance values in powers of 100, that means 0, 1, 2, 4 stand for 1, 100, 10000, 100000000.

Along with requested skill groups, an importance can also be assigned to agent's idle time and call's time in queue.

Importance factors are taken into account, only if there are multiple agents for a call (that has just arrived, for example) or multiple calls for an agent (that has just become ready and there were calls in queue, for example). Importance is used to find the best possible match.

It is recommended to give Time in Queue top importance to make calls with different routing rules ordered first by Time in Queue and then by other factors. This ensures that calls with the longest time in queue will be answered first.

Default Skill

Routing rules allow setting a so called default skill for each skill group in case that Call scenario did not provide skill requirements with the call (for example, a person chose logical branch that did not ask some skill selections). See ROUTE TO AGENT block.

Configuring

To add a new interval . . .

To add significant skill to interval . . .

Assigning Agent's Skill Levels.

After skill groups and skills in groups were defined, agents must be assigned skill values from 0 to 100.

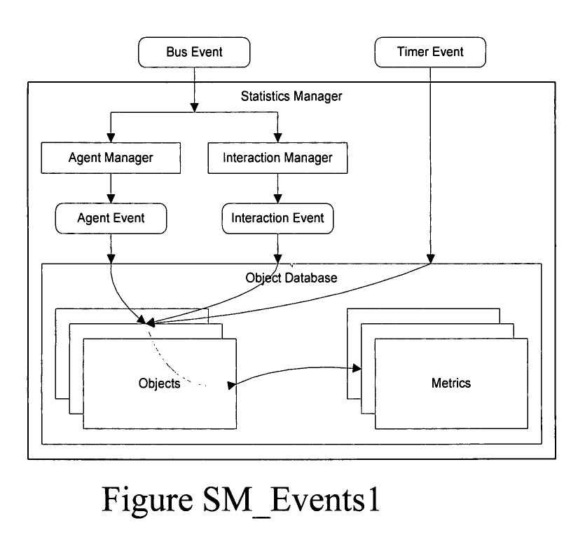

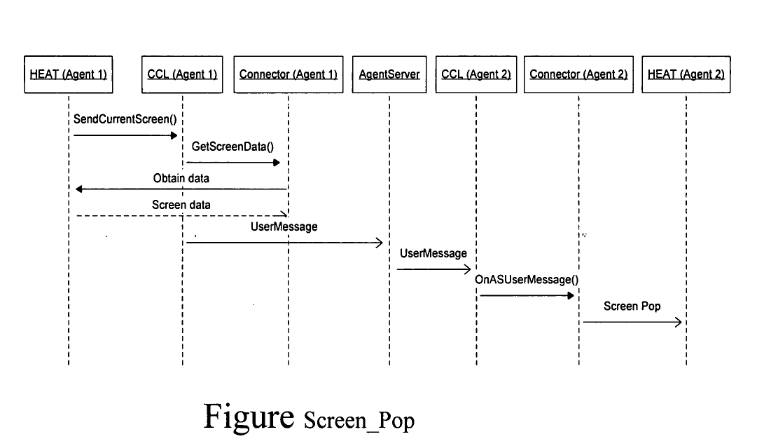

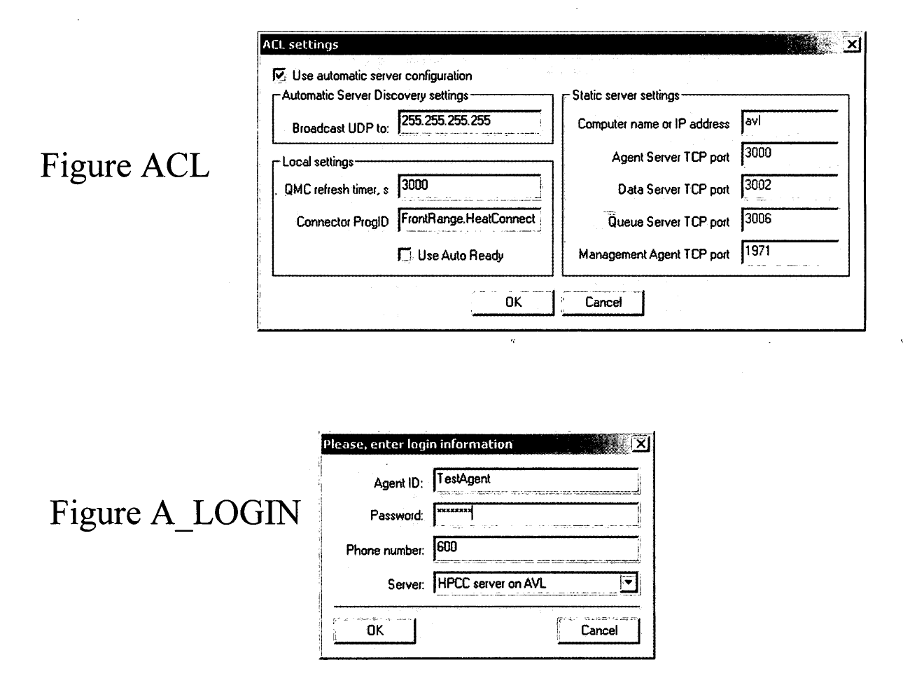

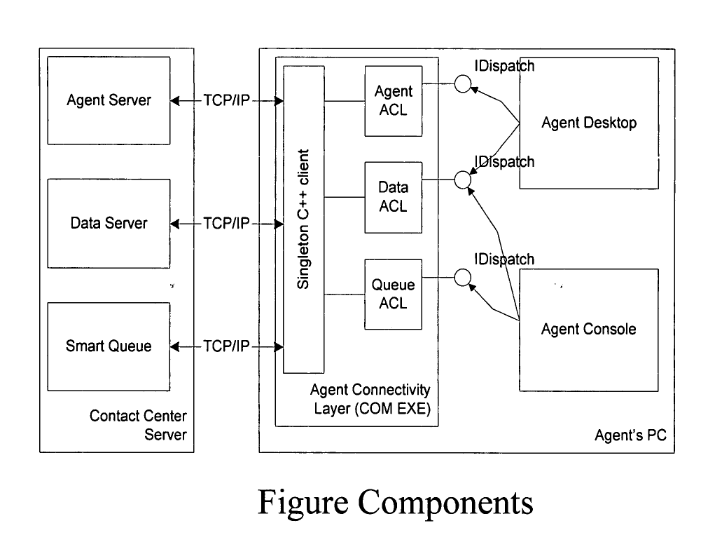

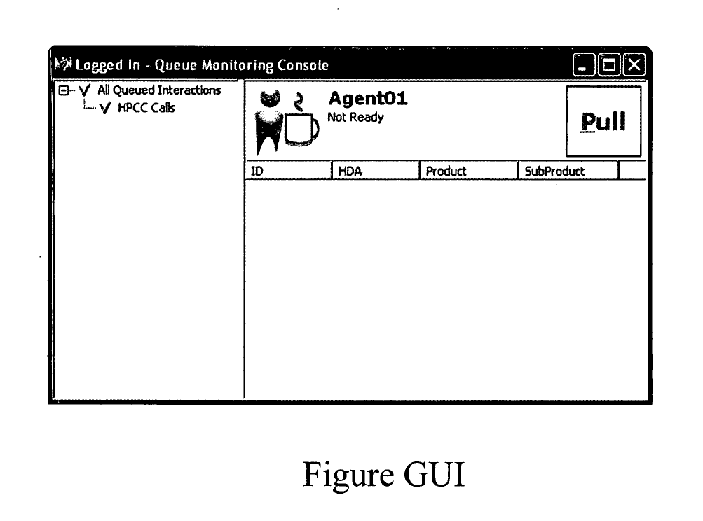

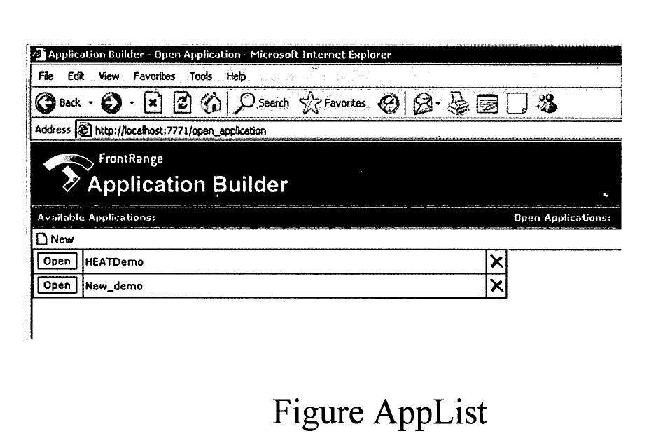

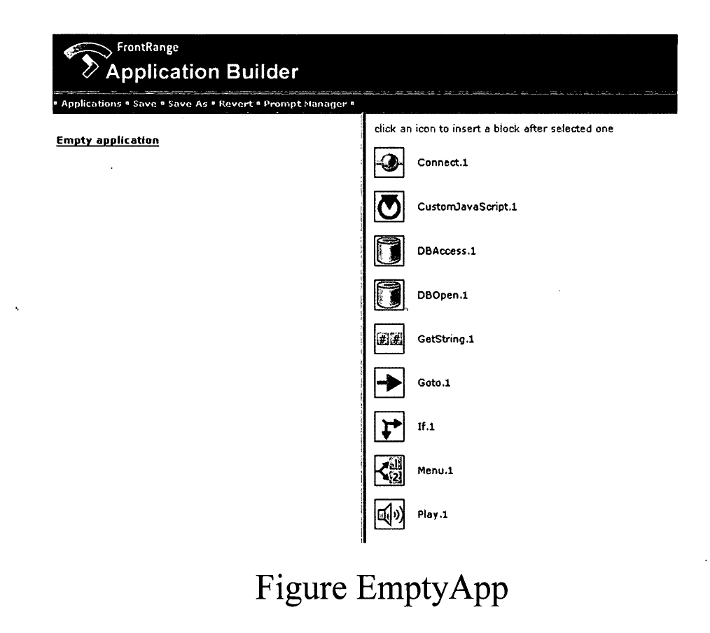

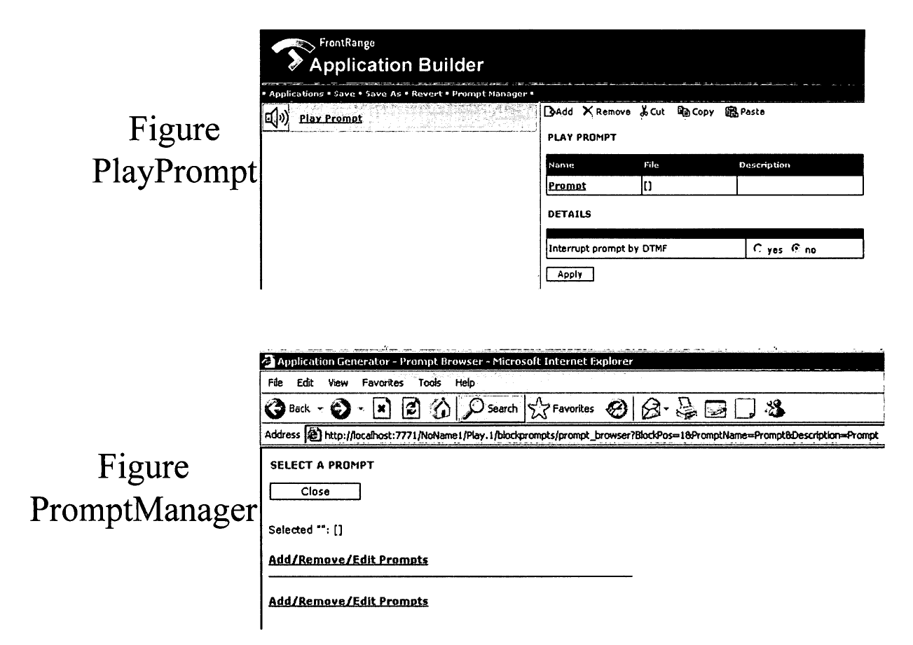

To do this, select the topic Agents from the left menu on CC Server page of Configuration Web Interface (see FIG. 11) and click it.

The page will present existing groups of agents and skills defined in system.

[image]

Agents may have skills defined, for example English=90, which means that the person can speak English fluently. The skill values are in range of 0 to 100—it is convenient to think about them as percentages. If a skill is not defined for an agent, it is assumed to be 0.

To create a new agent group, type in the group name under the red header NEW GROUP on the left of the page.

To move an existing agent to new group there two alternative ways: Mark agent's check boxes, and choose the target group from the <Select target group> drop-down list and use the Move Agent button.

Select the agent from drop-down list and click the Add button

To update agent skills after defining new skill groups and/or new skills, click the hyperlink with the name of the agent (.

[image]

To add a new agent, first select Users page of Configuration Web Interface.

[image]

Fill in the agent user name and skill levels.

Using Routing Rules in Call Scenario

Call scenario must be created that selects skills from skill groups. This is usually done by having REQUEST SKILL blocks on each of MENU block branches, then GOTO to ROUTE TO AGENT Block.

In ROUTE TO AGENT block, routing rules must be specified with the use of 3 escalation intervals in the following way:
the best possible match for the first 15 seconds
an OK match for the next 45 seconds
any agent for the rest of the call.

Agents may have skills defined, for example English=90, which means that the person can speak English fluently. The skill values are in range of 0 to 100—it is convenient to think about them as percentages. If a skill is not defined for an agent, it is assumed to be 0.

Routing rules allow setting a so called default skill for each skill group to be assumed in case Application did not provide skill requirements with the call (for example, a person chose logical branch that did not ask some skill selections).

To Specific Agent

To route to specific agent, interaction property AssignedAgentID must be set to agent's login name before sending call into queue. In that case all routing rules are ignored and call waits for that specific agent.

Call Properties

The following call properties are defined in system:
ANI [string] represents the number of calling party. Optional, present if supplied by telephone signaling protocol.
DNIS [string] represents the number dialed. Optional, present if supplied by telephone signaling protocol.
CallName [string] telephone directory name of the calling party, obtained via Caller ID service. Optional, present if supplied by telephone signaling protocol
CallTime [string] call time, obtained via Caller ID service Optional, present if supplied by telephone signaling protocol
ChannelID [long] channel number from configuration. Always present.
TelephonyType [string] call media type, one of:
   VoIP—SIP IP Telephony
   CiscoCM—CallManager CTI
UserData—folder—user data attached to the call (always present). Filled with Genesys call attached user data when Telephony Server is used in Genesys CTI Integration configuration (accessible as ‘UserData(“keyname”)’).

The following call properties are available only for SIP IP Telephony version of Telephony Server:
VoIPData—all VoIP properties are grouped under this node
VoIPData(“Codec”) [string]—current negotiated RTP payload (both SIP and CallManager):
   “0”—G.711 Mu-law
   “8”—G.711 A-law
   “18”—G.729
VoIPData(“FullLocalSDP”) [string]—full media capabilities of the Telephony Server (complete SDP as string), usually used for call offer or media re-negotiation. (SIP IP Telephony version only)
VoIPData(“FullRemoteSDP”)—full media capabilities of the remote endpoint (complete SDP as string). If the call was established by making a call, this property will be not empty available only after successful media re-negotiation. (SIP IP Telephony version only)
VoIPData(“AcceptedLocalSDP”)—capabilities of the current session (complete SDP as string). Usually used to re-negotiate media stream back to Telephony Server after it was redirected to some other location. (SIP IP Telephony version only)
VoIPData(“AcceptedRemoteSDP”)—capabilities of the current session (complete SDP as string). Usually used to re-negotiate remote media stream to some other location if FullRemoteSDP is not available or cannot be obtained. (SIP IP Telephony version only)
VoIPData(“<SIP header name>”)—<SIP header value>—complete SIP headers of INVITE that started the current call. (SIP IP Telephony version only)

Best IVR Application Practices

TABLE 1
Best Practices

| Best Practice | Example/Comments |
|---|---|
| Limit the number of options | It is acceptable to list four or five options that are |
| to four or five per branch. | available for customers to select. If the list goes beyond |
| | five items, customers lose patience and interest. |
| Minimize Demands on the | First say the option, then the key to select it |
| Caller's Memory | |
| Save Time | Present the most likely menu choice first, the second |
| | most likely second, and so on. |
| Keep menu descriptions brief | When offering account information, provide a list of |
| and to the point. | account names; do not provide a description of each |
| | account type. |
| Keep customer touch-tone | It is acceptable to ask customers to enter in a ZIP code or |
| input to a minimum. | account number (even 16 to 20 positions long). It is |
| | inadvisable to ask customers to enter in their complete |
| | address. |
| Keep menu options | If the star (i.e., asterisk) key is used in one part of the |
| consistent throughout a script | script to reach a CSR, use this consistently throughout |
| and a company (common | the script, so that any time customers hit the star key they |
| navigation techniques). | are transferred to a CSR. |
| Use words, terms and | When referring to checking accounts, do not use the |
| expressions that are | banking term “DDA” (demand deposit account); say |
| commonly understood by the | “checking account.” |
| general public. | |
| Make it easy for customers to | Remind customers throughout the call scenario how to |
| transfer from the application | transfer from the call scenario to a CSR -- tell them |
| to a CSR. | which key to press. |
| Select a voice with an accent | Stay away from regional accents that are hard to |
| that is acceptable to the | understand outside the region (except in situations where |
| customer base. | only one region is accessed). |
| Set customer expectations for | If it will take 10 business days for a copy of a check or |
| all fulfillment and actions | catalog to reach a customer, let the customer know the |
| requested in the call scenario. | exact time frame. |
| Do not use humor in | Humor is personal -- what is funny to one person may not |
| prompts. | be funny |
| | to someone else. |
| Make prompts as short as | Instead of prompting . . . “To listen to information on travel |
| possible while remaining | to California, say 1.”, prompt . . . “For California travel |
| polite and informative. | information, say 1.” |
| Confirmation | There are times where you should read the entry back |
| Announcements | and allow the caller to confirm it. Other times, a feedback |
| | announcement (such as “Please, wait while your |
| | information is located”) is more appropriate than a |
| | confirmation announcement. |

Integration with Agent Applications

Call Center is easily integrated with any back-end applications such as ticketing, service management and so on via open, published integration interface.

The integration with business application makes it possible to create automatically a pop-up screen at agent's monitor, containing all the information about the caller which was gathered by Application and which is available in business database. Moreover, such an integration allows Application to validate the caller's input comparing it to the information in database, and, according to this data, process calls differently.

Existing integrations include Solutions' HEAT Service Management application. Let's consider HEAT ticketing system as an example for description of integration design. DDE (Dynamic Data Exchange) protocol is used for interaction between HEAT application and Agent's Dashboard application.

Call Scenario and HEAT Application

To ensure more data will be used for agent pop-up screen, the data required for back-end application can be received from caller and validated if needed in database by means of Call Scenario. Application Builder's building blocks, such as GET DTMF STRING or ACCESS DATABASE provide that functionality.

[image]

Popup screen at agent's desktop is created in the following way:

Call scenario offers caller to input his identification data (CustID), validates it in HEAT database, gets customer type parameter (CustType) from data base. These and other parameters will be attached to the call.

When call is being connected to the agent, these parameters will be used by connector to get data from HEAT database and to create pop-up screen.

HEAT Data Base

For each customer inquiry Heat application creates a ticket—a record of customer-agent interaction related to this inquiry. Ticket is a database object which makes the information available to any agent and allows to record and track activities on the case.

Consists of several entries and has a status: open or closed. If open, ticket can remind about itself in certain periods of time.

Data Base stores interaction records or tickets. Among other fields, ticket contains:
CustID
CustType
CallID

There may be several calls for one ticket, and several tickets for one customer. Not each call results in a ticket.

DDE Parameters

Communicates with HEAT application and Agent's Dashboard. Upon receiving call-attached data, it creates pop up screen at agent's computer filled with caller's data. It has commands and other parameters.

Application may use the following DDE properties of HEAT application (to be used by connector):
DDE_HEAT_Command—the DDE function name to be called. Should be one of the following:
   LoadCustomer (this is default)
   NewCallTicket
   LoadCallTicket
   SaveCallTicket
   RefreshScreen
DDE_HEAT_CustId—Customer ID parameter for the DDE function (if needed). A uniquenumber to identify a customer, ties all elements of the Customer record together and makes it possible to link a Customer Record with Call tickets. Required for the following commands: LoadCustomer, NewCallTicket.
DDE_HEAT_CustType—Customer Type parameter, required for the following commands: LoadCustomer, NewCallTicket.
DDE_HEAT_CallId—ticket ID parameter required for the command LoadCallTicket.
DDE_HEAT_ScreenType—Screen Type parameter for DDE function (if needed). Required for the command: LoadCustomer.
   Deploying New Applications

How to move Application from development computer to producting system. Copying and registering extra blocks, copying application folder, etc.

Application XML files are kept under AppBuilder data/Applications directory. Each application has a separate directory; name of the directory is the name of application.

Inside the directory, there are: an application.xml file that contains application flow—chart, prompt directories and automatic backups of unsaved application files (made when user session expires without saving changes).

Application Selector

There may be several call scenarios. Different call scenarios may be invoked for different calls, for example, depending on the call number prefix or on other criteria. An application for incoming call is selected with the use of Application Selector.

[image]

The Application Selector is implemented as a file in special format, which contains pairs: condition—Application name. The example file is provided with installation.

Application Selector is stored as: AppSelector.xml

New developed Application should be registered in Application Selector to be considered. To register new call scenario or to edit the list of available applications, please use Configuration Web Interface, Applications page.

[image]

To add a new call scenario or update just edited application, click the Reload button. The list of applications will be updated.

The Application Selector includes multiple entries, evaluated one by one sequentially for each incoming call. Each entry represents one or several conditions written in JavaScript and an application COM CLSID. If an entry is evaluated true, an application specified by CLSID is run to process the call. CallProperties string keys such as “DNIS” and “ANI” can be used directly as variables in conditions (example: ANI==“5555”).

Application configuration is used to specify:
which application to start
in which case
with which parameters

Changes to information made in Application Configuration have immediate effect on Call Center after clicking Save.

How Applications are Selected

When incoming call arrives, conditions in Application Configuration are evaluated, from top to bottom. First condition evaluated TRUE selects the entry, so the position of a line in a list is significant. If a condition is empty, it is presumed to be TRUE.

If no application is selected after all conditions were evaluated, the default application will be started.

Setting Conditions for Application

The radio button presents the options available:
Selected Always. With this option selected, the application has the criteria TRUE. Once the Application Selector gets to this application, application will be selected. If it is on the top of the line, it will be the only one to be played.
Disabled. Temporary excludes the Application from selection process, but don't cut it off the list.
Criteria Builder allows building a criteria in a way very similar to one used for IF block.
Custom. Lets to type in criteria in arbitrary form (JavaScript)

[image]

Using Criteria Builder

If Criteria Builder option is selected, click the Add Column button. The Add Column dialog box pops up.

[image]

There are the following types of properties:

Type of parameters includes a drop-down list of groups:
Call Property
User Property
Interaction Data
CTI property
VoIP Property
Time
Day Type

Each group of parameters has its own list of properties.

Call property group includes properties:
ANI
DNIS
Call Name
Call Time
Channel ID
Telephony Type

User Property parameters maybe used as a string or a number. Name should be typed in.

Interaction Data parameters are defined the same way as User Property Parameters.

[image]

CTI contains items:
Call Type
ConnID
Other Queue
This DN
This Queue

VoIP property defines Codec to be used

Time parameter helps define any time restrictions.

Day type makes it possible to define specific day types for any purposes (such as: on national holidays “Holiday” Application will be played to inform customers that only self-service is available; or on last Friday of the month “Friday” application will be played to inform customers about special discounts).

To create combined logical expression

The Add column button creates a new column or condition to be joined by logical AND

The Add Alternative button creates a new condition to be joined by logical OR

[image]

On Figure the criteria will combine conditions on incoming calls numbers and time of the day.

To define specific conditions, just click, and the dialog box with predefined for this group of parameters logical expressions (forms) will pop up.

For Call Properties, such as DNIS, ANI there will be forms:
No condition
Value
In range
Starts with
Ends with
Contains
<
>

For Time restrictions there will be forms:
No condition
Value
In range
<
>

Before including Day Types in criteria, it is necessary to create Day Types, because on installation there are no default Day Types. Day Type form has only one item—Value.

To finish building the criteria, press the Update button.

Day Types

To create a Day Type on the Application page of Configuration Web Interface, click the Day Types from the left menu. On the Day Type page type in a name for new Day Type, and click the Add button. The form for Day type appears.

The Day Type may be defined as occurring Daily, Weekly, Monthly, Yearly, One time.

The form will reflect the choice of period and will show the list of months and days for Yearly choice; the list of week days for Weekly choice, and so forth.

[image]

After creating of Day Types was completed, return to the Applications page to edit the criteria.

Application Builder Interpreter

Application Builder Interpreter is called each time FRCC Application Selector decides to run an Application Builder-built application.

Interpreter receives application name as a parameter and loads application xml file. Prompts are checked and regenerated if necessary.

Blocks are executed in sequence, if block's return value matches value of one of its condition, blocks from that condition are executed.

Prompt Check and Regeneration

On start, Interpreter scans all declared prompts and their descriptions and compares them with prompt files in application directory (Prompts subdirectory).

If there is no file corresponding to a description, or if description's MTime attribute specifies later time than prompt file modification date, the prompt is generated using text-to-speech and then re-encoded into all supported encodings. This generates initial prompt set or overwrites recorded prompt if description text was changed in editor. This is used to automatically replicate prompt files manually replaced for one of the encodings. If there is no prompt for language selected, the Interpreter uses US English by default.

TTS-generated prompts are supposed to be replaced later with recorded versions, by simply overwriting initial prompt set.

Glossary

CSR—customer Service Representative

DDE—Dynamic Data Exchange

DTMF cut-through

The foregoing has described a number of techniques for implementing a VoIP based Call Center. It is contemplated that changes and modifications may be made by one of ordinary skill in the art, to the materials and arrangements of elements of the present invention without departing from the scope of the invention.

1. A Call Center system, said call center system comprising:
a local area network;
a PSTN to VoIP gateway; said PSTN to VoIP gateway directing calls on said PSTN onto said local area network;
a plurality of agent stations coupled to said local area network, said agent stations comprising a VoIP telephone; and
a call center server, said call center server for queuing incoming calls and distributing calls to said agent stations.
